(19) United States
(12) Patent Application Publication
(10) Pub. No.: US 2012/0089914 A1
(43) Pub. Date: Apr. 12, 2012

(54) USER INTERFACES FOR NAVIGATING STRUCTURED CONTENT

(75) Inventors: Thomas D. Holt, Atherton, CA (US); Larry S. Burke, Brentwood Bay (CA)

(73) Assignee: SURFWAX INC., Menlo Park, CA (US)

(21) Appl. No.: 13/271,882

(22) Filed: Oct. 12, 2011

Related U.S. Application Data
(63) Continuation-in-part of application No. 13/030,052, filed on Feb. 17, 2011.
(60) Provisional application No. 61/328,572, filed on Apr. 27, 2010.

(51) Int. Cl. G06F 3/048; G06F 3/16

(52) U.S. Cl. 715/728; 715/784; 715/764

(57) ABSTRACT

User interfaces for navigating structured content. In one example embodiment, a user interface includes a grid, a header row of cells each positioned in a separate column of the grid, a header column of cells each positioned in a separate row of the grid, a plurality of multi-dimensional cells each having a unique position in the grid, and a viewport that displays only a portion of the grid. Upon of reception an indication that the portion of the grid displayed within the viewport should simultaneously scroll both horizontally and vertically, the multi-dimensional cells of the grid are configured to scroll simultaneously within the viewport both horizontally and vertically, and the header row cells and header column cells of the grid are configured to scroll in a synchronous manner so as to remain visible in the viewport and remain aligned with the rows and columns of multi-dimensional cells.

### CROSS REFERENCE TO RELATED APPLICATIONS

This application is a continuation-in-part of U.S. patent application Ser. No. 13/030,052, filed on Feb. 17, 2011, which claims priority to and the benefit of U.S. Provisional Patent Application Ser. No. 61/328,572, filed on Apr. 27, 2010.

### BACKGROUND

Grid-based or table-based arrays of information, along with instructional systems in learning environments that harness the internet, intranets, databases, courses, teaching units, and lexicons are growing at an explosive rate. Most such content can be “structured” into scope and sequence arrays that connote either a sense of developmental “progress” (a progression of steps leading from more elementary to more advanced or complex steps) or can be structured to represent a range or spectrum of information, not unlike a color spectrum or a bell curve. These “progression” or “spectral” informational arrays can be quite large and can be considered multi-dimensional in that information or steps at any one level may have sub-component steps or elements, which themselves have sub-steps.

Current use or display of such arrays is accomplished through either: 1) a print format, such as a book or chart, or 2) a computer screen displaying charts or graphs such as a spreadsheet or an interactive digital row-column display. However, often such content has multiple layers or relationships that are difficult to represent. For example, a book or chart does not provide an easy access to the content of a large array. Also, while information can be displayed on computer screens as spreadsheets in a row-column manner, and can algorithmically relate one cell or item of information to another cell(s) or spreadsheet or website, such actual relational aspects are usually the custom result of the spreadsheet's user and not intrinsic to the design of the spreadsheet as a spreadsheet typically comes as an empty software solution without content. Spreadsheets provide access to and management of fixed-size arrays, but not to variable-sized, N-dimensional arrays.

One approach for displaying and managing such arrays is to easily expand and contract the display of and access to layers of related content, allowing the user to view and interact with additional content within a limited-size display screen on a device. However, expansion and contraction of screen objects is typically associated with overlapping, and thus obscuring, surrounding screen objects.

With conventional data display, navigation and interaction, the user can be presented with an array that vastly exceeds the displayable area of their device. Further, none of the existing conventional methods intrinsically provide a method for the user to link or navigate to sub-Steps related to the cell (e.g., an instructional step or skill), link to resources of other related cells within the array (e.g., related skills), capture the user's rating of the cell content or credit/score on achievement/mastery relative to the cell's content, or create “social” links to other users based on the pertinence or applicability of the cell's content, comments by other users on the cell's content, or the user's score relative to the cell's content.

Social networks, such as Facebook®, MySpace® and LinkedIn®, have proliferated and are now part of the global culture. However, such networks typically rely on “freely-associated” or “open” content wherein a user creates his/her personal content on any subject, without a “structure” or “progression” of content implied or provided by the underlying social-networking system (to which other users could attach their content). One of the major appeals of such social networks is the creation of “open” content and messages. But one aspect of the “open” approach that is missing is a system for using “default” structured content to spawn social interest and interaction, with such content providing an underlying structured knowledge to which users can edit or attach their own content, comments, share interests and create a network based on the theme of specific steps or topics or domains of knowledge.

### BRIEF SUMMARY OF SOME EXAMPLE EMBODIMENTS

In general, example embodiments of the invention relate to user interfaces for navigating structured content. At least some of the example user interfaces disclosed herein enable large amounts of structured content to be efficiently shared across social networks or displayed, modified, cross-referenced, and/or tracked.

In one example embodiment, a user interface includes a grid comprising rows and columns, a header row of cells each positioned in a separate column of the grid, a header column of cells each positioned in a separate row of the grid, a plurality of multi-dimensional cells each having a unique position in the grid, and a viewport that displays only a portion of the grid. Upon of reception an indication that the portion of the grid displayed within the viewport should simultaneously scroll both horizontally and vertically, the multi-dimensional cells of the grid are configured to scroll simultaneously within the viewport both horizontally and vertically, and the header row cells and header column cells of the grid are configured to scroll in a synchronous manner so as to remain visible in the viewport and remain aligned with the rows and columns of multi-dimensional cells.

In another example embodiment, a user interface includes a grid and a plurality of cluster cells each having a unique position in the grid. Each cluster cell is configured to display only a single cell representing multiple cells before selection and display the multiple cells represented by the single cell upon selection.

In yet another example embodiment, a user interface includes a grid comprising rows and columns and defining multiple unique row/column positions in the grid, a header row of header row cells each positioned in a separate column of the grid, a header column of header column cells each positioned in a separate row of the grid, and a plurality of multi-dimensional spanning cells each configured to span multiple header row columns, multiple header column rows, both multiple header row columns and multiple header column rows in a diagonal fashion, or some combination thereof.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Additional features will be set forth in the description which follows, and in part will be obvious from the description, or may be learned by the practice of the teachings herein. Features of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

To further clarify certain aspects of the present invention, a more particular description of the invention will be rendered by reference to example embodiments thereof which are disclosed in the appended drawings. It is to be understood that the drawings are diagrammatic and schematic representations of such example embodiments, and are not limiting of the present invention, nor are they necessarily drawn to scale. Aspects of the invention will be described and explained with additional specificity and detail through the use of the accompanying drawings in which:

FIGS. 1 to 3-2 disclose example matrices of structured content;

FIG. 4 discloses one example environment in which the user interfaces of the present invention may be employed;

FIGS. 5-1 and 5-2 disclose a first example user interface for navigating structured content;

FIGS. 6A-1 to 6B-2 disclose diagonal scrolling within the user interface of FIGS. 5-1 and 5-2;

FIGS. 7-1 and 7-2 disclose accordion expansion of a row within the user interface of FIGS. 5-1 and 5-2;

FIGS. 8-1 and 8-2 disclose accordion expansion and a pop-up dialog of a cell within the user interface of FIGS. 5-1 and 5-2;

FIGS. 9A-1 to 9B-2 disclose accordion expansion of a cell and a pop-up menu of the cell within the user interface of FIGS. 5-1 and 5-2;

FIGS. 10-1 and 10-2 disclose accordion expansion of a cell within the user interface of FIGS. 5-1 and 5-2;

FIGS. 11-1 and 11-2 disclose accordion expansion of a cell and a modal window of a cell within the user interface of FIGS. 5-1 and 5-2;

FIGS. 12-1 and 12-2 disclose search capabilities within the user interface of FIGS. 5-1 and 5-2;

FIGS. 13-1 and 13-2 disclose a second example user interface for navigating structured content;

FIGS. 14-1 and 14-2 disclose accordion expansion of a row within the user interface of FIGS. 13-1 and 13-2;

FIGS. 15A-1 to 15B-2 disclose various stages of accordion expansion of a cell within the user interface of FIGS. 13-1 and 13-2;

FIGS. 16A-1 to 16B-2 disclose simultaneous accordion expansion of multiple cells within the user interface of FIGS. 13-1 and 13-2;

FIGS. 17A-1 to 17F-2 disclose accordion expansion of a cell, a drop-down menu of the cell, various pop-up windows of the cell within the user interface of FIGS. 13-1 and 13-2;

FIGS. 18-1 and 18-2 disclose a pop-up social-networking window of a cell within the user interface of FIGS. 13-1 and 13-2;

FIG. 19 discloses a third example user interface for navigating structured content;

FIG. 20 discloses expansion of a row within the user interface of FIG. 19;

FIG. 21 discloses a fourth example user interface for navigating structured content;

FIG. 22 discloses diagonal scrolling with synchronous headers within the user interface of FIG. 21;

FIG. 23 discloses disclose a pop-up window of a cell within the user interface of FIG. 21 employed in a handheld device environment;

FIG. 24 discloses a summative display of the grid of the user interface of FIG. 21 employed in a handheld device environment;

FIGS. 25-1 and 25-2 disclose the user interface of FIG. 21 employed in the context of a network-based social network;

FIG. 26 discloses a fifth example user interface for navigating structured content and a pop-up window of a cell within the fifth example user interface;

FIGS. 27A to 27C disclose various interface objects of a first cell within the user interface of FIG. 26;

FIG. 28 discloses an interface object of a second cell within the user interface of FIG. 26;

FIGS. 29-1 and 29-2 disclose a first portion of the grid of the example user interface of FIG. 26 with empty cells;

FIGS. 30-1 and 30-2 disclose another portion of the grid of the example user interface of FIG. 26 with empty cells;

FIG. 31 discloses the grid of FIGS. 29-1 to 30-2 with the empty cells hidden in the first column;

FIGS. 32-35 are example administrative displays of the user interface of FIG. 26;

FIGS. 36A-36C disclose a sixth example user interface for navigating structured content;

FIGS. 37A-37B disclose a seventh example user interface for navigating structured content;

FIGS. 38A-38B disclose an eighth example user interface for navigating structured content; and

FIG. 39 disclose a ninth example user interface for navigating structured content.

### DETAILED DESCRIPTION OF SOME EXAMPLE EMBODIMENTS

Example embodiments of the present invention relate to user interfaces for navigating structured content. At least some of the example user interfaces disclosed herein enable large amounts of structured content to be efficiently shared across social networks or displayed, modified, cross-referenced, and/or tracked.

### 1. Structured Content, Grids, Headers, and Dimensions

As used herein, the term “structured content” refers to digital data that is structured as a progression, continuum, matrix, hierarchy, or spectrum, or some combination thereof. The digital data can include any type of data including, but not limited to, text, symbols, charted data, audio, images, or video, or some combination thereof. Some examples of digital data that can be compiled as “structured content” and displayed in the example user interfaces disclosed herein include outlines; product feature comparison charts; real estate listings; organization responsibilities; job descriptions; training/skillset information; financial data; service listings; education standards; drug listings and tables displaying dosage and contraindications; tweets or messages; college comparison information; photo albums or arrays of images; video or audio clips; car listings; educational materials; religious development information; curriculum; reference data; movie/title/actor listings; personal assessment checklists; reading; math; child development; growing one's religious faith; parenting skills; how to sell real estate; career path steps within an organization; virtual learning environments (VLEs); managed learning environments (MLE); decision matrices; linear or non-linear expansion of or spectral representation of knowledge, data, states, prices, options, conditions, concepts, images, practices, products, service, terminology, language constructs, organizational parameters, and unitary or functional or multidivisional or conglomerate structures; specific sequences of numbers or symbols (for example, 1, 2, 3, 4); words or symbols that denote sequence (for example, creep, crawl, walk, run); words or symbols including photo/audio/video representations thereof (for example, photos showing states or stages of progress or assembly, such as tires, engine, frame, doors, complete car); scene sequences such as frames that make up a scene and scenes that make up a story board, photo album, movie, or film; pages that make up chapters and chapters that make up a book; a bell curve of data points; a chart/taxonomy of biological classification; or various other domains of learning.

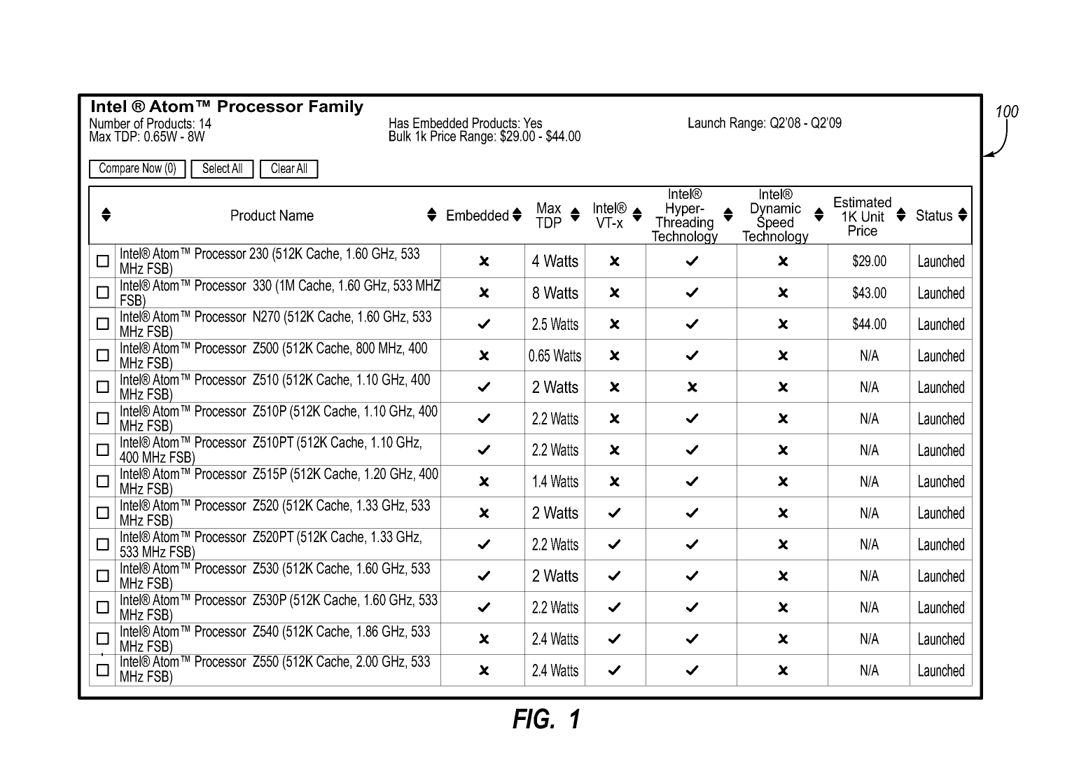

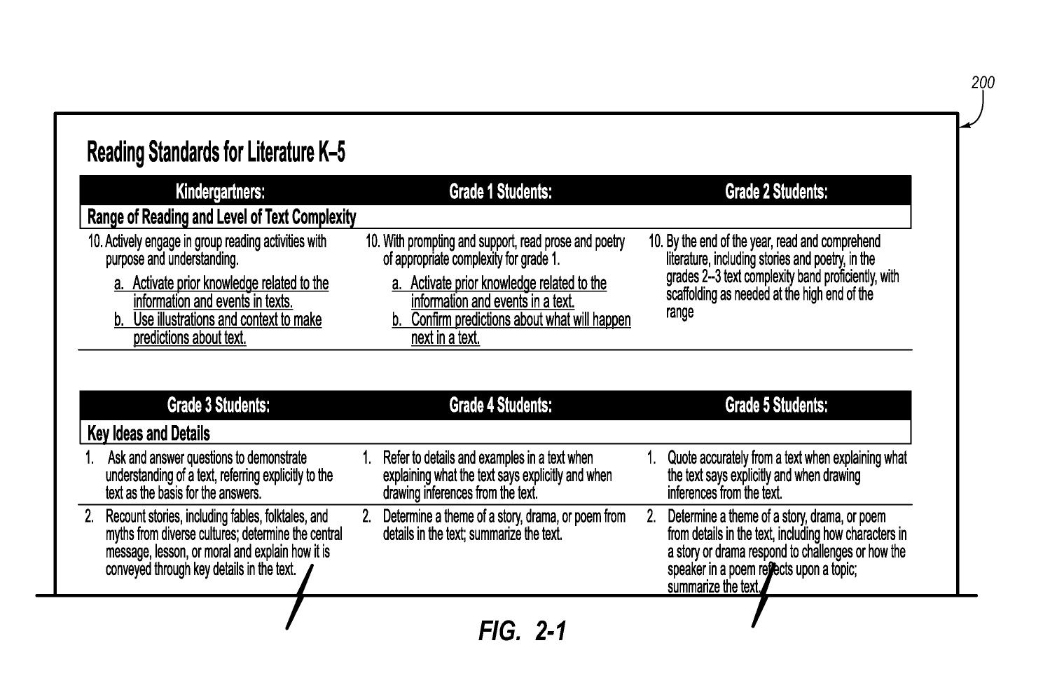

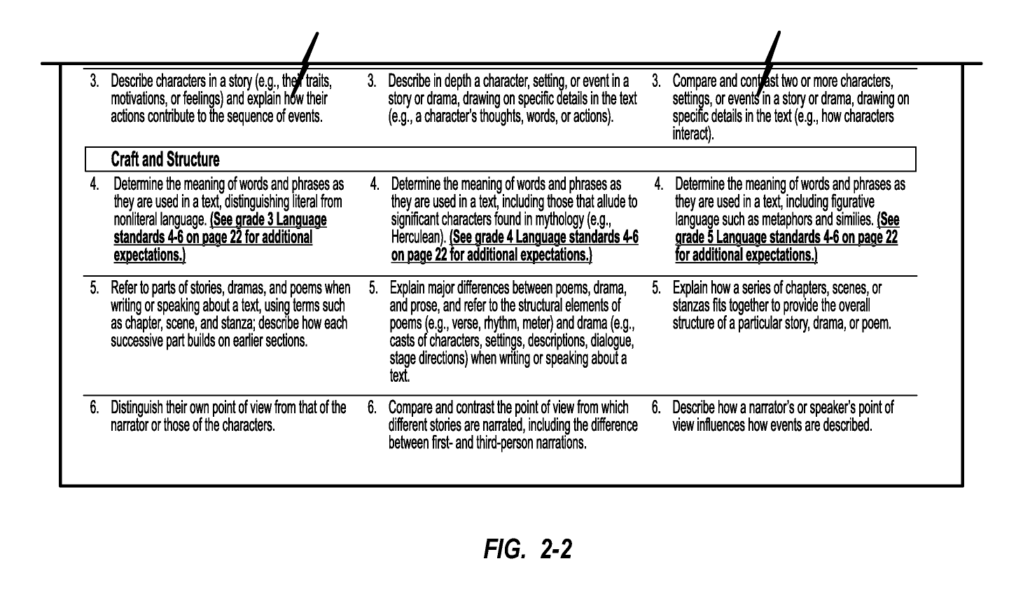

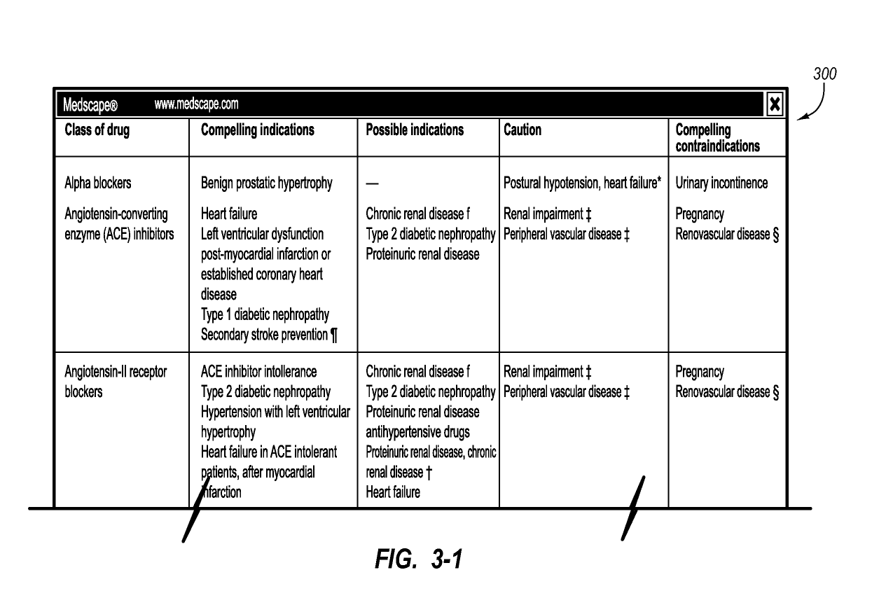

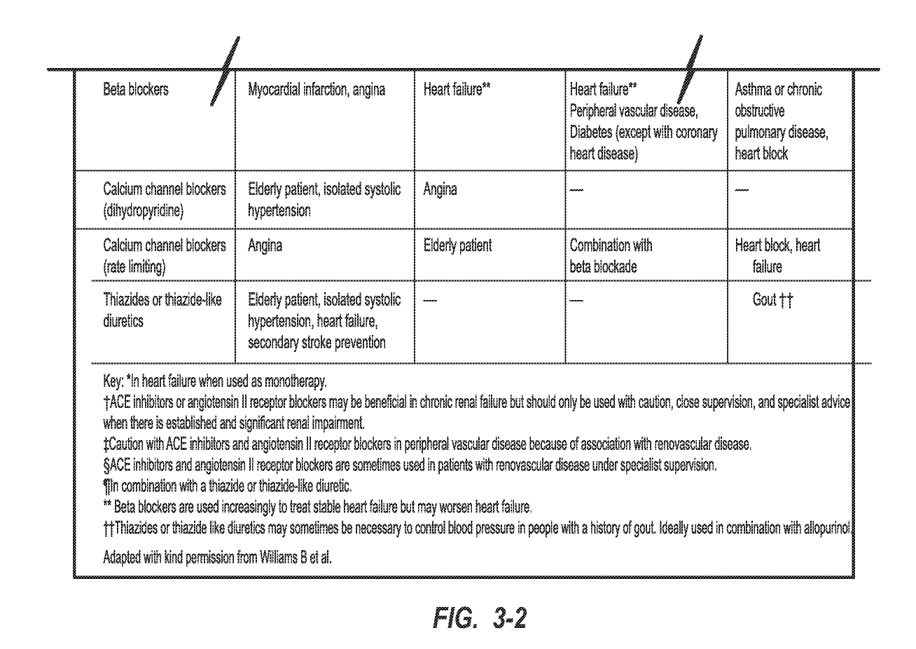

For example, FIGS. 1 to 3-2 disclose three examples matrices of structured content. FIG. 1 discloses a matrix 100 comparing product features, FIGS. 2-1 and 2-2 disclose a matrix 200 of curriculum goals, objectives, and standards, and FIGS. 3-1 and 3-2 disclose a matrix 300 of drug listings, dosages, and contraindications. Each of these three examples of structured content can be displayed in the example user interfaces disclosed herein. It is understood, however, that many other types of structured content can also be displayed in the example user interfaces disclosed herein.

For example, another example of structured content that can also be displayed in the example user interfaces disclosed herein is course curriculum. Regardless of the subject of instructional area, the basic framework for a course curriculum may generally has a framework as follows:

1−>Category/Domain (Topic, e.g., “Real Estate” or “Auto Repair” or
“Math”)

2−> Strand (Subject or “goal” area, e.g., “Changing Oil” or
“Patching Tire”)

3−> Steps (Sequential Objectives/skills leading to end of, or
mastery of goal)

4−> sub-Steps (tasks/skills sequenced within a Step for

learning Step mastery)

5−> Mastery Code/score (self-assessment or formal
evaluation)

6−> List/personalization of content
6−> List of resources/teaching methods

5−> Social sharing of status/interests

Thus, course curricula compiled as structured content lends itself to being displayed in the example user interfaces disclosed herein.

One is curriculum for an education Domain (e.g., “Math”) containing nested or sequentially-dependent goal areas or topic Strands (e.g., “Fractions”), with each Strand containing sequenced Objectives (Steps) leading to mastery within the topic, with each Objective related to respective component sub-Steps/tasks/skills, Instructional Methods and Materials and Resources for teaching the Objective or sub-Step, with a method for capturing, tracking, and reporting user mastery (assessment score/credit, self-assessment, or assessment/testing by another party) on that Objective or sub-Step, a method for aggregating and reporting mastery data for a specific user or across users, and a method for establishing a social network across individual users and users for harnessing the aggregate data.

In addition, as used herein, the term “grid” is not limited to grids made up of rectangular cells organized into rows and columns. Therefore, although the grids of the example user interfaces disclosed herein are generally grids made up of rectangular cells organized into rows and columns, it is understood that the term “grid” can also encompass grids with non-rectangular cells, such as spherical grids.

Further, as used herein, the term “header row” is not limited to a row of header cells positioned at or near the top of a grid. Instead, the term “header row” can encompass any group of header cells in the same row of a grid. Similarly, the term “header column” is not limited to a column of header cells positioned at or near the extreme left side of a grid. Instead, the term “header column” can encompass any group of header cells in the same column of a grid. Therefore, although the grids of the example user interfaces disclosed herein include only header rows and header columns positioned at or near the top and extreme left sides of the grids, respectively, it is understood that header rows and header columns can be otherwise positioned within a grid. Further, although the grids of the example user interfaces disclosed herein each includes only a single header row and/or a single header column, it is understood that a grid may include multiple header rows and/or multiple header columns.

As used herein, the term “dimension of structured content” refers a specific layer or level of structured content within a cell in a grid. Therefore, the term “dimension” as used herein does not refer to a position in space within the grid.

### 2. Example System

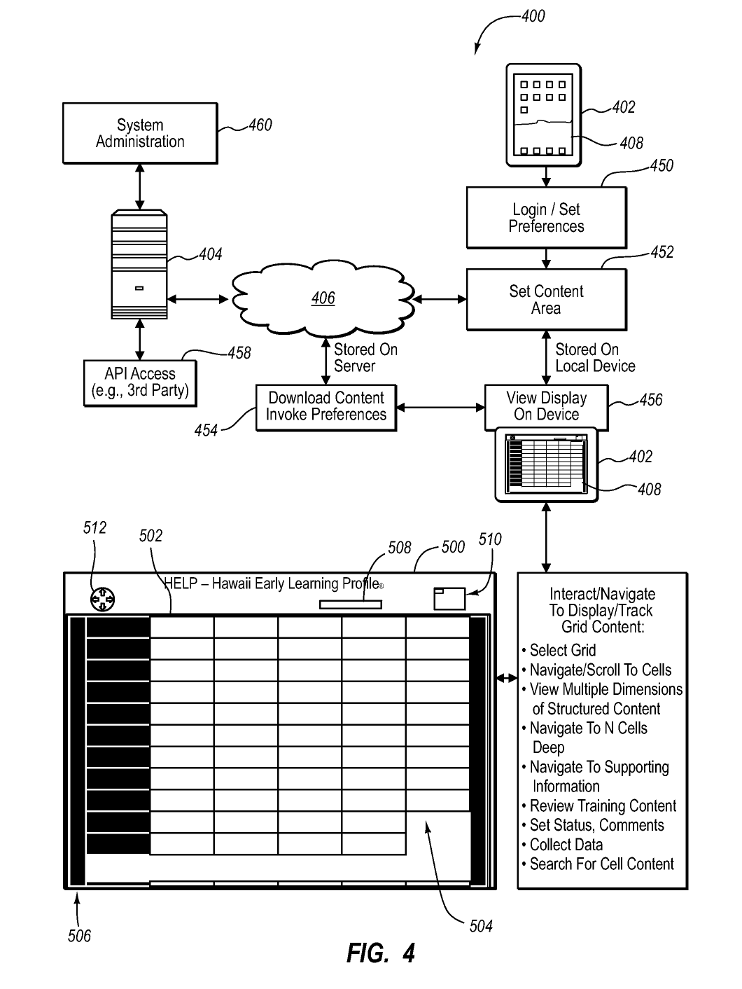

With reference to FIG. 4, one example system 400 is disclosed in which the example user interfaces disclosed herein can be employed. The example system 400 includes a user device and a server 404 that communicate with each other over a network 406. The user device 402 includes a display 408, which may either be integrated into the user device 402 or connected to the user device 402, upon which the user interfaces disclosed herein, such as the user interface 500, can be displayed. The user device 402 can be any networked computing device such as a desktop computer; a notebook, netbook or laptop computer; slate-type computer such as an iPad®; a cell or smart phone such as an iPod®; web-connected/networked or stand-alone devices; electronic clipboards, production/manufacturing recording devices, test recording, and data collection/recording devices/tools/instruments or checklists The network 406 may be any type of wired or wireless network such as the internet, a WAN, a LAN, a G3 or G4 network, a Wi-Fi network, or a cellular network.

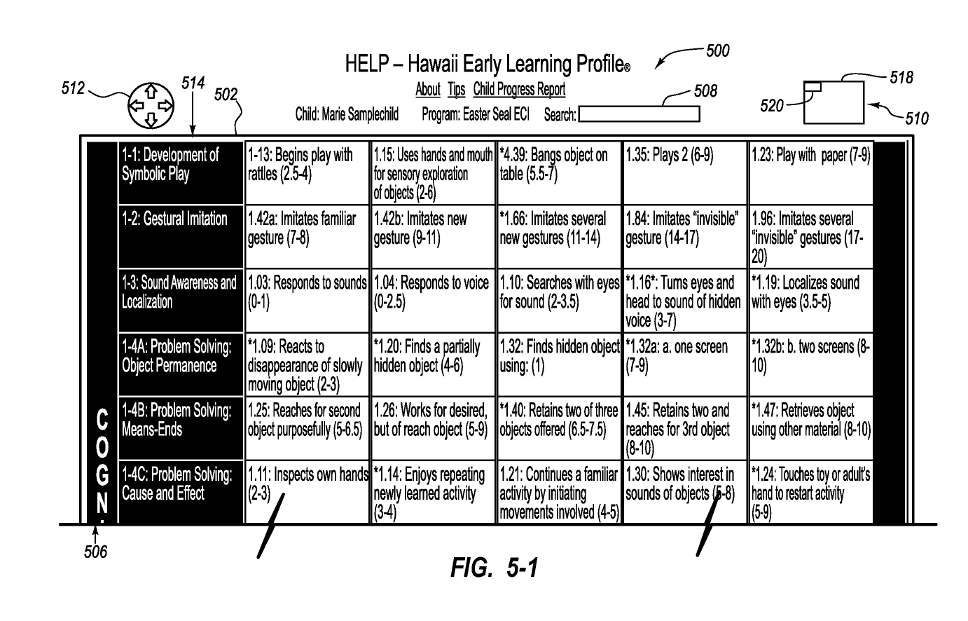

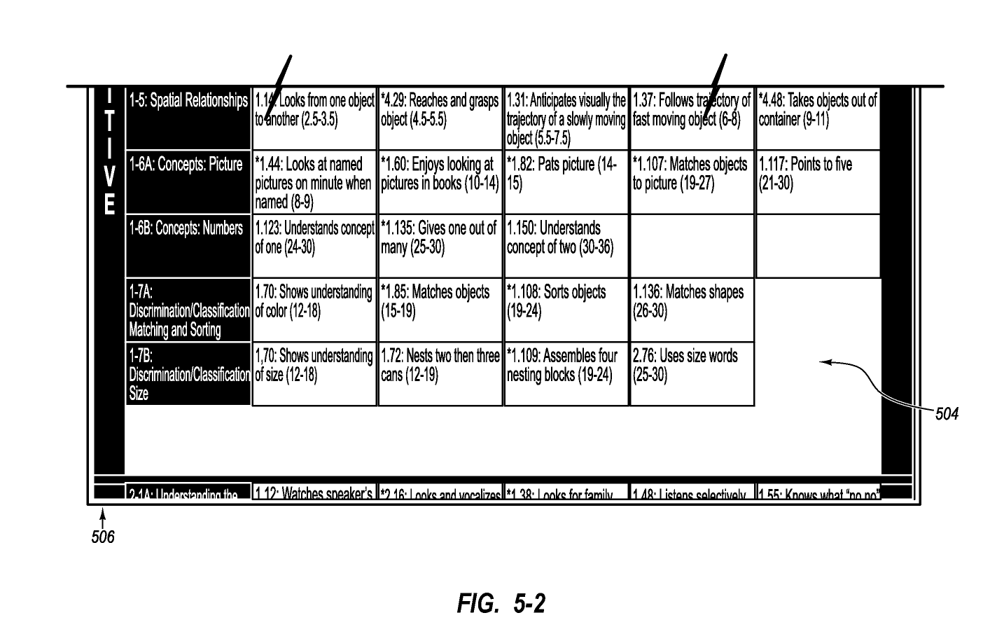

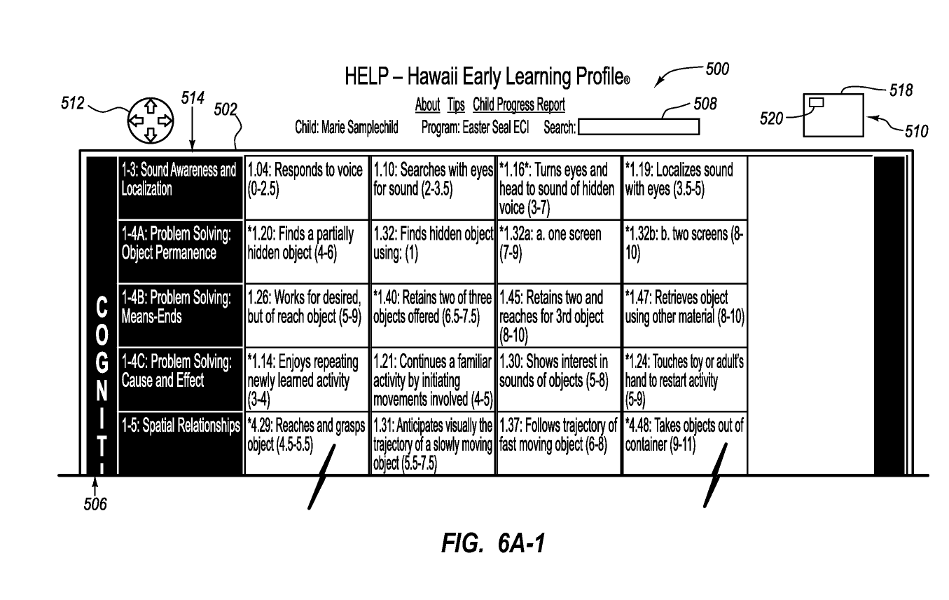

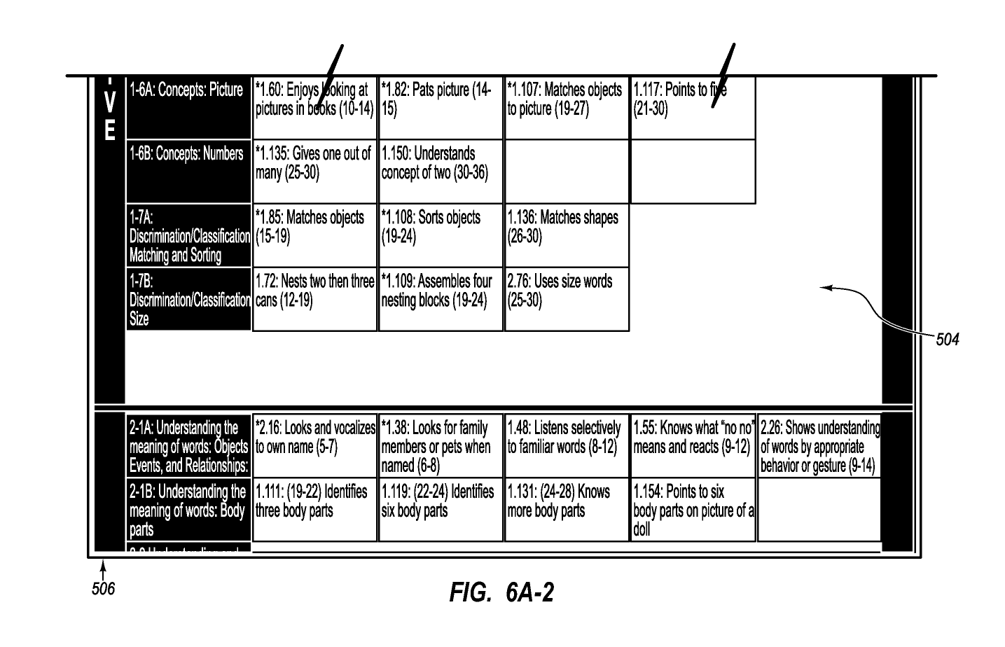

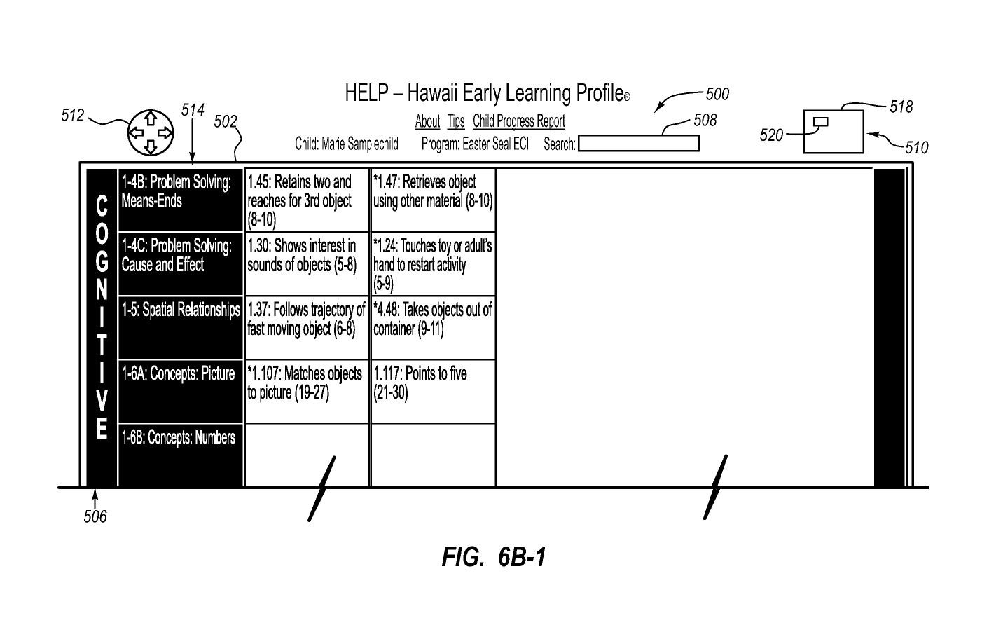

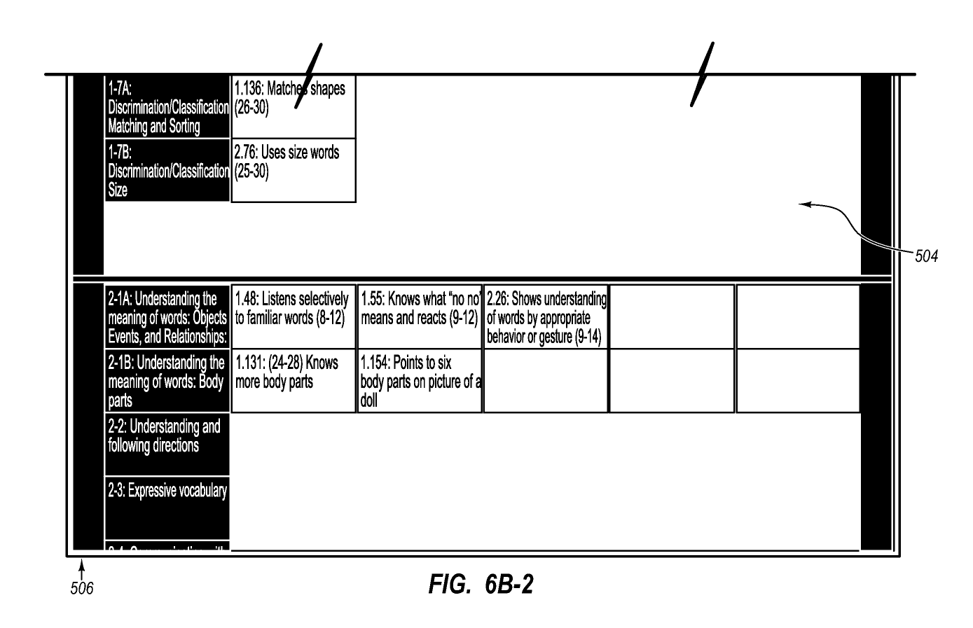

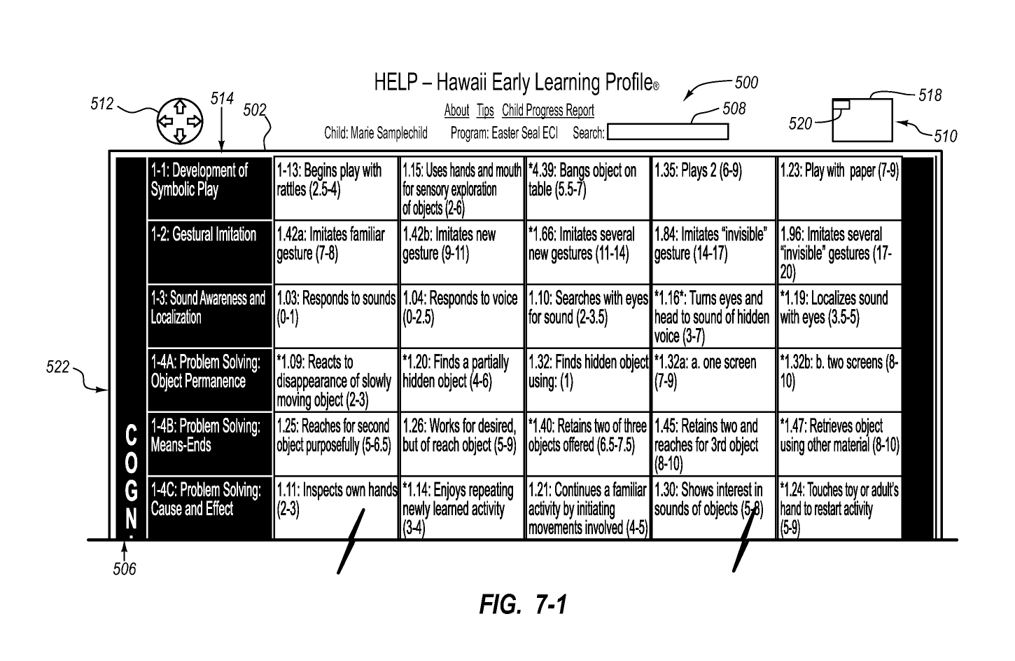

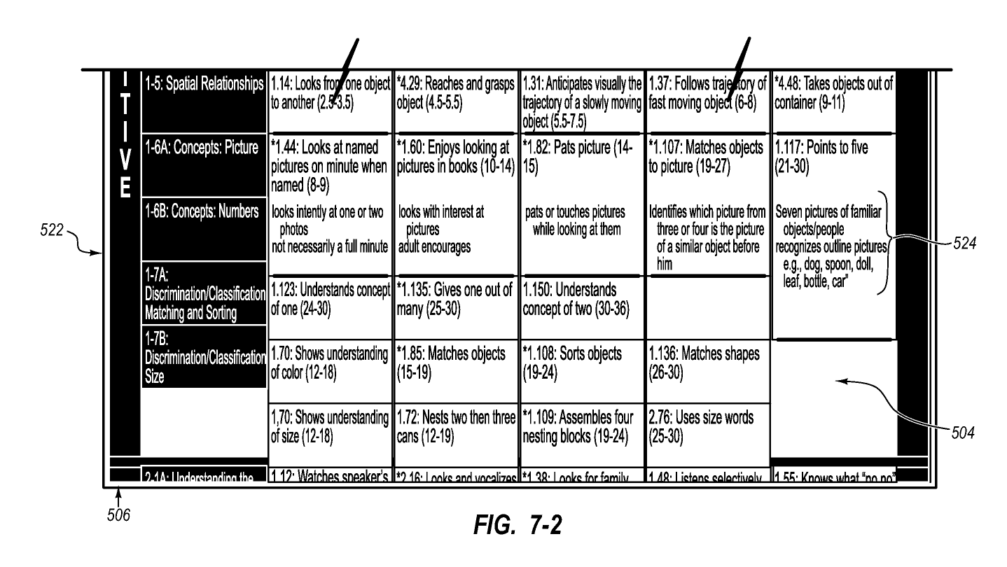

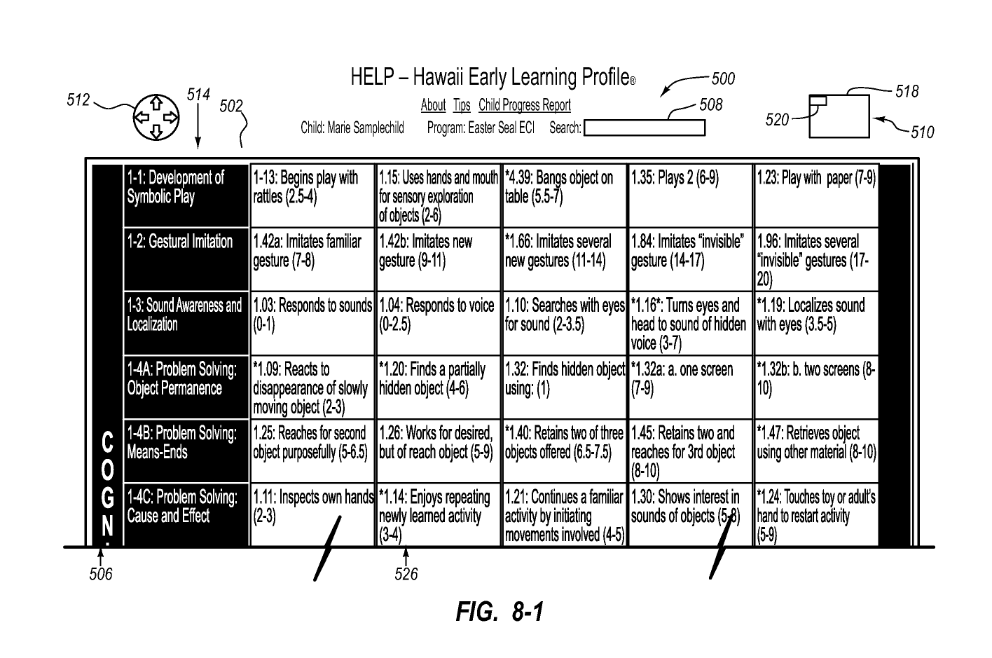

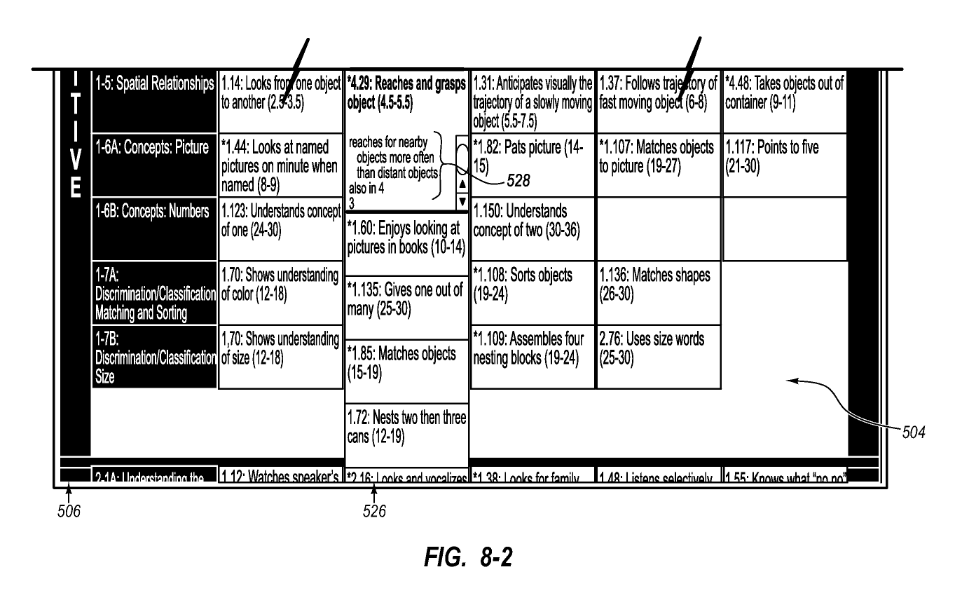

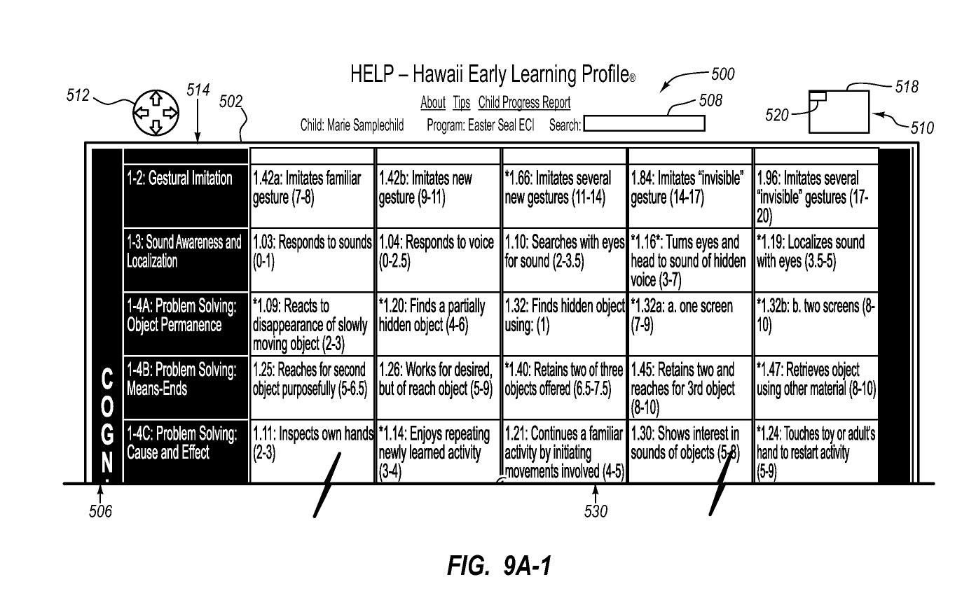

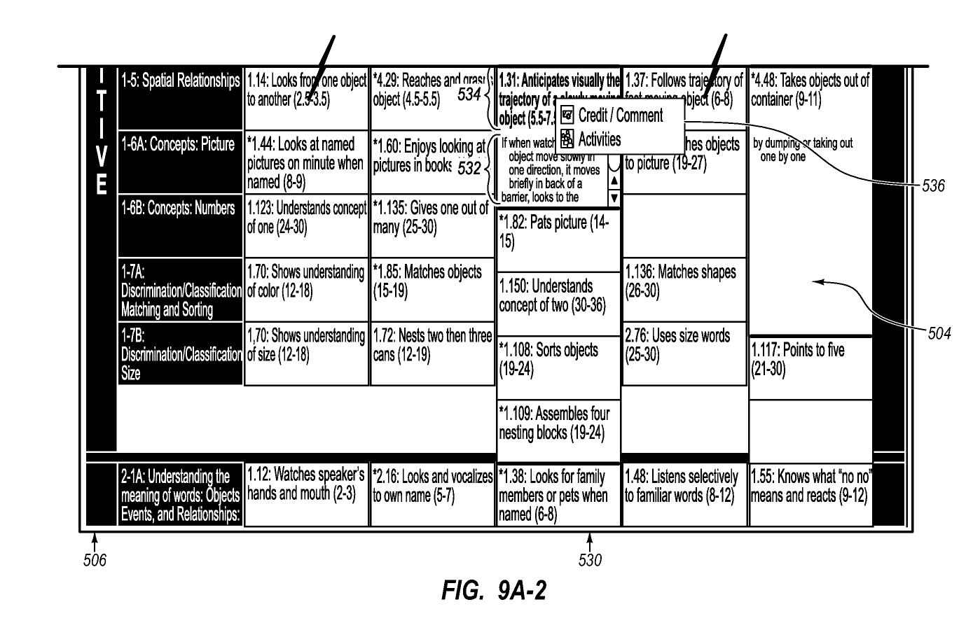

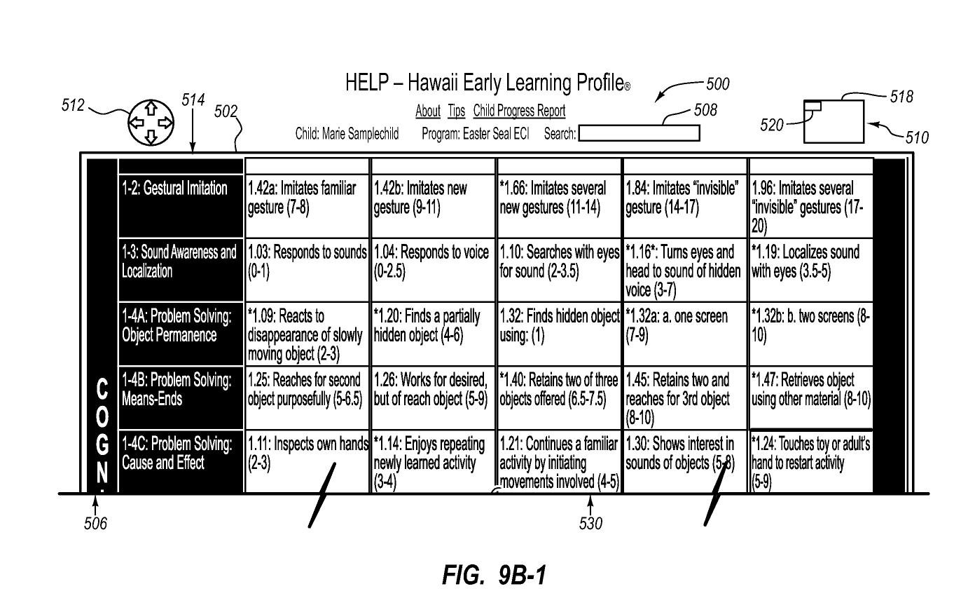

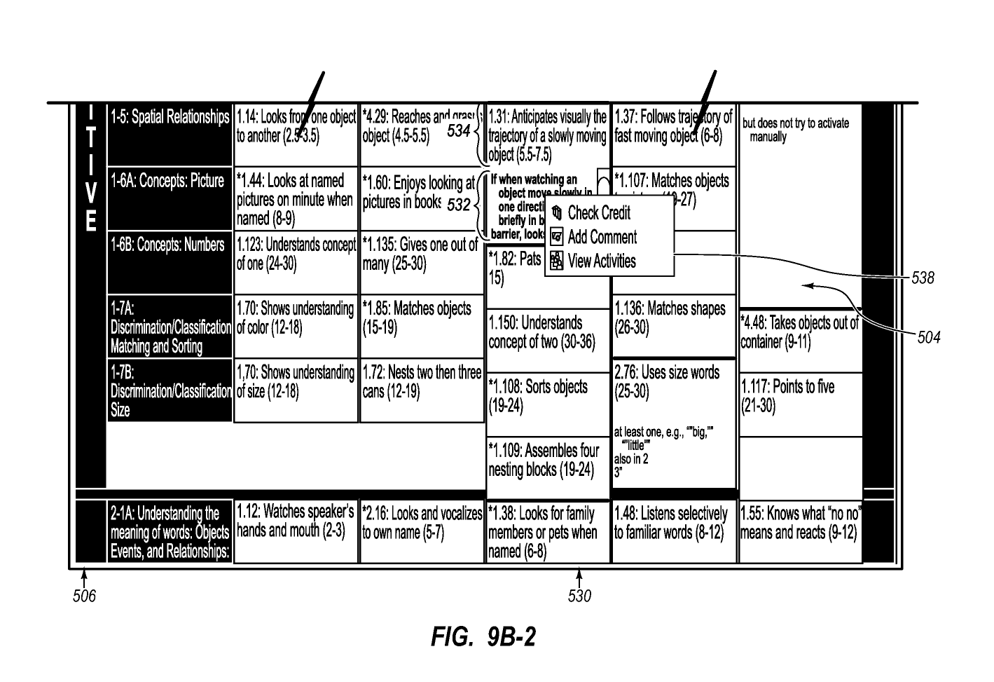

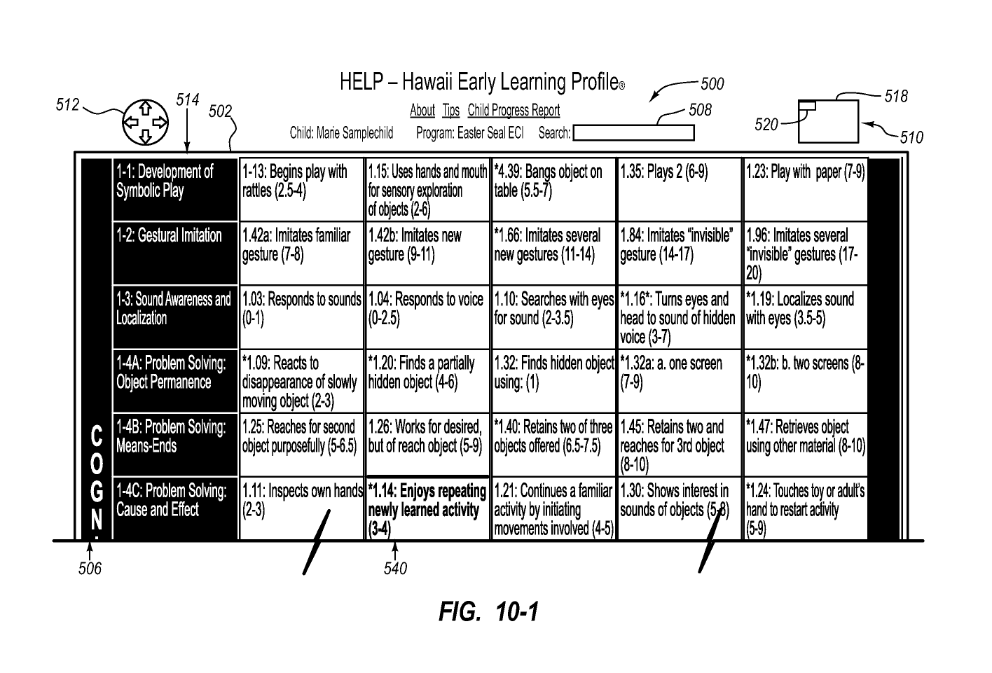

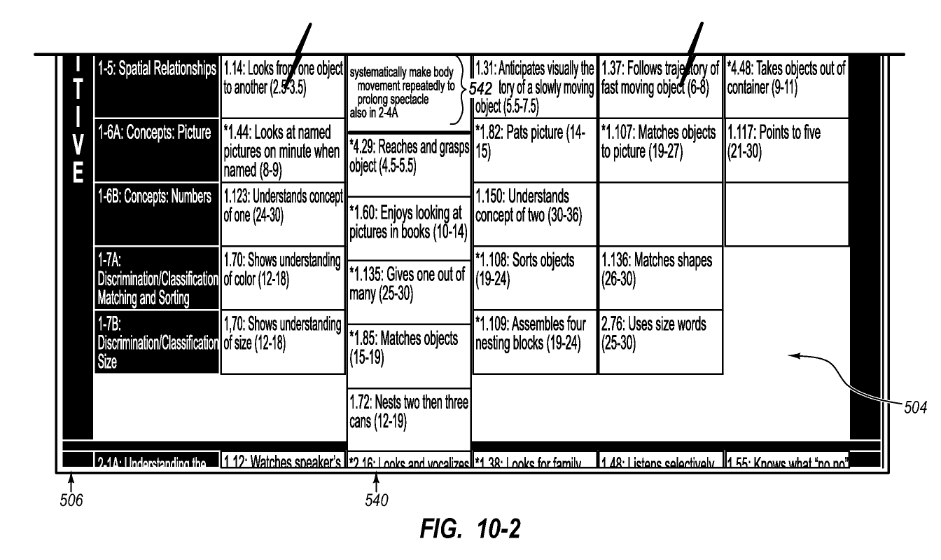

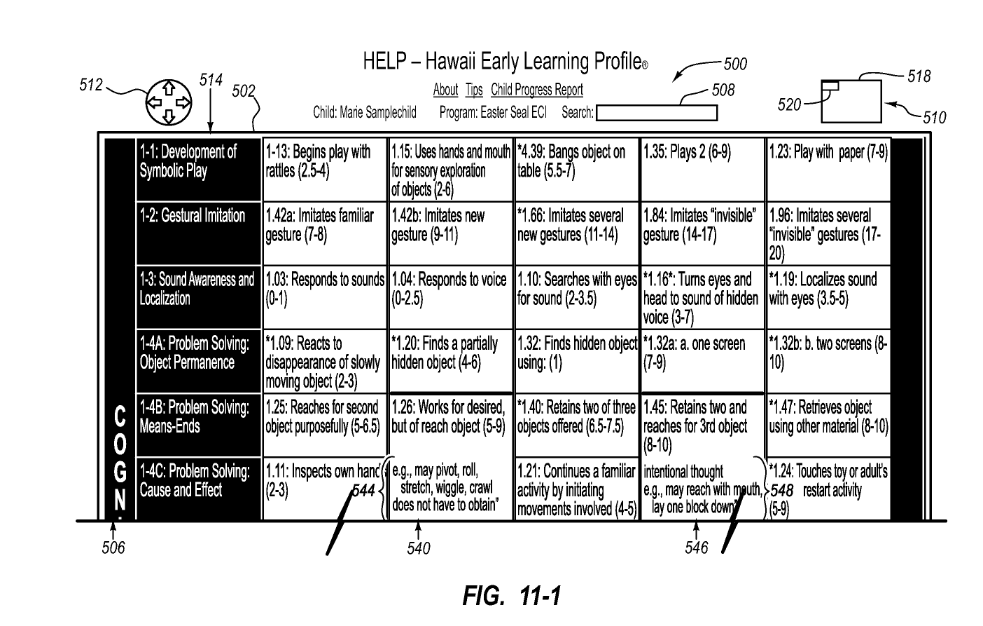

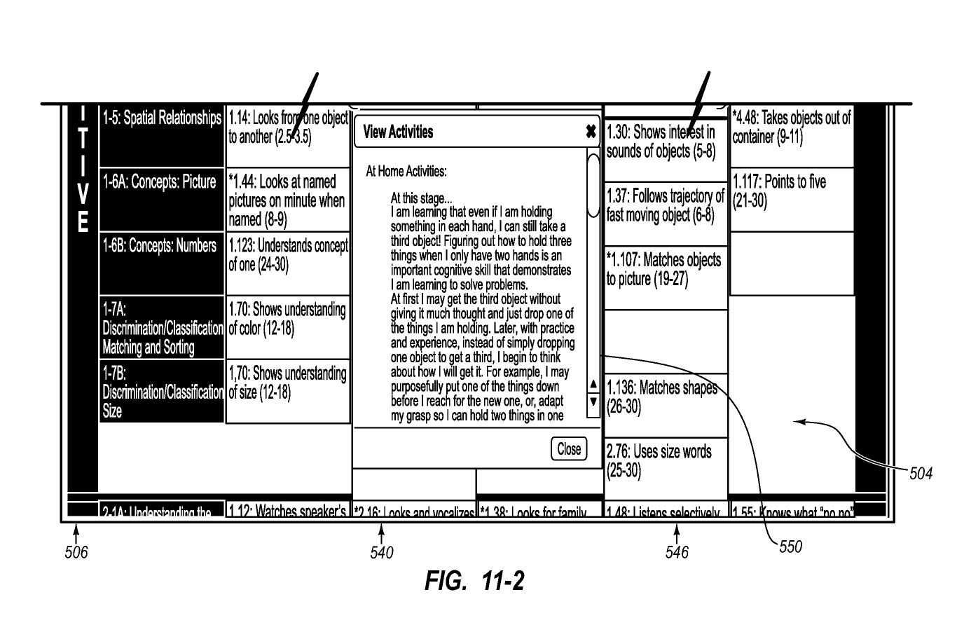

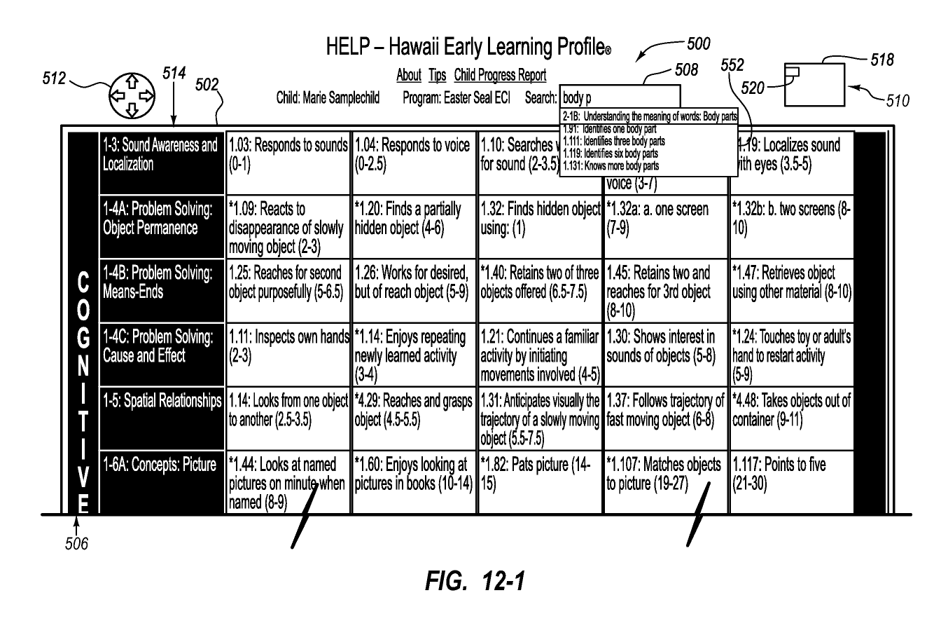

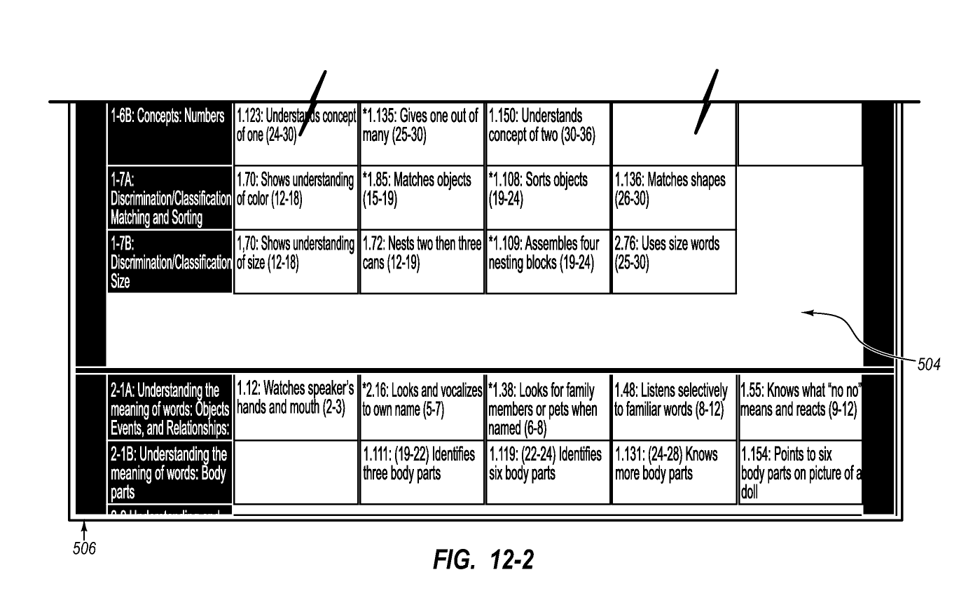

The user interface 500 generally includes a viewport 502 that displays at least a portion of a grid 504 made up of a plurality of multi-dimensional cells each having a unique position in the grid 504. The grid 504 also includes a domain column 506 of cells each spanning multiple rows. The user interface 500 may also include a search box 508, a viewtracker 510, and/or navigation arrows 512. Additional details regarding the various components of the user interface 500 will be given below in connection with FIGS. 5-1 to 12-2.

During operation, a user can employ the user device 402 to connect to the server 404 over the network 406 in order to access, browse, use, execute, or download software that includes the example user interface 500. The user can obtain the software as an independent user or as part of a group of users, such as students in a class or members of a church, in which case the user would use the software via an account that the user accesses via the network 406. The software that includes the user interface 500 can run as a stand-alone application on the user device 402, or can run on the server 404 and be accessed by the user device 402 over the network 406.

Once the user interface 500 is running, the user may be prompted at an act 450 to login and/or set preferences. For example, the user can set various preferences which may include, for example, border gradation and cell background colors, fonts, and symbols used to display the content within the user interface 500. The user interface 500 can automatically detect the type of the user device 402 and the size of the user device display 408 in order to automatically optimally configure the viewport 502 for display on the user device display 408. For example, the user interface 500 can automatically set: the size of the viewport 502, the scrolling speed, the screen orientation, or the display navigation options, or some combination thereof. Alternatively, the user can select the user device 402 and the user device display 408 and set preferences such as “accordion” speed (accordion expansion will be discussed below), how rows and columns expand and contract, the height or width of expanded cells, or how various cells are highlighted by color or other means, or some combination thereof. The user can also select from a variety of “resource” preferences, such as other tools, links, authorities, or reference materials, for display within the viewport 502.

Next, at act 452, the user may select a content area. Content are can include, for example, any of the examples of structured content disclosed herein. The content might be stored on the user device 402, or remain on the server 404 and be accessed to provide the user with remote networked use of the content. Once the content area is selected, at act 454 the user's preferences are applied to the user device 402, either from the server 404 or from settings saved locally to the user device 402. Then, at act 456, the content is displayed within the viewport 502 configured on the user device 402.

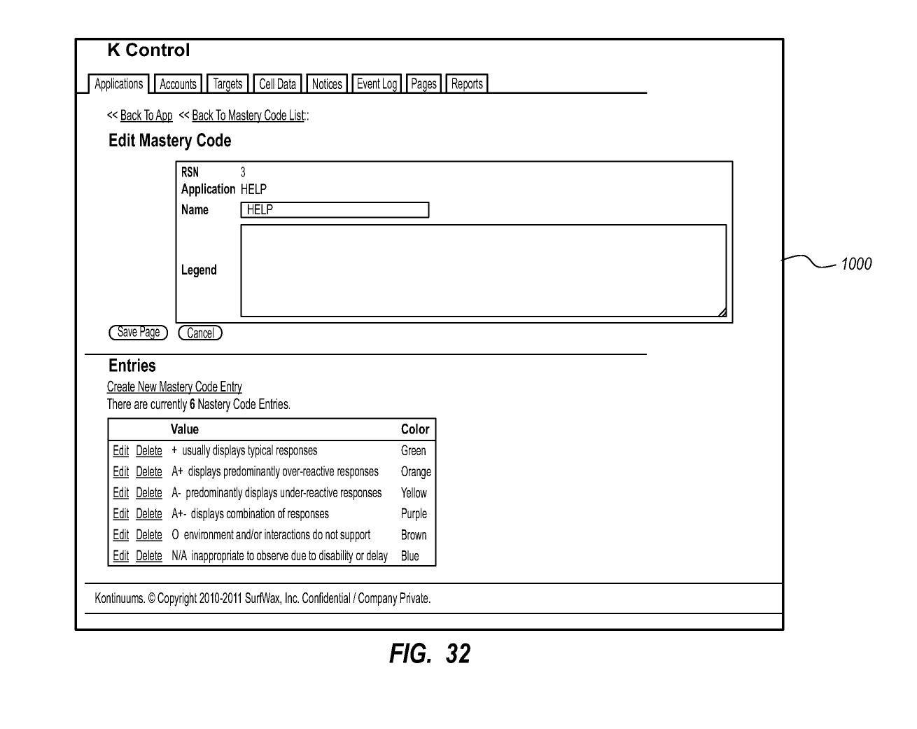

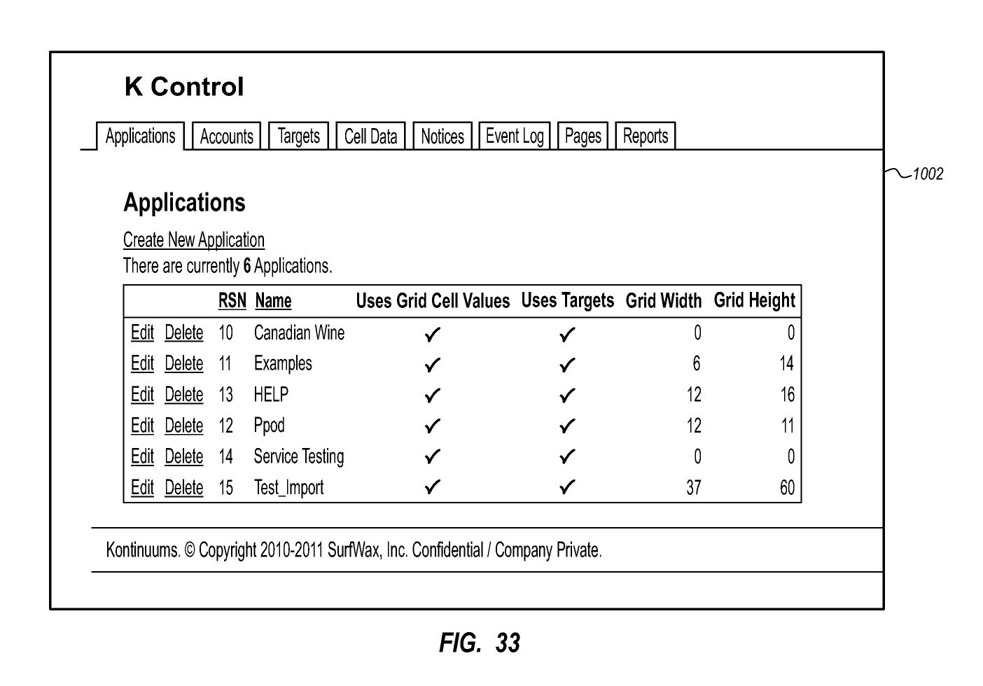

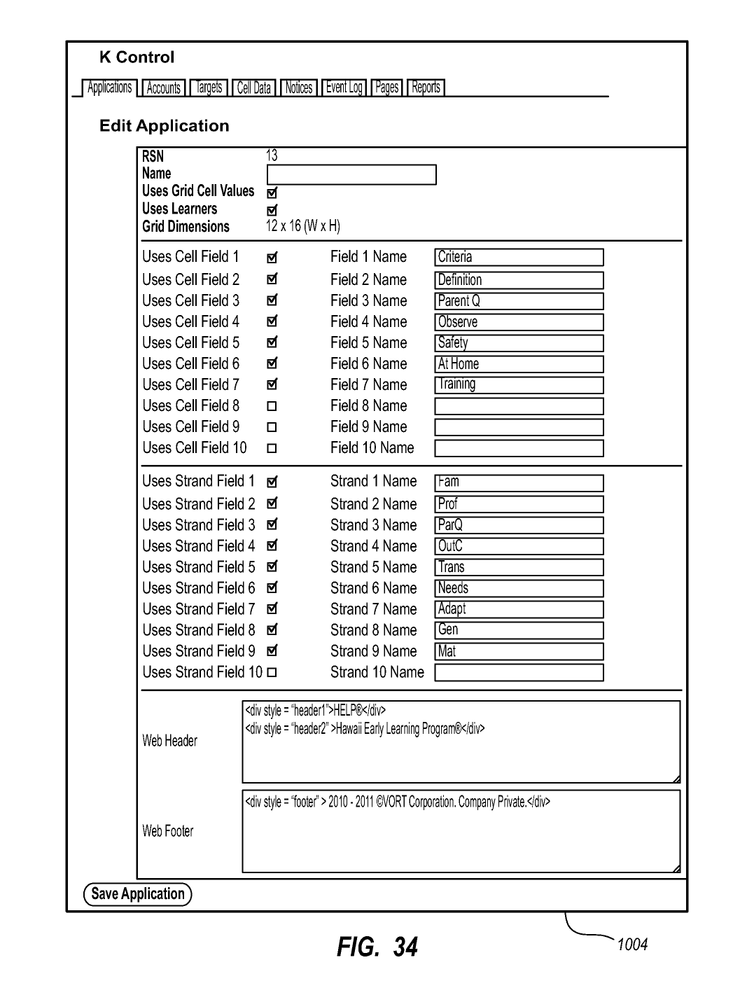

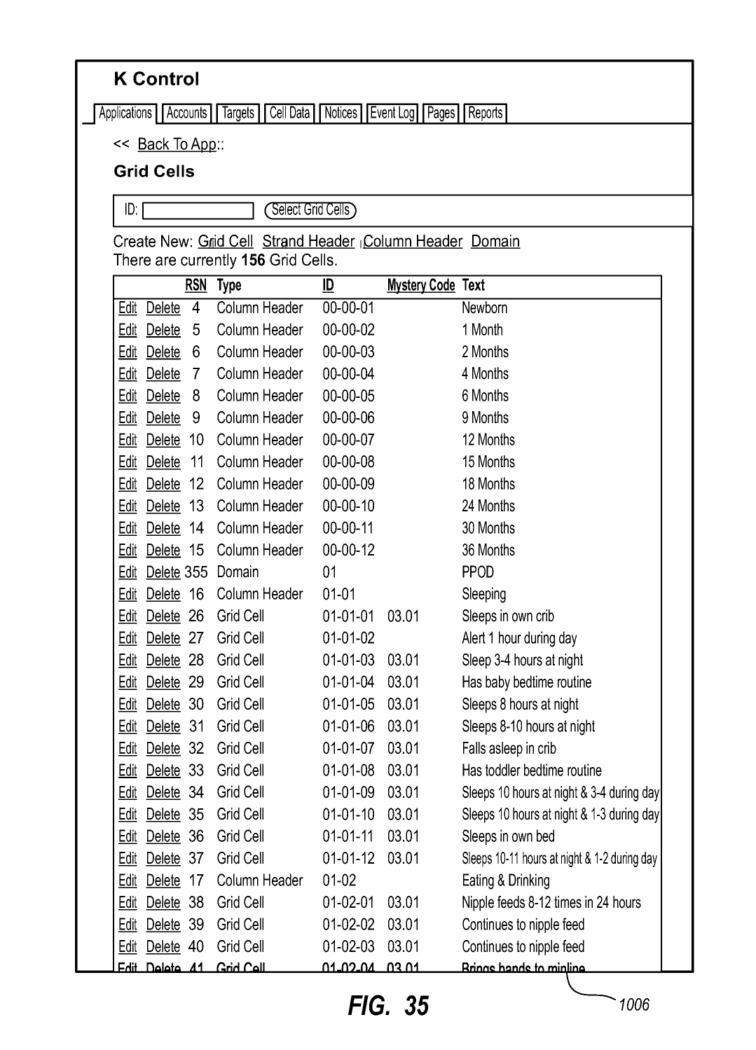

It is further noted that at act 458, the server 404 may access APIs, such as third party APIs. The APIs may allow for customizing, branding, or wrapping the user interface 500 or viewport 502 and subsequent content and behavior into a client's website or application. APIs can also allow for importing, arranging, editing, confirming, simulating, and testing the placement of client or user content within the user interface 500. Also, at the act 460, the server 404 may access system administrative settings and displays, such as the administrative displays disclosed in FIGS. 32-35.

The structured content that is ultimately displayed in the user interface 500 may either be loaded into the system 400 by a system administrator or one or more users. Alternatively, the structured content may be is dynamically received, based on the user's preferences or the system preferences. Further, the cells of the grid 504 may be configured to be automatically populated with multi-dimensional structured content based on one or more content preferences specified by a user or automatically derived from a pattern of usage of the cells of the grid 504 by a user. In another example, the metrics or indices of the columns and rows and the sources may be derived from a list of possible sources (the basis of the “structure”), such as web sites, news feeds, knowledge bases, Google Groups or Facebook® or other sources, some, for example, with API options. For example, the user might subscribe to several news and RSS feeds, and track friends' “Facebook Wall” or comments or photos or other content as posted on Facebook or other social media sites, and the content of these feeds might, for example, be used (either by the system 400 or by the user) to populate separate columns or rows within the grid 504. For example, the column header cell may be a chronology of time or other metric, thus allowing the user to capture, skim, browse, and get more detail on a variety of content from within their own personalized grid 504 which becomes a form of “home base” for the user to monitor, share, cross-reference, and access their social interaction and information from a wide range of sources.

When the user first accesses the structured content using user interface 500, the user can use one of a variety of methods to determine where to begin in the viewport 502. For example, the viewport 502 may initially automatically scroll to a starting portion of the grid 504 based on one or more metrics entered by a user of the user interface 500. These metrics may include, for example, keywords, photos, concepts, or the user's gender, age, geographical location, job type, education level, and/or background. Thus the user interface 500 can automatically facilitate where, within a large grid 504, a user might begin. In the case where the user is a professional, such as a teacher or therapist, or a parent, the user can enter preliminary information on the student/child to find which skills/steps match the child's/student's current level. In one example embodiment, a “screening” method (filter) might be available to be displayed within the continuum/array to determine which cells (objectives/needs) to begin working on. For example, a screening test or assessment may be used by educators, doctors, or human resource personnel in evaluating staff or job applicants. This screening method can employ identifying behaviors or other criteria be used to gauge where the person or item being assessed is on the progression of the structured content of the grid to find an appropriate starting point the starting point.

Further, answering the question “Where do I start?” can be accomplished by the user entering into the search box 508 keywords describing their goal, status in life, or problems/needs, or response to questions or images or adjective checklists The user interface 500 will match such information against rules or an internal thesaurus of terms related to the actual content of the grid 504, and then highlight for the user those cells initially applicable to the user. The user interface 500 may further have an option to automatically or upon request show the user the most frequently visited cells or changed cells.

Although the example user interfaces disclosed herein are all graphical user interfaces, it is understood that aspects of the user interfaces disclosed herein could instead be employed in other types of user interfaces including, but not limited to, auditory user interfaces that present data audibly to a user or a tactile user interfaces such as braille output interfaces.

### 3. First Example User Interface for Navigating Structured Content

With reference now to FIGS. 5-1 to 12-2, additional aspects of the first example user interface 500 will be disclosed. As noted above, the user interface 500 is configured to navigate structured content. As disclosed in FIGS. 5-1 to 12-2, the structured content of the user interface 5-1 to 12-2 is the Hawaii Early Learning Profile, with each cell containing one or more steps relating to child development. It is understood, however, that the user interface 500 could instead be used to navigate other structured content.

As noted above, and as disclosed in FIGS. 5-1 and 5-2, the user interface 500 generally includes the viewport 502, a grid 504 of multi-dimensional cells and the domain column 506 of cells that span multiple rows, the search box 508, the viewtracker 510, and the navigation arrows 512. The cells of the grid 504 are generally organized into horizontal rows and vertical columns. The grid 504 also includes a header column 514 made up of header column cells each positioned in a separate row of the grid 504.

Each cell in the grid 504 can be considered a container for structured content and a navigable object capable of displaying N-dimensional and nested structured content. Any dimension, cell, or portion of the grid 504 can have identifying numbers, symbols, colors or similar visual aids to help the user track which dimension they are on. For example, a header column cell number might also be shown in the cells in the same row as the header column cell. Further, an ID number or symbol may be used in each cell to denote what domain or content area it belongs to, or what phase or association or level of complexity the item/element might hold within the grid 504. Some ways to accomplish cell identification are: to show a gradation of color across the grid 504, showing related or associative properties of the content of the cells (e.g., functional or lexical), or showing a sense of task or development progression from simple to complex. The gradation might denote functional differences or assemblies, for example, as with an array of parts or elements comprising a whole such as a bill of materials listing, an organizational chart, or a sales or CRM list.

Each cell in the domain column 506 may be configured to display, upon selection, one or more additional dimensions of structured content applicable to all cells positioned in the rows spanned by the domain column cell. For example, the domain labeled “COGNITIVE” disclosed in FIGS. 5-1 and 5-2 may be selected, using a mouse pointer on a standard display or a finger on a touch display for example, to cause a second dimension of structured content applicable to all cells positioned in the rows spanned by the “COGNITIVE” domain column cell. This second dimension, or additional dimensions, may display in a separate interface object, such as a pop-up menu, a DIV, a modal or non-modal window, or other code-screen object, for example, that may or may not overlap at least a portion of the grid 504. It is understood that various other interface objects can be employed in the user interfaces disclosed herein other than those specifically illustrated in the drawings.

The viewtracker 510 includes a grid representation 518 of the grid 504 and a viewport representation 520 of the viewport 502. The viewport representation 520 is positioned within the grid representation 518 and overlays the grid representation 518. The viewport representation 520 visually conveys both the proportion of the grid 504 currently displayed in the viewport 502 as well as the position within the grid 504 of the portion of the grid 504 displayed in the viewport 502, thereby helping the user visualize where the user is in terms of either additional or total content to be viewed or progress along the progression of the grid 504. During scrolling within the viewport 502, the viewport representation 520 may also convey the rate of travel through the grid 504.

The viewport representation 520 is configured to automatically reposition within the grid representation 518 when the user repositions the portion of the grid 504 displayed in the viewport 502. Similarly, the portion of the grid 504 displayed in the viewport 502 is configured to automatically reposition when the user repositions the viewport representation 520 within the grid representation 518. Thus, the user can drag the viewport representation 520 within the viewtracker 510 to reposition the display within the actual viewport 502.

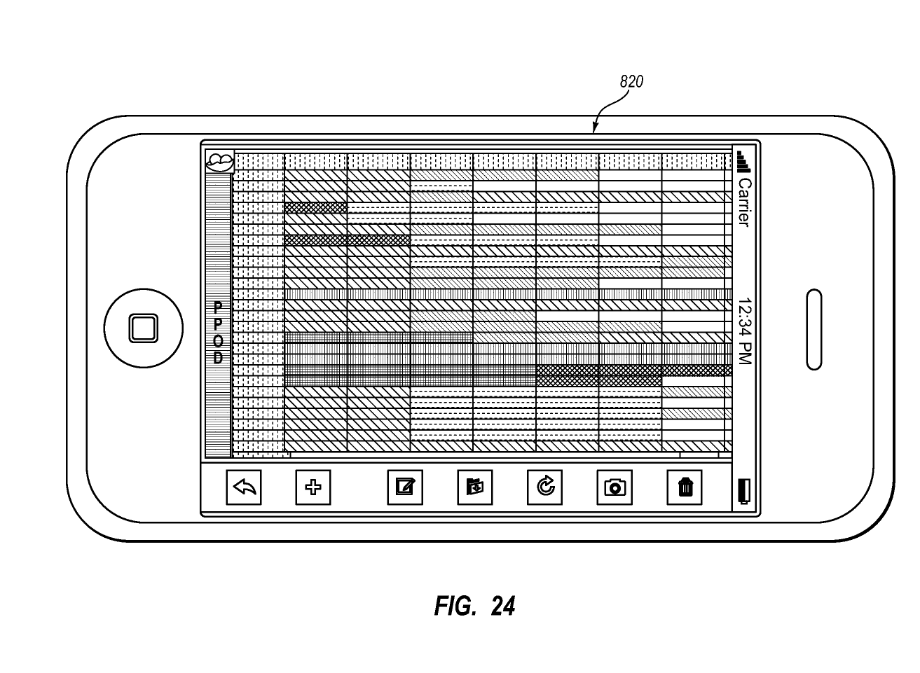

Although not disclosed in FIGS. 5-1 and 5-2, it is understood that the viewtracker 510 may also provide additional information regarding additional dimensions of structured content within the grid 504. For example, the viewtracker can be configured, using shades of color or some other visual indicator, to show those portions of the grid 504 that are most complete, most visited, or most popular, for example. Further, the viewport representation 520, the grid representation 518, or some combination thereof may visually convey a content density of the cells of the grid 504, with the content density of each cell being the amount of content in each cell, the number of dimensions of content in each cell, or some combination thereof. In one example embodiment, the viewtracker 510 may be further configured to display a summative representation of the status of the cells in the grid 504, similar to the summative representation 820 of the grid 804 as discussed below in connection with FIG. 24. The viewtracker 510 may also be configured as a rectangular cube instead of a flat rectangle.

As disclosed in FIGS. 6A-1 to 6B-2, the portion of the grid 504 displayed within the viewport 502 is can be repositioned automatically or by the user while the position of the viewport 502 itself remain constant and stationary within the user interface 500. For example, the portion of the grid 504 displayed within the viewport 502 can be repositioned by scrolling up, down, left, right, or diagonally. The diagonally scrolling can be accomplished by simultaneously scrolling both horizontally and vertically. In particular, upon reception of an indication that the portion of the grid 504 displayed within the viewport 502 should simultaneously scroll both horizontally and vertically, the multi-dimensional cells of the grid 504 are configured to scroll simultaneously within the viewport 502 both horizontally and vertically. For example, the portion of the grid 504 displayed within the viewport 502 in FIGS. 6A-1 and 6A-2 can be scrolled diagonally (two cells up and two cells to the left) as disclosed in FIGS. 6B-1 and 6B-2. At the same time, the cells of the header column 514, as well as the cells of the domain column 506, are configured to scroll in a synchronous manner so as to remain visible in the viewport 502 and remain aligned with the rows of multi-dimensional cells. Further, FIGS. 6B-1 and 6B-2 discloses that the portion of the grid 504 displayed within the viewport 502 is configured to automatically “snap” to align one or more cell boundaries with one or more edges of the viewport 502 after simultaneous horizontal and vertical scrolling.

The portion of the grid 504 displayed within the viewport 502 can be scrolled diagonally in various ways. For example, the indication that the portion of grid 504 displayed within the viewport 502 should scroll diagonally may be received upon a user dragging the grid 504 diagonally, using a mouse pointer on a standard display or a finger on a touch display, for example. Alternatively, the indication may be received upon a user selecting a spot on the navigation arrows 512 in between two arrows or by simultaneously pressing two arrow keys on a keyboard. Further, the indication may be received by a user dragging the viewport representation 520 within the viewport 510. Also, the indication may be received by the user searching for a particular keyword using the search box 508 and the user interface 500 automatically generating the indication in order to reposition the viewport 502 over a particular search result cell(s). Finally, it is noted that in additional to diagonal scrolling, the portion of the grid 504 displayed within the viewport 502 can also simply be scrolled up, down, left, or right using the arrow keys on a keyboard for example.

Each of the multi-dimensional cells is configured to display only a first dimension of structured content before selection, as disclosed in FIGS. 5-1 and 5-2, and display one or more additional dimensions of structured content upon selection, thus providing the user with the ability to navigate through multiple dimensions of structured content.

For example, the additional dimensions of structured content may include supportive or related information specific to the cell selected. Such supportive information can include for example, definitions, examples, hints, procedures, glossaries, details, guidelines, cross-references, links to other cells or outside webpages, or video clips or movies or audio segments or images or photos used for training the user on or about the content of the selected cell. In one embodiment where the supportive information is in the form of video clips, the user can select from a screen object/device different-language audio overlays or segments, so that, for example, the same video clip/content is provided for an English-speaking user who selects English as the language in which to hear the content or instructions whereas a Spanish-speaking user can watch the same video clip/content but select Spanish as the preferred language in which to hear the audio content or instructions overlaying or accompanying the video content.

In another example, as disclosed in FIGS. 7-1 and 7-2, each of the cells in the row 522 has been selected by the user selecting the header column cell 1-6A. The selection of the cells in the row 522 causes the cells to expand downward, also known as “accordion expansion,” and causes other cells positioned in rows beneath the row 522 of the selected header column cell 1-6A to shift downward in response to the downward expansion of the cells in row 522. The accordion expansion of the cells positioned in row 522 enables a second dimension 524 of content to be displayed in each of the expanded cells. The downward shifting of the cells beneath the row 522 enables the cells in the row 522 to expand and the second dimension 524 of content to be displayed without covering the content of the cells beneath the row 522. It is noted that the selection of a cell can be accomplished in a variety ways including, but not limited to, a mouse click, a mouse hover, a finger touch on a touch screen, the use of control keys, voice commands, or some combination thereof. For example, content of the cells may be text that is converted text-to-speech, and the user can use voice commands corresponding to the resulting speech in order to select or otherwise navigate a cell, grid, or any other interface object.

In at least some example embodiments, the user can set preferences to define the behavior of the accordion expansion of the cells within the viewport 502. For example, whether or not moving a pointing device out of a cell contracts that cell or keeps the cell expanded, or double clicking/touching a cell causes another layer or overlay of content (perhaps semi-opaque in appearance) to be positioned on or near the current cell. Further, it should be noted that the accordion expansion of cells may be applied to many levels of structured content to form nested and cascading accordion expansion and contraction.

In another example, as disclosed in FIGS. 8-1 and 8-2, the cell 4.29 in the column 526 has been selected by the user. The selection of the cell 4.29 causes the accordion expansion of the cell 4.29. The downward expansion of the cell 4.29 enables a second dimension 528 of content to be displayed in the expanded cell 4.29. The downward shifting of the cells beneath the expanded cell 4.29 in the column 526 enables the cell 4.29 to expand and the second dimension 528 of content to be displayed without covering the content of the cells beneath the expanded cell 4.29 in the column 526.

In another example, as disclosed in FIGS. 9A-1 to 9B-2, the cell 1.31 in the column 530 has been selected by the user. The selection of the cell 1.31 causes the accordion expansion of the cell 1.31, thus enabling a second dimension 532 of content to be displayed in the expanded cell 1.31. In addition, as disclosed in FIGS. 9A-1 and 9A-2, the selecting of the first dimension 534 of content in the cell 1.31, by clicking on the text, hovering over the text, or touching a touch display over the text of the first dimension 534 for example, causes another dimension of content to display in a modal menu 536. Similarly, as disclosed in FIGS. 9B-1 and 9B-2, the selecting of the second dimension 532 of content in the cell 1.31 has caused another dimension of content to display in another pop-up menu 538.

In another example, as disclosed in FIGS. 10-1 and 10-2, the cell 1.14 in the column 540 has been selected by the user. The selection of the cell 1.14 causes the accordion expansion of the cell 1.14, thus enabling a second dimension 542 of content to be displayed in the expanded cell 1.14.

In another example, as disclosed in FIGS. 11-1 and 11-2, the cell 1.26 in the column 540 has been selected by the user. The selection of the cell 1.26 causes the accordion expansion of the cell 1.26, thus enabling a second dimension 544 of content to be displayed in the expanded cell 1.26. In addition, as disclosed in FIGS. 11-1 and 11-2, the cell 1.45 is linked to the cell 1.26 such that the selection of the cell 1.26 also cause the accordion expansion of the cell 1.45 in the column 546, thus enabling a second dimension 548 of content to be displayed in the expanded cell 1.45. Further, the grid 504 is configured to highlight, upon selection of the linked cell 1.26, all cells linked to the selected cell 1.26, which is this case is only the cell 1.45. The highlighting of linked cells may be triggered by a special form of selection, for example, by clicking one cell while pressing the control key.

The cell 1.26 and 1.45 may be linked in various ways. For example, the cell 1.45 may be linked to the cell 1.26 automatically and dynamically based on a pattern of usage of the cells of the grid 504 by a user. For example, the structured content in the grid 504 may constitute a decision map where a decision point presented in any one cell may lead to various other cells depending on the decision made by a user. Thus, the cells of the grid 504 may be conditionally linked and only functionally linked once a user makes decisions from cell to cell. Alternatively, cells within the grid 504 may be manually linked by a user or by a system administrator.

Further, cells may be dynamically or heuristically linked, wherein action in one cell connects or navigates to cells with related content. For example, “See Also” content can be based on dynamically or heuristically established relationships based on language/lexical, membership, and/or concept matching. Such dynamically-related content might stem from an immediate, pre-defined relationship, or be based on heuristic determination based on the user's movement and action with other cells in a grid, thus allowing new or other relations between cells to be established. For example, tracking a user's repeated action on or behavior with a series of cells can be used to determine levels of interest and type of interaction from which subsequent heuristically-determined relations can be established, and then applied as new sets of rules or relationships, all of which are repeatedly challenged and altered using heuristic means.

In addition, as disclosed in FIGS. 11-1 and 11-2, the selecting of the second first dimension 544 of content in the cell 1.26, by highlighting the text or hovering over the text for example, causes a third dimension of content to display in a drop down 550. Thus selection of the cell 1.26 enables the display of multiple additional dimension of structured content, as well as the highlighting or cells linked to the cell 1.26.

FIGS. 12-1 and 12-2 disclose search capabilities within the example user interface 500. In particular, a user can enter text into the search box 508 in order to search the structured content of the grid 504 based on any of a variety of criteria including, but not limited to, content within any of the dimensions of the cells, cell ID numbers, and/or a thesaurus or corpus related to the content. Search results can appear as a list of hits, or in a dynamic object 552 using auto-completion techniques. As the user selects a result from the search, if the selected cell is not currently displayed in the viewport 502, the user interface 500 will automatically reposition the viewport over the selected cell, and the viewtracker 510 will show the user the relative position of the navigated-to-cell within the grid 504. In one embodiment, the search result might select and highlight multiple cells, thus automatically causing the according expansion of the multiple cells.

### 4. Second Example User Interface for Navigating Structured Content

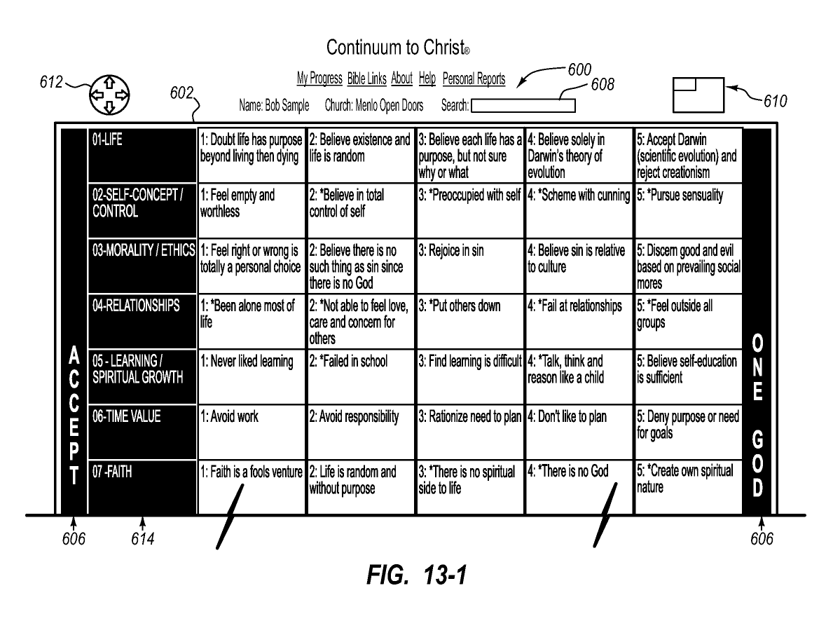

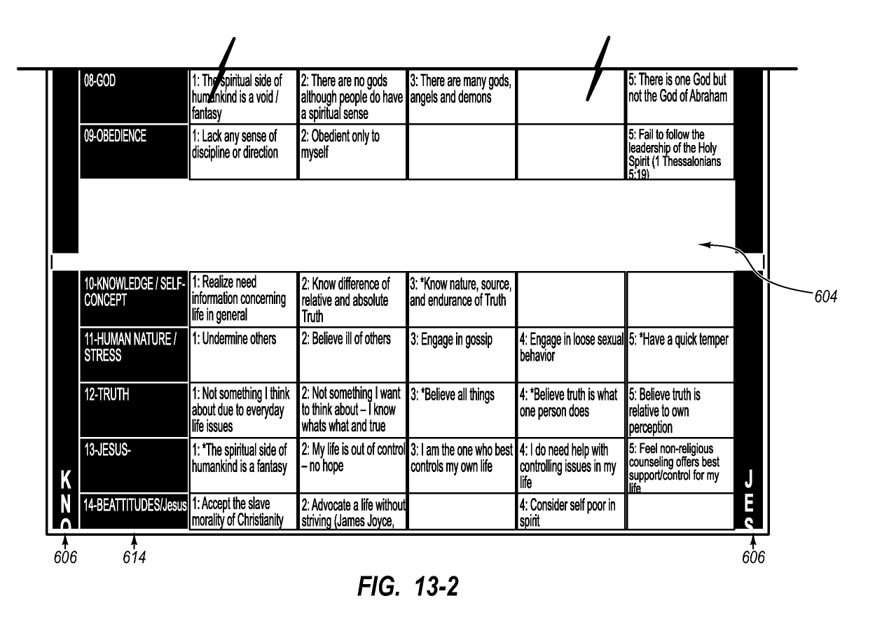

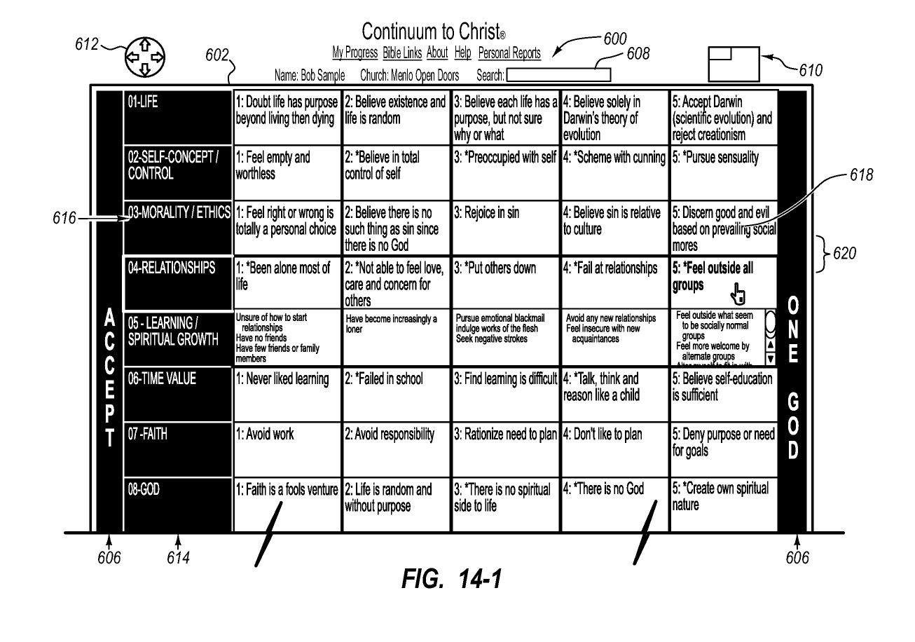

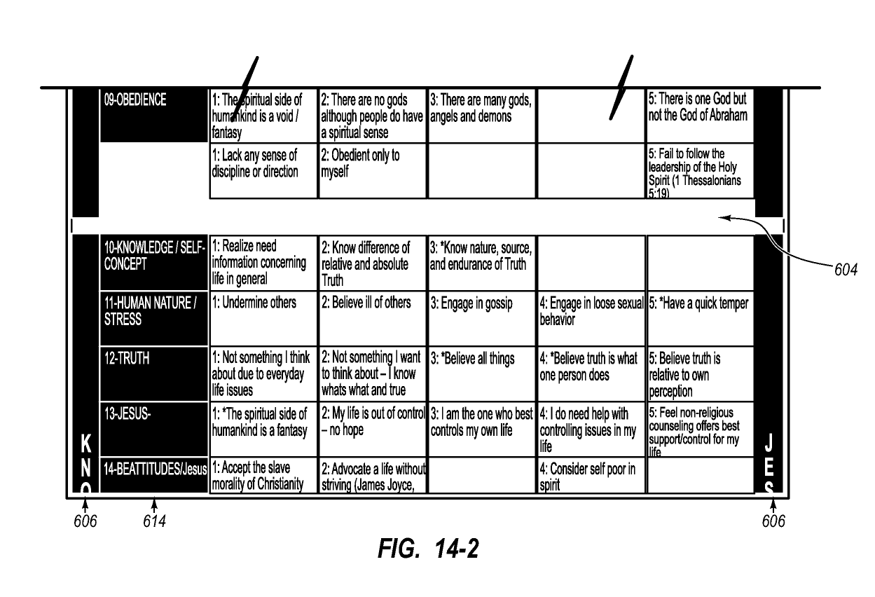

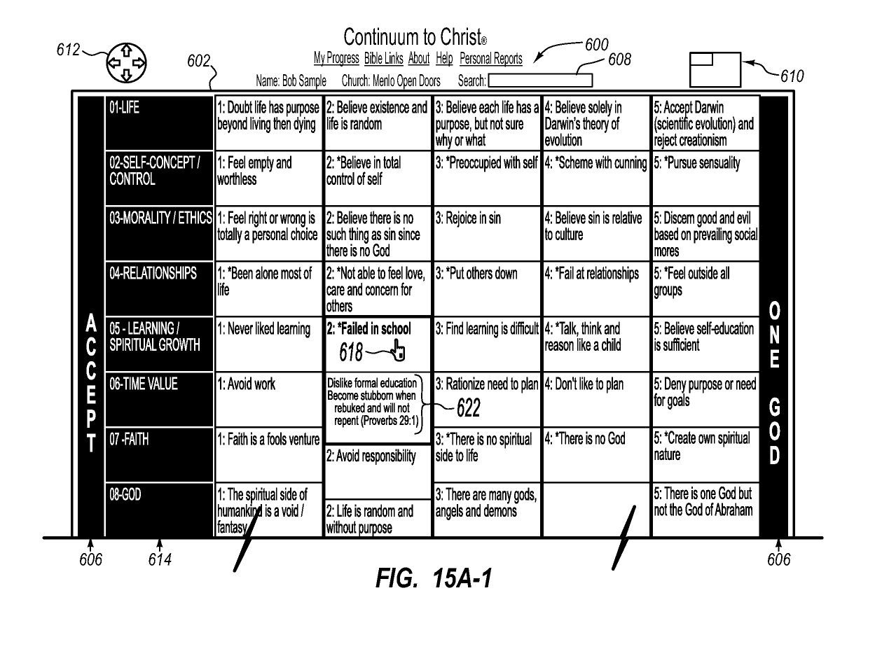

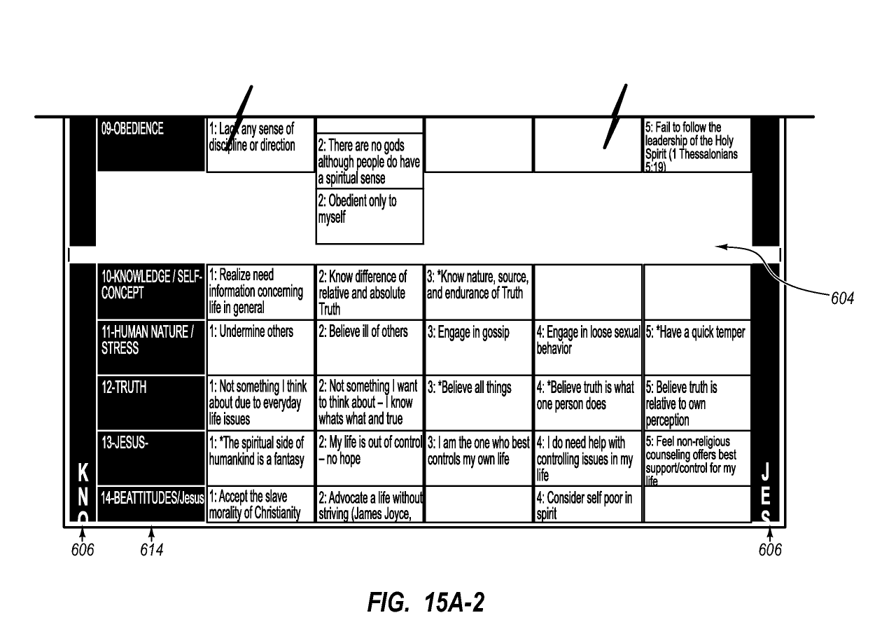

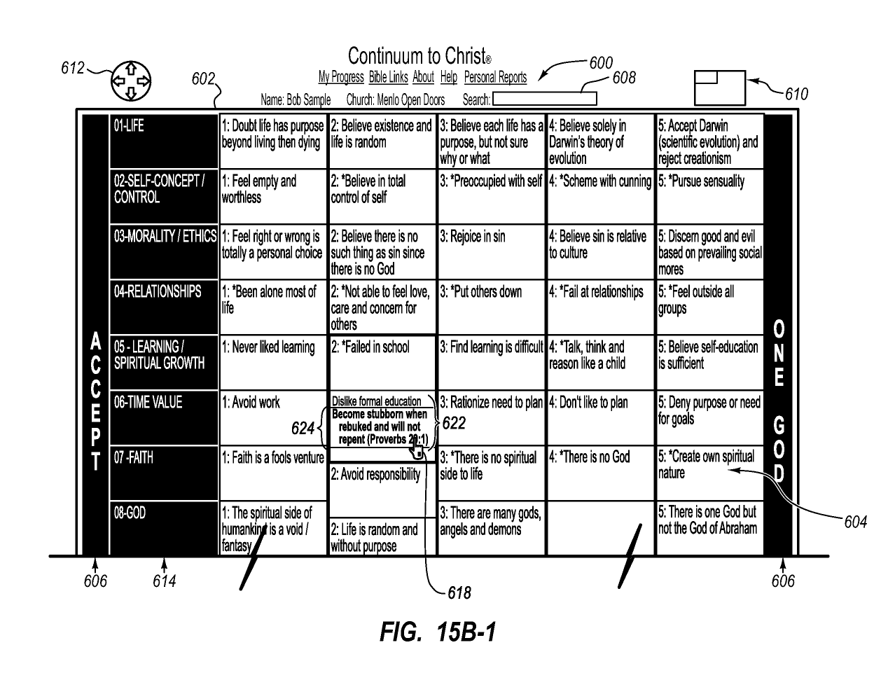

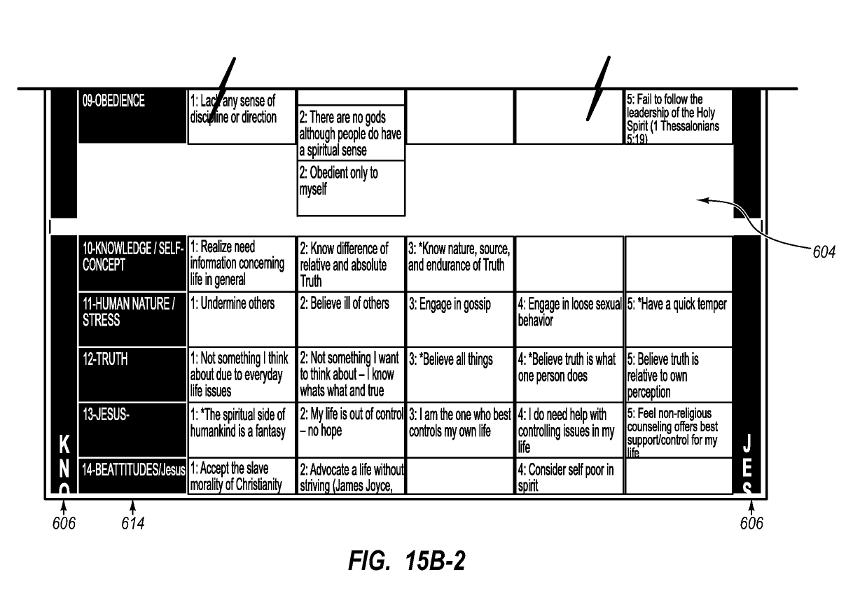

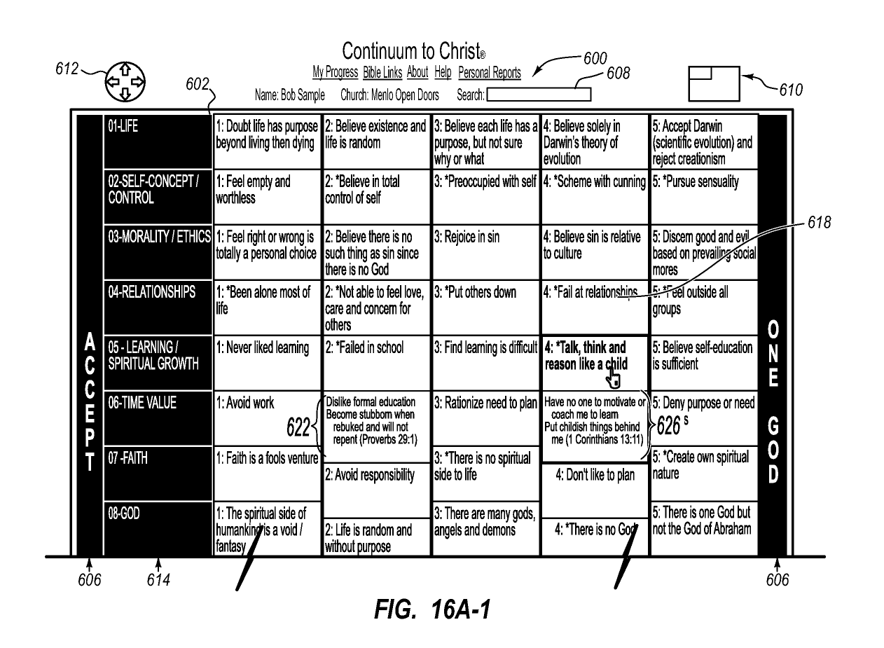

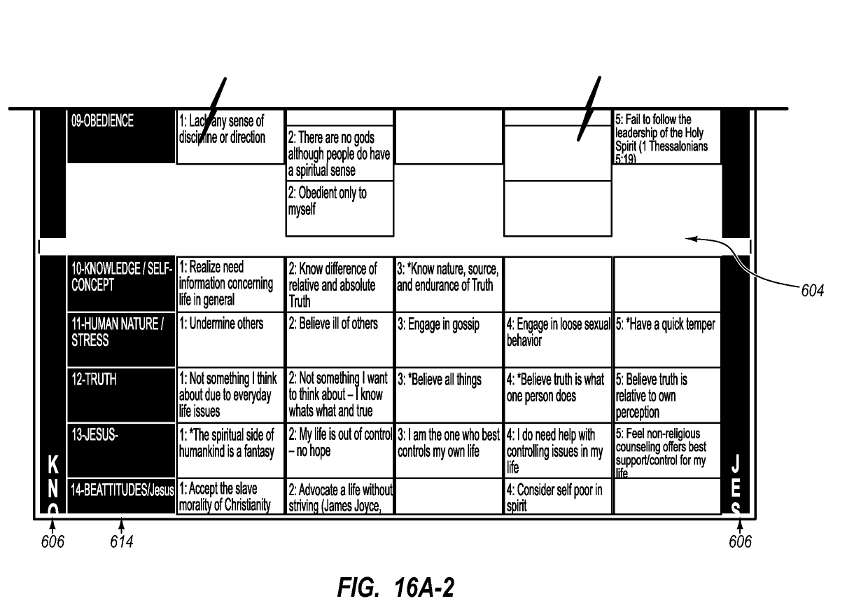

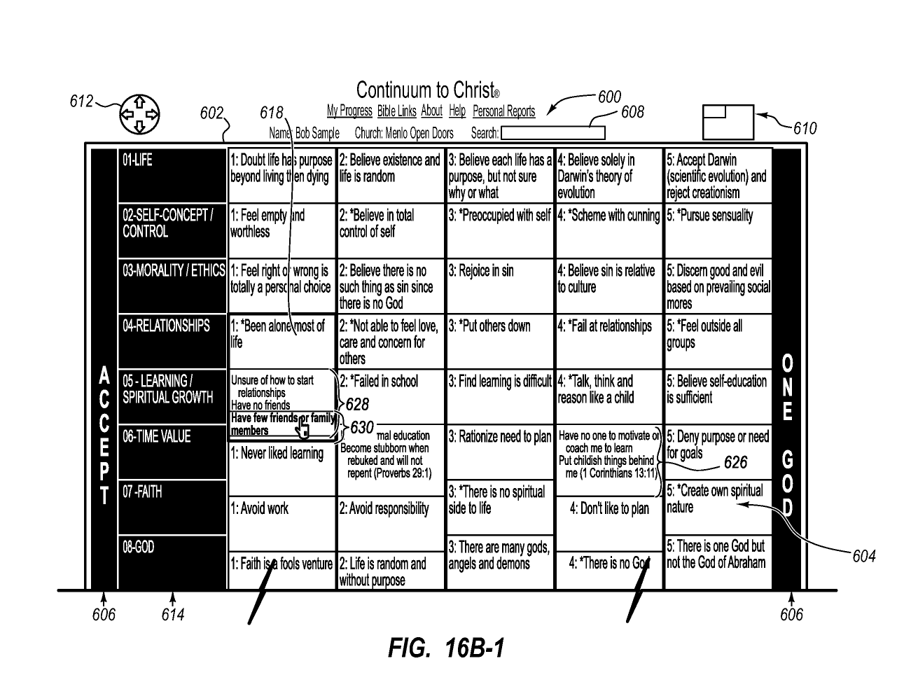

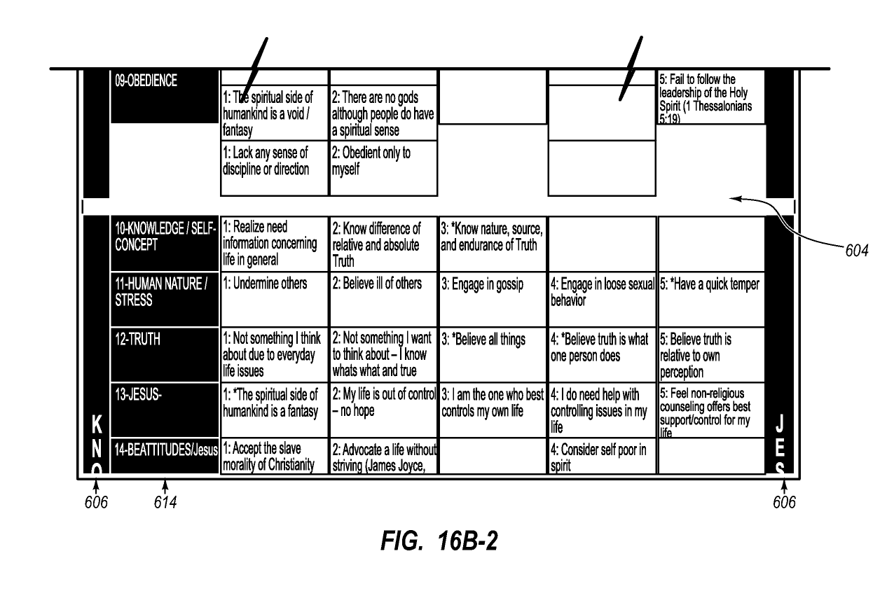

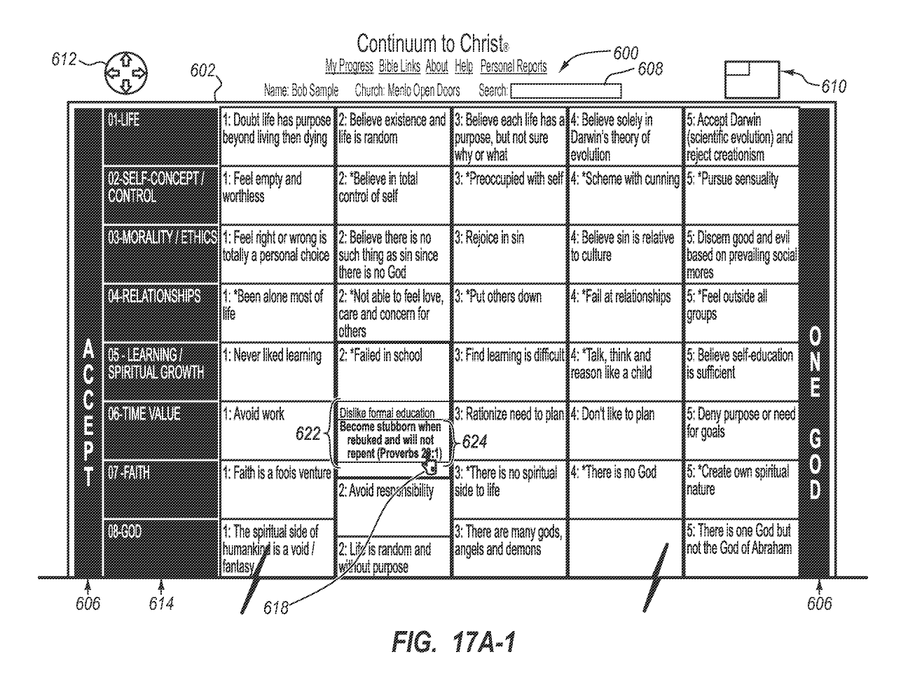

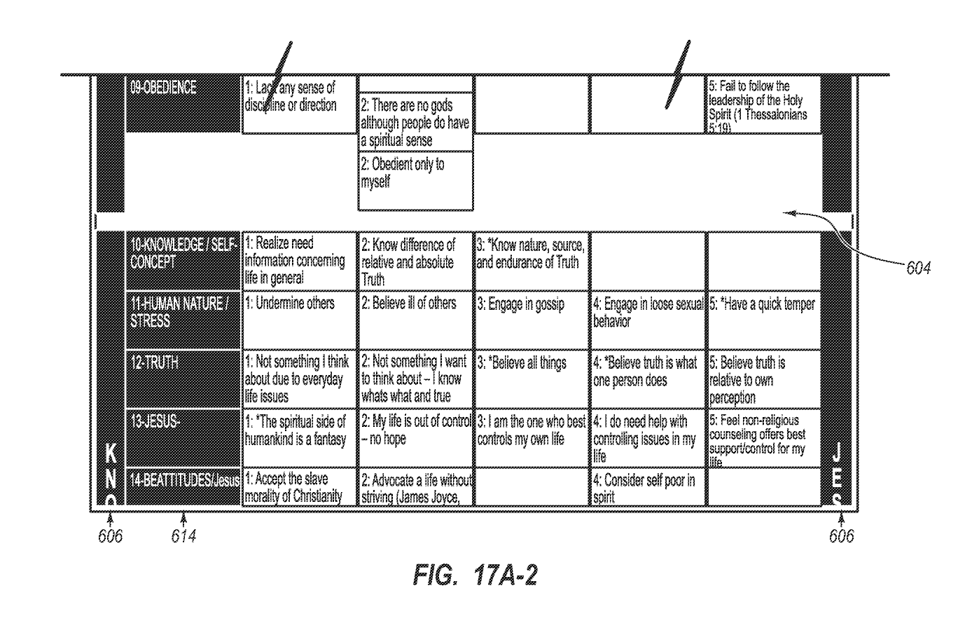

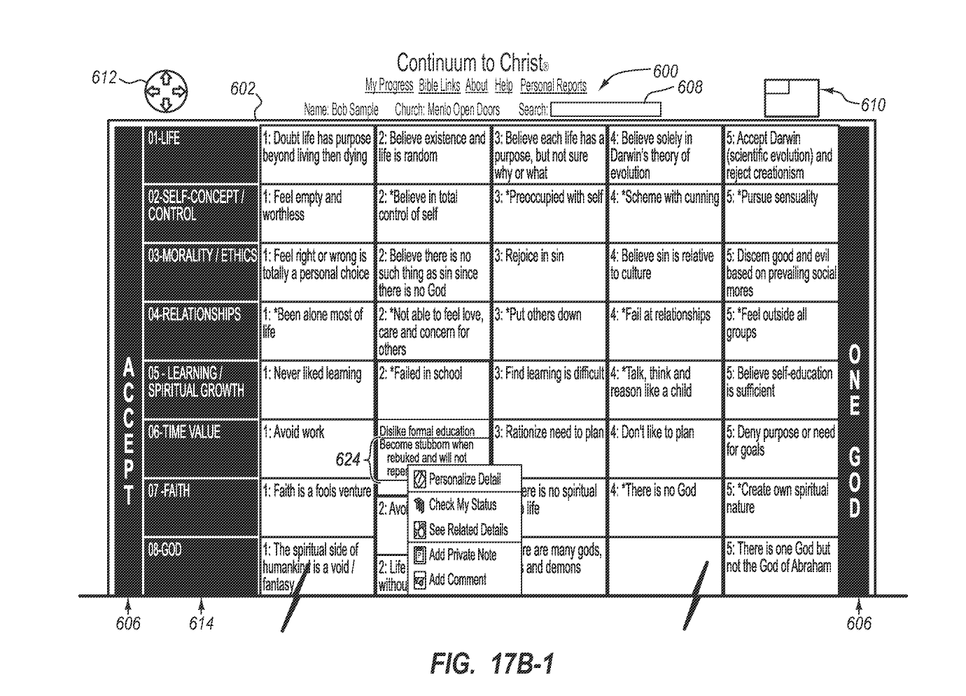

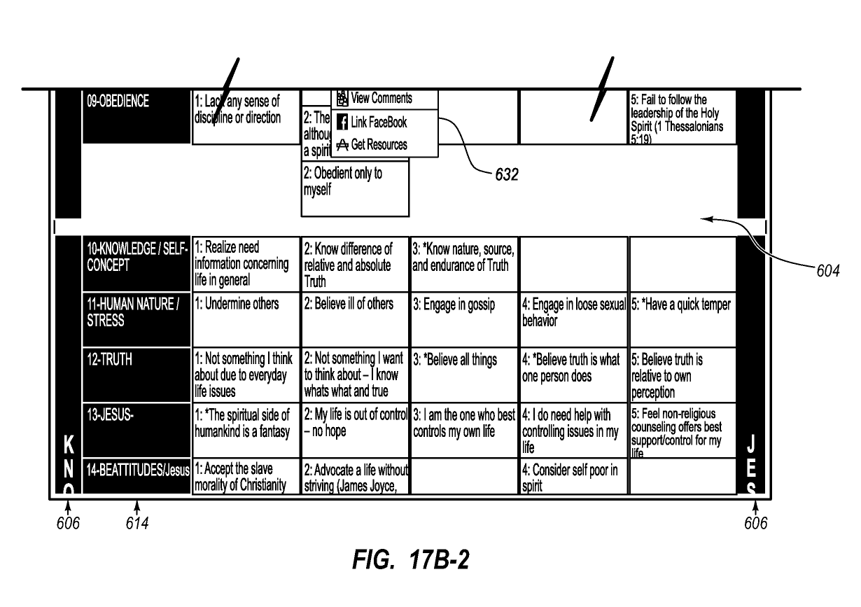

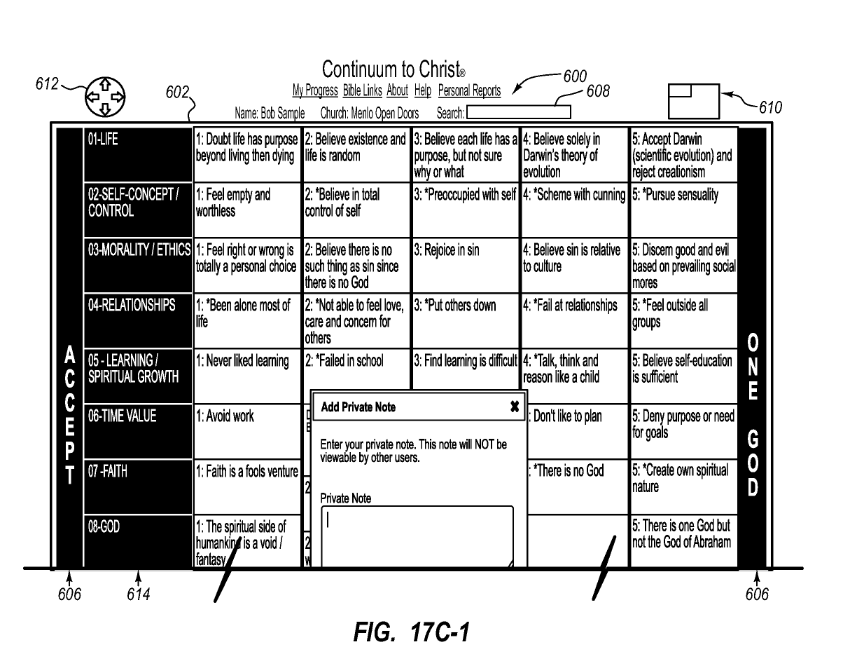

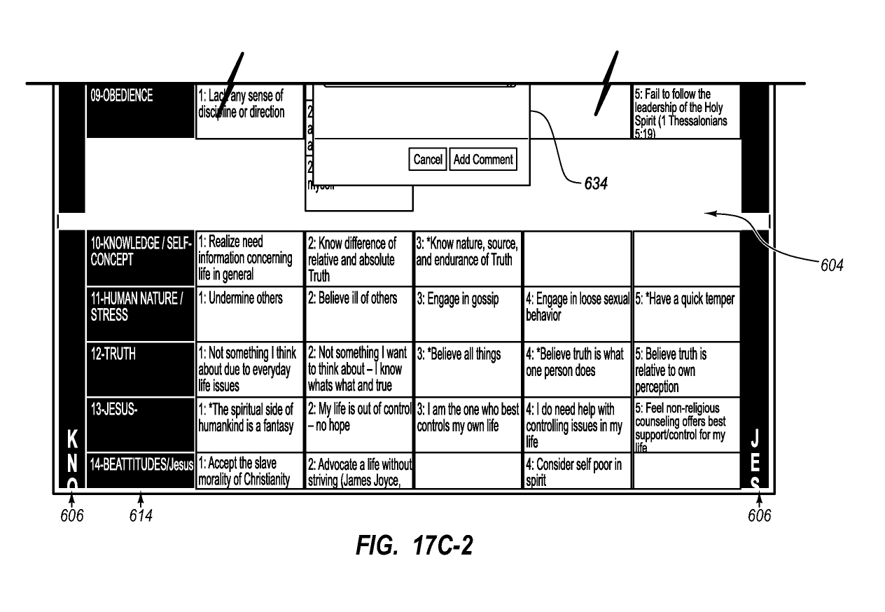

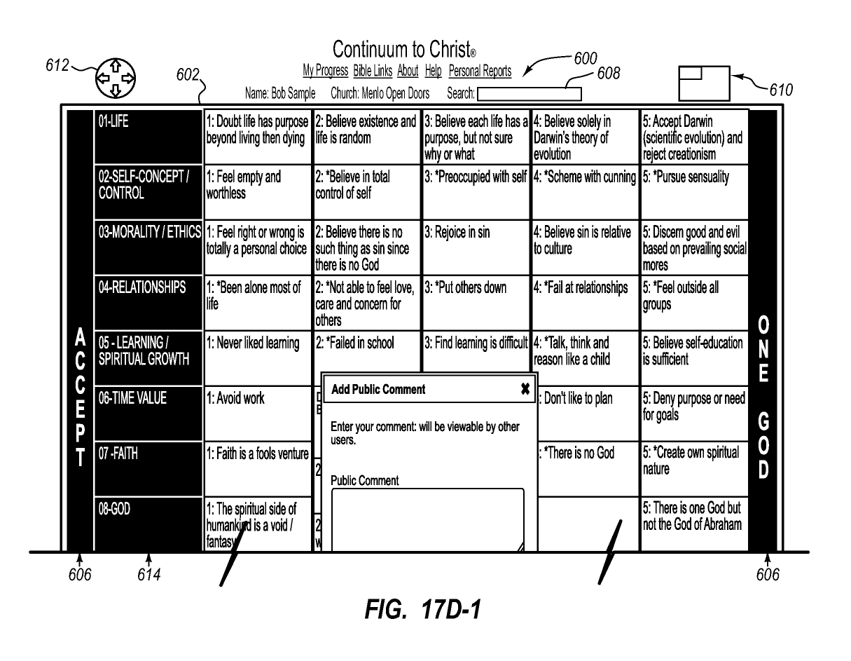

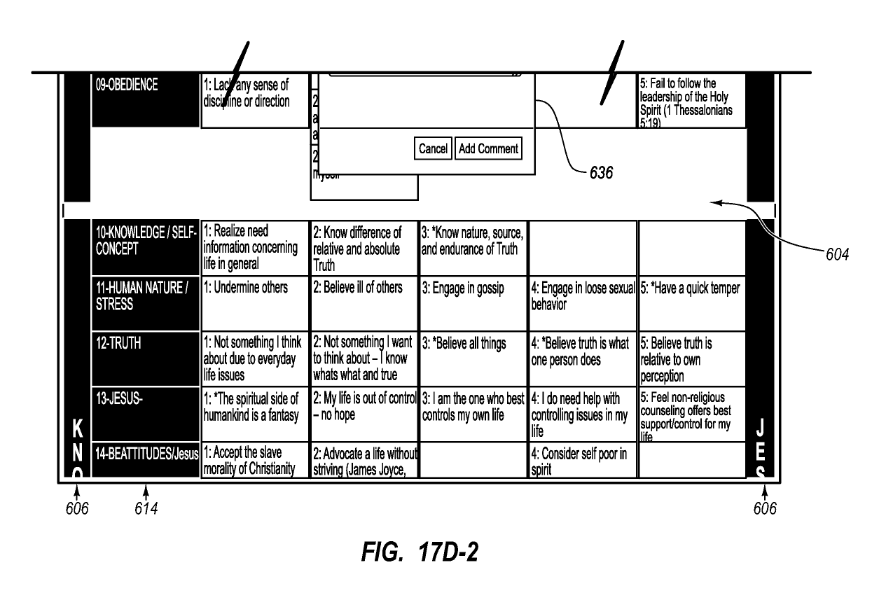

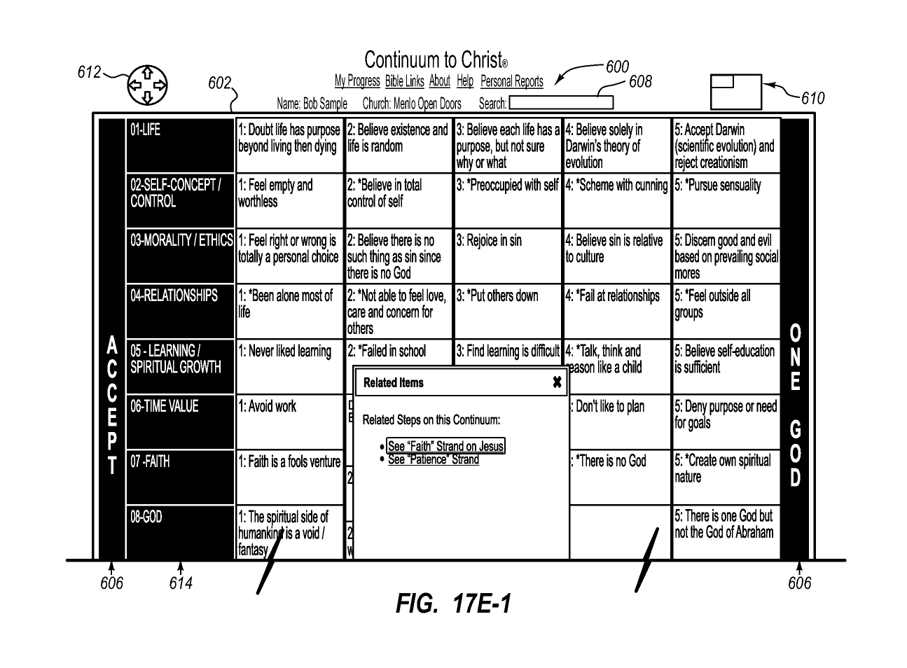

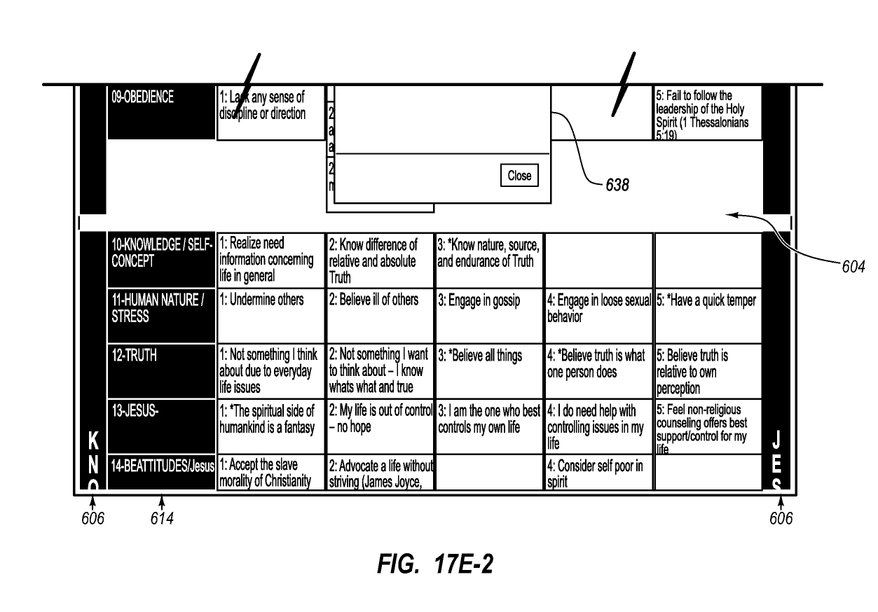

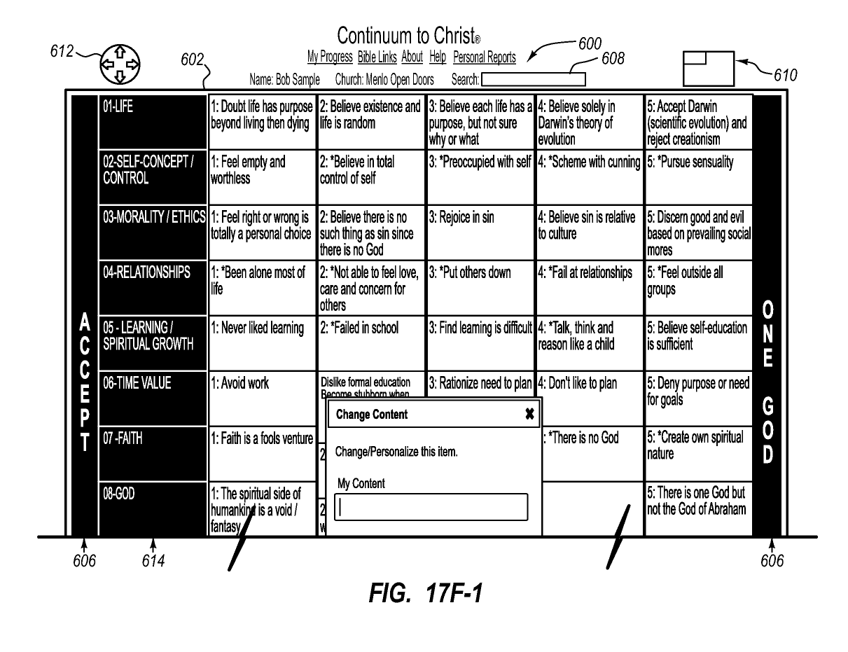

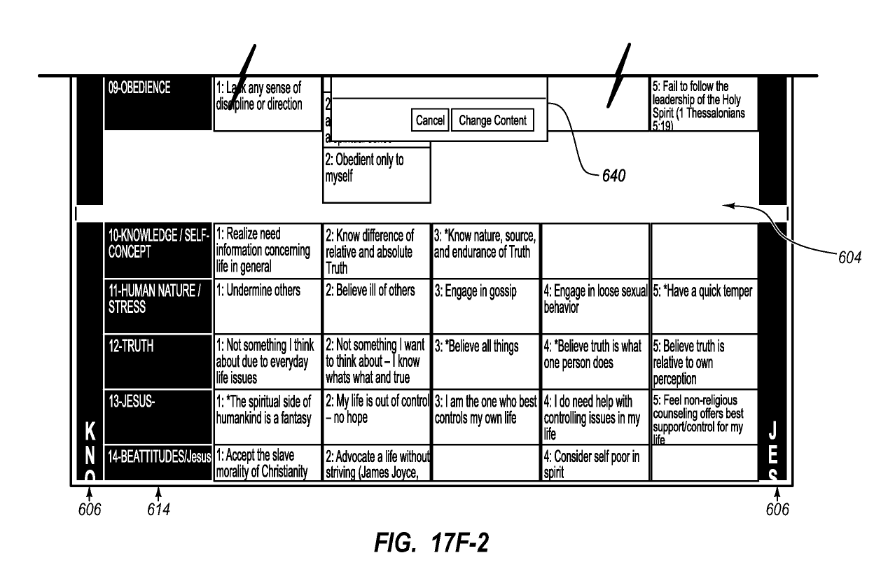

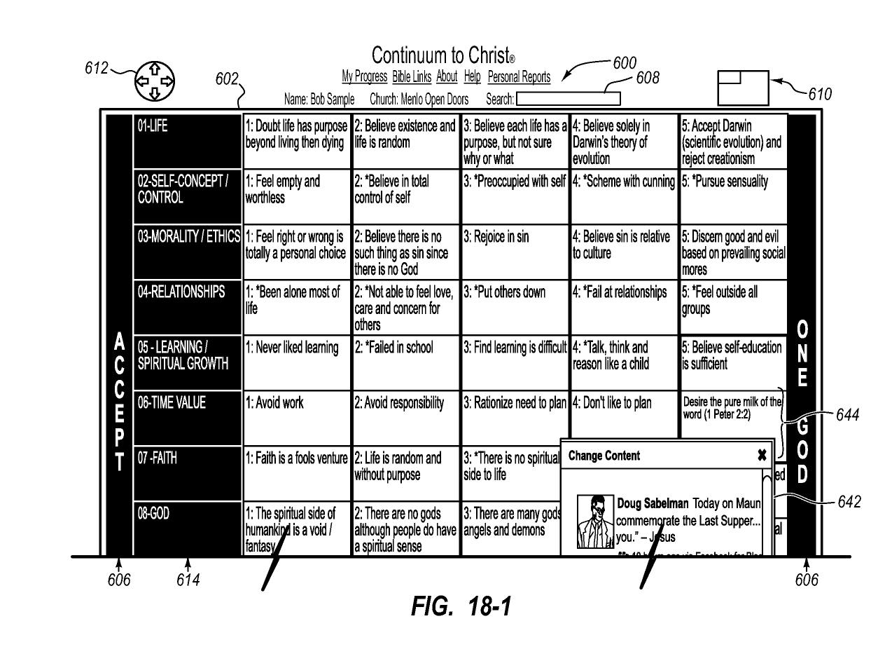

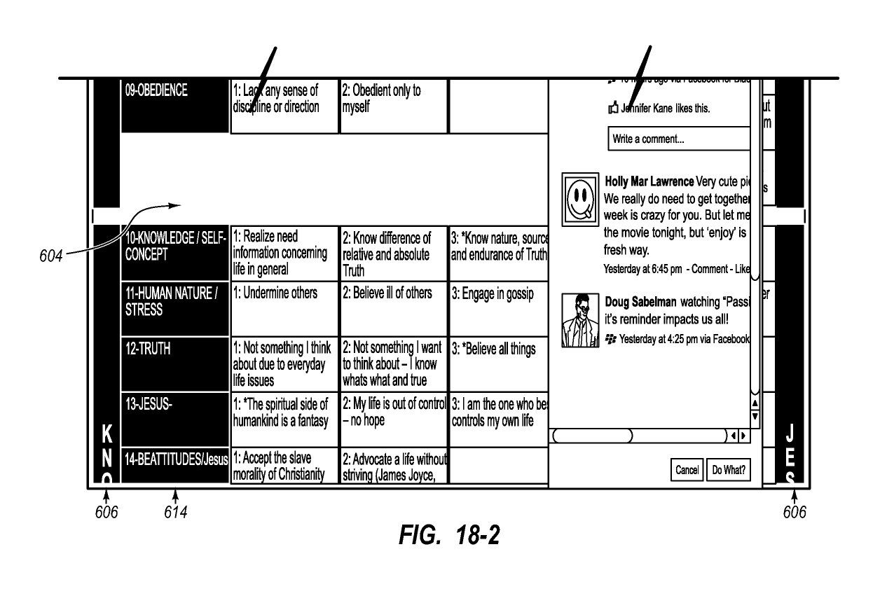

With reference now to FIGS. 13-1 to 18-2, a second example user interface 600 is disclosed. As with the user interface 500, the user interface 600 is configured to navigate structured content. As disclosed in FIGS. 13-1 to 18-2, the example structured content of the user interface 600 is the Continuum to Christ, with each cell containing one or more steps relating to progress within the Christian faith. Since faith is such a personal issue requiring easily-customized content for the user to truly feel the content applies to him/her, the user interface 600 starts with default content, but then allows the user to create and manage content that is balanced, uniquely and highly personal, and therefore relevant to the user. It is understood, however, that the user interface 600 could instead be used to navigate other structured content.

As disclosed in FIGS. 13-1 and 13-2, the user interface 600 generally includes a viewport 602, a grid 604 of multi-dimensional cells, left and right domain columns 606, a search box 608, a viewtracker 610, and navigation arrows 612. The cells of the grid 604 are generally organized into horizontal rows and vertical columns. The grid 604 also includes a header column 614 made up of header column cells each positioned in a separate row of the grid 604. Each of the multi-dimensional cells of the grid 604 is configured to display only a first dimension of prepopulated structured content before selection, as disclosed in FIGS. 13-1 and 13-2, and display one or more additional dimensions of prepopulated and/or user-modified structured content upon selection.

For example, as disclosed in FIGS. 14-1 and 14-2, each of the cells in the row 616 has been automatically selected by the user selecting the cell 04-5 with a mouse pointer 618. The selection of the cells in the row 616 causes accordion expansion of the cells. The accordion expansion of the cells positioned in row 616 enables a second dimension 618 of content to be displayed in each of the expanded cells. The downward shifting of the cells beneath the row 616 enables the cells in the row 616 to expand and the second dimension 620 of content to be displayed without covering the content of the cells beneath the row 620.

In another example, as disclosed in FIGS. 15A-1 and 15A-2, the cell 05-2 has been selected by the user using the mouse pointer 618. The selection of the cell 05-2 causes the accordion expansion of the cell 05-2. The downward expansion of the cell 05-2 enables a second dimension 622 of content to be displayed in the expanded cell 05-2. Next, as disclosed in FIGS. 15B-1 and 15B-2, a portion 624 of the second dimension 622 of content of the expanded cell 05-2 has been selected by the user using the mouse pointer 618, which causes the text of the portion 624 to become highlighted.

In another example, as disclosed in FIGS. 16A-1 and 16A-2, the cells 05-2 and 05-4 have been selected by the user by floating the mouse pointer 618 over the cells, which causes the accordion expansion of the cells 05-2 and 05-4. The downward expansion of the cell 05-2 and 05-04 enables second dimensions 622 and 626 of content to be displayed in the expanded cells 05-2 and 05-4, respectively. Thus, a user can accordion expand a first cell then a second cell and simultaneously view the second dimensions of content in the expanded cells. Further, as disclosed in FIGS. 16B-1 and 16B-2, the cell 04-1 has been selected by the user by floating the mouse pointer over the cell. The selection of the cell 04-1 causes the accordion expansion of the cell 04-1 and enables a second dimension 628 of content to be displayed in the expanded cell 04-1. Next, a portion 630 of the second dimension 628 of content of the expanded cell 04-1 has been selected by the user using the mouse pointer 618, which causes the text of the portion 630 to become highlighted.

In yet another example, as disclosed in FIGS. 17A-1 and 17A-2, the cell 05-2 has been selected by the user using the mouse pointer 618, causing the accordion expansion of the cell 05-2 and enabling a second dimension 622 of content to be displayed in the expanded cell 05-2. Also, the portion 624 of the second dimension 622 of content of the expanded cell 05-2 has been selected by the user clicking the mouse pointer 618. As disclosed in FIGS. 17B-1 and 17B-2, the selection of the portion 624 of the second dimension 622 of content also causes another dimension of content to display in a pop-up menu 632.

If the user selects the “Add Private Note” option on the pop-up menu 634 disclosed in FIGS. 17B-1 and 17B-2, another dimension of content is displayed in FIGS. 17C-1 and 17C-2 in yet another modal window 634. The modal window 634 allows the user to privately annotate or comment on the step described in the second dimension 622. Alternatively, if the user selects the “Add Public Comment” option on the pop-up menu 632 disclosed in FIGS. 17B-1 and 17B-2, another dimension of content is displayed in FIGS. 17D-1 and 17D-2 in yet another modal window 636. The modal window 636 allows the user to annotate or comment on the step described in the second dimension 622 for public viewing. Similarly, if the user selects the “See Related Details” option on the pop-up menu 632 disclosed in FIGS. 17B-1 and 17B-2, another dimension of content is displayed in FIGS. 17E-1 and 17E-2 in yet another modal window 638. The modal window 638 allows the user to select cells that are linked to the currently selected cell 05-2, as discussed above, thus potentially enabling the user find related structured content that can help teach, instruct, inform, or provide background on the structured content of the selected cell. Moreover, if the user selects the “Personalize Detail” option on the pop-up menu 632 disclosed in FIGS. 17B-1 and 17B-2, another dimension of content is displayed in FIGS. 17F-1 and 17F-2 in yet another modal window 640. The modal window 640 allows the user to edit or customize the content of the selected cell 05-2, thus potentially improving content relevance by making it more personal, for example. In one example embodiment, the user can hold down a Control key (or equivalent function on their device) and toggle between viewing the original default content and the user's own changed content in the viewport 602. In another embodiment, the user can send a public or anonymous request to other users who may have changed similar content.

With reference now to FIGS. 18-1 and 18-2, a modal social-networking window 642 of the cell 05-5 within the user interface 600 is disclosed. As disclosed in FIGS. 18-1 and 18-2, the cell 05-5 has been selected by the user, causing the accordion expansion of the cell 05-5 and enabling a second dimension 644 of content to be displayed in the expanded cell 05-5. Next, the selection of the second dimension 644 of content causes another dimension of content to display in the social-networking window 642. The social-networking window 642 allows the user to network with other users who, for example, are interacting with a similar user interface to the user interface 600.

For example, the user interface 600 may be part of a social-networking system of user interfaces for navigating structured content and for content-driven and context-specific social networking. The system may be made up of multiple user interfaces, each associated with a user. The social-networking system may further automatically monitor the interaction of each user with the associated user interface and recommend users to each other based on the monitoring of user interaction with the user interfaces.

For example, the social-networking system may recommend users to each other based on users having chosen to interact with user interfaces that include identical or similar structured content. For example, where multiple users have chosen to interact with user interfaces with structured content that is identical or similar to the structured content of the user interface 600, the system may recommend the users to each other. Thus, the structured content engenders social interaction.

In another example, the social-networking system may recommend users to each other based on the similarity of patterns of usage of the cells of the grids of the users. For example, where users “Doug Sabelman” and “Holly Mar Lawrence” have selected and/or modified the cell 05-5 of user interfaces identical to the user interface 600, the system may automatically recommend that “Doug Sabelman” and “Holly Mar Lawrence” chat with each other using the social-networking window 642.

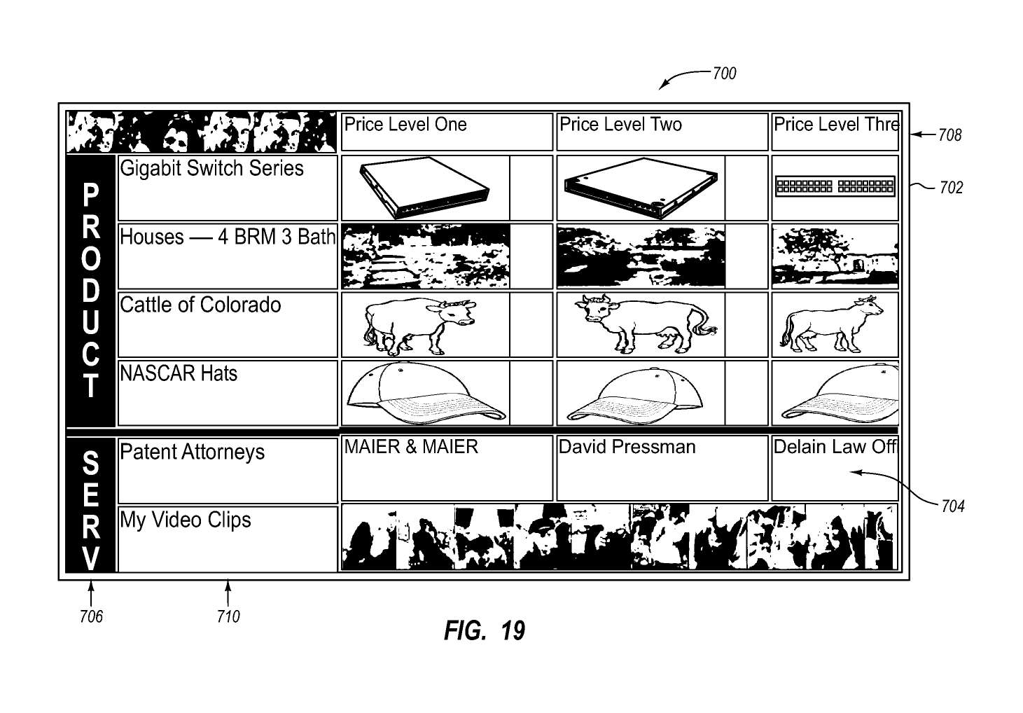

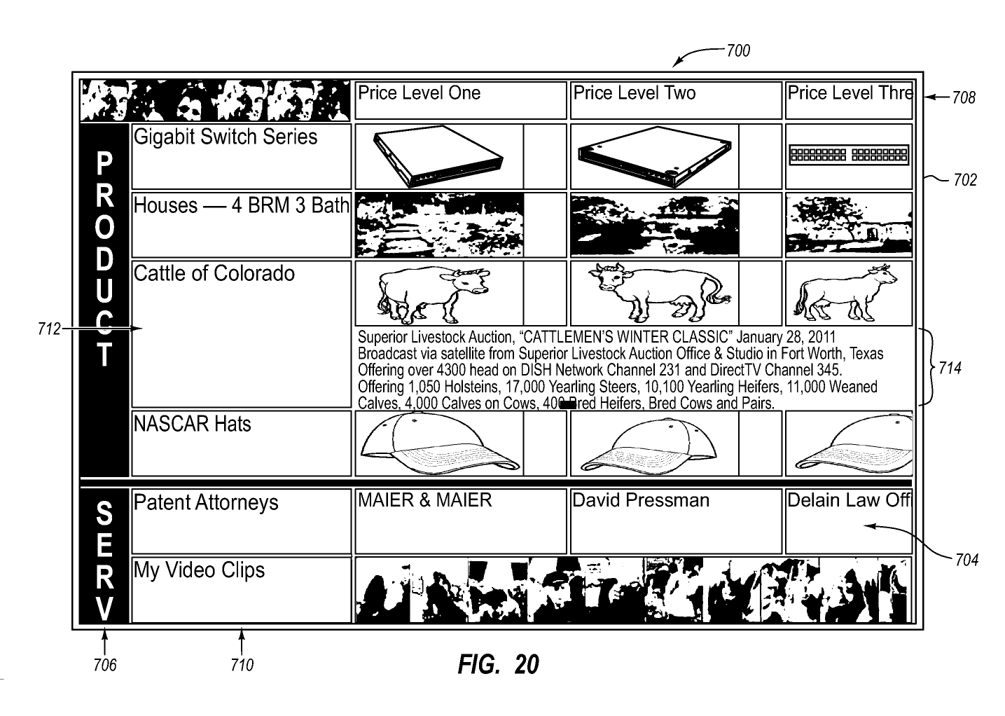

In yet another example, the social-networking system may recommend users to each other based on the similarity of statuses of the cells of the grids of the users. For example, as a user learns from or works across the progression of structured content in a grid, at any time he can enter or update the “Status” on a particular dimension of a cell, which may reflect how applicable the dimension is to the user or the user's sense of accomplishment or mastery of the dimension. A status may also be represented in a variety of ways, such as progress on a skill, a purchasing status of cattle, or a ranking of lawyers (see FIGS. 19 and 20). A status can be self-assessed, assessed by others, or automatically assessed by the user interface. For example, where two users have entered identical or similar statuses in one or more cells of their respective user interfaces 600, the system may automatically recommend the users to one another and/or give a percentage of cells with similar statuses so that the users can decide whether they are similar enough to warrant contacting one another using the social-networking window 642. Additional details regarding cell statuses will be disclosed below.

The social-networking window 642 thus enables users to link their comments about any dimension of the structured content of the grid 604 and use of the default structured content (or their personal changes thereto) of the grid 604 to link to and interact with members of a social network. In another embodiment, a user can create his own network (e.g., business, social) based on his use of the structured content in the grid 604 by using any appropriate social-networking method.

It should be noted that while one contemplated embodiment involves the notion of users linking from the grid 604 into an existing network-based social-networking system (such as Facebook®), other embodiments might be directed to the notion that the grids of structured content can themselves serve as the basis for establishing a new genre of social networks where the structured and viewport-accessible content serves as a starting point or default anchor to which users can, for example, attach or make comments, expand content, add photos, video, or other such social or business networking elements.

Further, while user-specific data may remain private and personal, if the user is using the user interface 600 as a member of a group (in a class, as an employee, as a church member, etc.), the system may allow for a group administrator to aggregate anonymous user status and “time in cell” data, as well as monitor the progress of multiple users, such as where a teacher creates an account that gives the teacher access to the user interfaces of each of his/her students and can thus monitor and assess the progress of each student. These features, based on granular content, make content easily hidden or visible, and thus usable. Most social scales are too “gross” in terms of applicable detail, thus losing users due to lack of personal association. From the aggregate report the administrator can determine if the group as a whole is making progress and how much progress and whether the content in the grid 604 is relevant, for example. This may permit a better self-directed and paced learning experience which provides for honest self-assessment as a private tool. This also enables multiple user interfaces to function together as part of an integrated system.

Further, the social-networking of the example user interfaces disclosed herein can enable real-time designation, determination, and tracking of status across and/or within cells to denote states or criteria, for example, skill mastery, progress, measurements, statistical distributions, purchase status, item or product selection, ranking, condition, further review needed, and/or GPS location. For example, as part of the preferences defined by the content author or the user or the system administrator, definable sets of status points or criteria (such as progress indicators, status representations, acceptance levels, performance levels, pricing levels or action thereon, accomplishment criteria, or other textual or symbolic representations or criteria) can be assigned to or associated with various types or levels of progress within or across the structured content displayed within grid cells for tracking of status/progress. Additionally, color or other representative nomenclature can be assigned or defined for each criterion or status point to provide a visual display of each cell's status.

### 5. Third Example User Interface for Navigating Structured Content

With reference now to FIGS. 19 and 20, a third example user interface 700 is disclosed. As with the user interfaces 500 and 600, the user interface 700 is configured to navigate structured content. As disclosed in FIG. 19, the structured content of the user interface 700 includes various types of structured content data types including images, video clips, and text, or any combination thereof. In one embodiment of the user interface 700, the user can tap/click, drag or scroll across multiple image, audio, or video content displayed with the cells of the grid 704 to select and re-sequence, for example, video clips, audio patterns or a mashing thereof, or for creating pictures sentences, used by those with autism or communication disabilities. It is understood, however, that the user interface 700 could instead be used to navigate other structured content.

As disclosed in FIG. 19, the user interface 700 generally includes a viewport 702, a grid 704 of multi-dimensional cells and a domain column 706. The cells of the grid 704 are generally organized into horizontal rows and vertical columns. The grid 704 also includes a header row 708 and a header column 710. The header row 708 is made up of header row cells each positioned in a separate column of the grid 704. The header column 710 is made up of header column cells each positioned in a separate row of the grid 704.

Each of the header column and header row cells may be multi-dimensional cells configured to store structured content. For example, a header cell can contain any manner of information such as an index, coordinate, or metric, such as types, categories, dates, time, money, or ranking. For example, a grid based on time metrics in the header cells might represent a timeline. Further, each header row cell and header column cell may be further configured to display, upon selection, one or more additional dimensions of structured content applicable to all cells positioned in the same column or same row, respectively, as the selected header cell.

For example, as disclosed in FIG. 20, the header column cell in the row 712 has been selected by the user. Upon selection, the selected header column cell has displayed a second dimension 714 of structured content applicable to all cells positioned in the row 712. This display of the second dimension 714 of structured content is accomplished by the each header column cell of the row 714 being further configured to expand vertically. The vertical expansion of the selected header column cell of row 714 also causes other cells positioned in row 714 to expand vertically downward and other cells positioned in rows beneath row 714 to shift vertically downward. It is understood, however, that this second dimension 714 of structured content that is applicable to all cells positioned in the row 714 may instead be displayed in a separate interface object, such as a modal window for example. It is further understood that any of the cells in the header row 708 may be similarly configured to expand horizontally along with the other cells in the same column, in order to display, upon selection, one or more additional dimensions of structured content applicable to all cells positioned in the same column.

### 6. Fourth Example User Interface for Navigating Structured Content

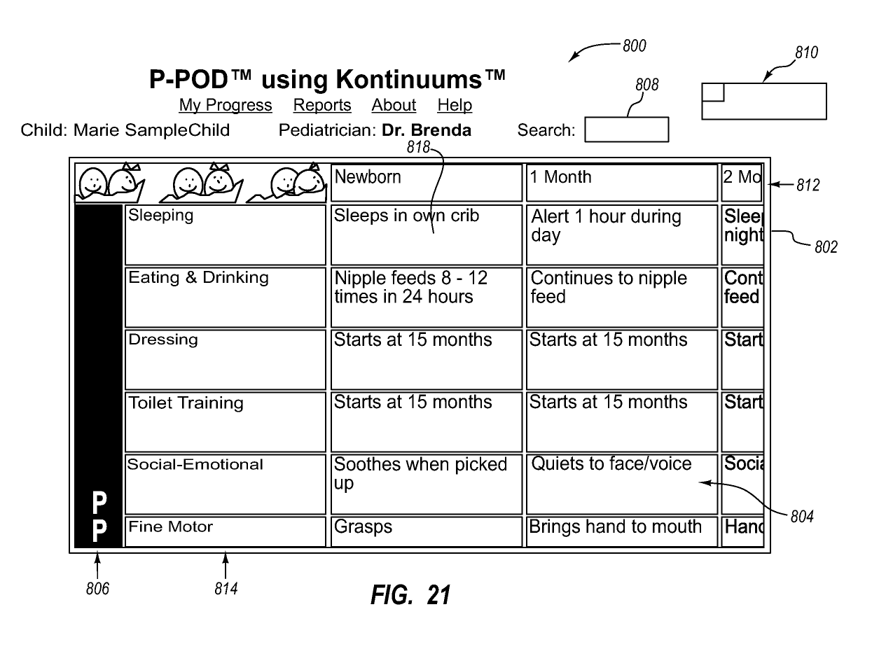

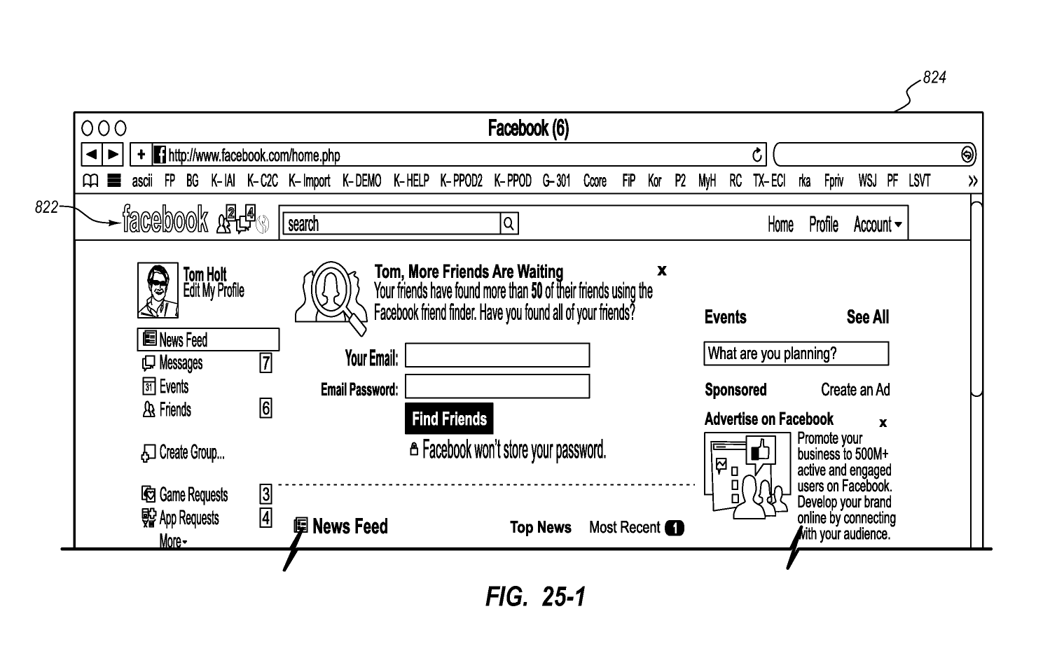

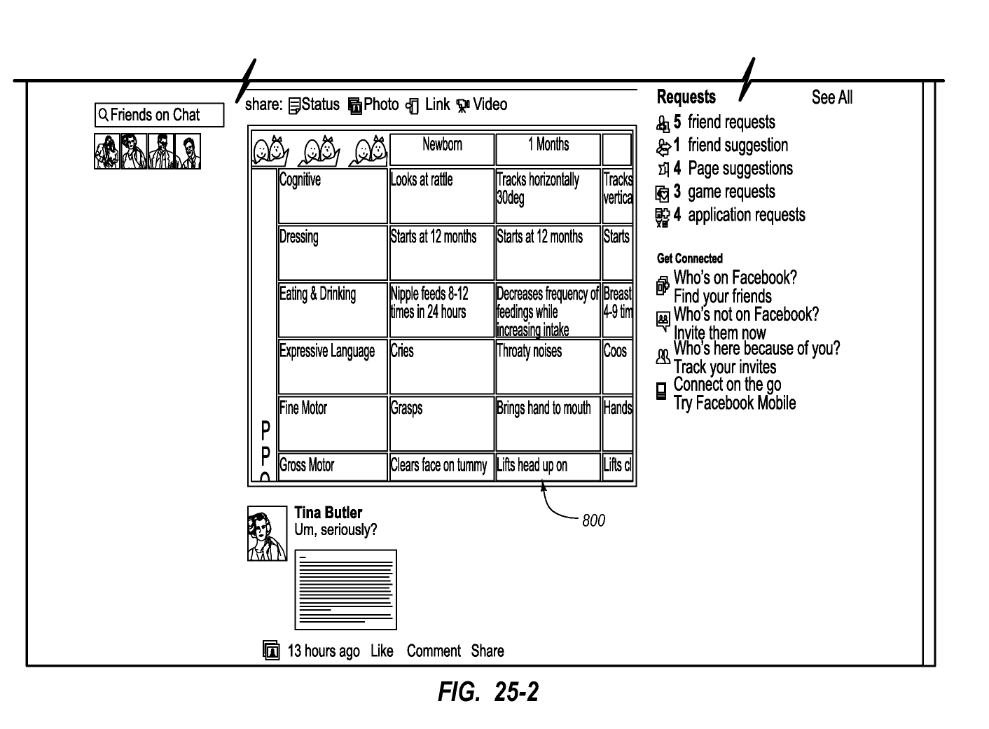

With reference now to FIGS. 21 to 25-2, a fourth example user interface 800 is disclosed. As with the user interfaces 500, 600, and 700, the user interface 800 is configured to navigate structured content. As disclosed in FIG. 21, the structured content of the user interface 800 is the P-POD™, with each cell containing one or more steps relating to child development. It is understood, however, that the user interface 800 could instead be used to navigate other structured content.

As disclosed in FIG. 21, the user interface 800 generally includes the viewport 802, a grid 804 of multi-dimensional cells and a domain column 806 of cells that span multiple rows, the search box 808, the viewtracker 810. The cells of the grid 804 are generally organized into horizontal rows and vertical columns. The grid 804 also includes a header row 812 and a header column 814. The header row 812 is made up of header row cells each positioned in a separate column of the grid 804. The header column 814 is made up of header column cells each positioned in a separate row of the grid 804.

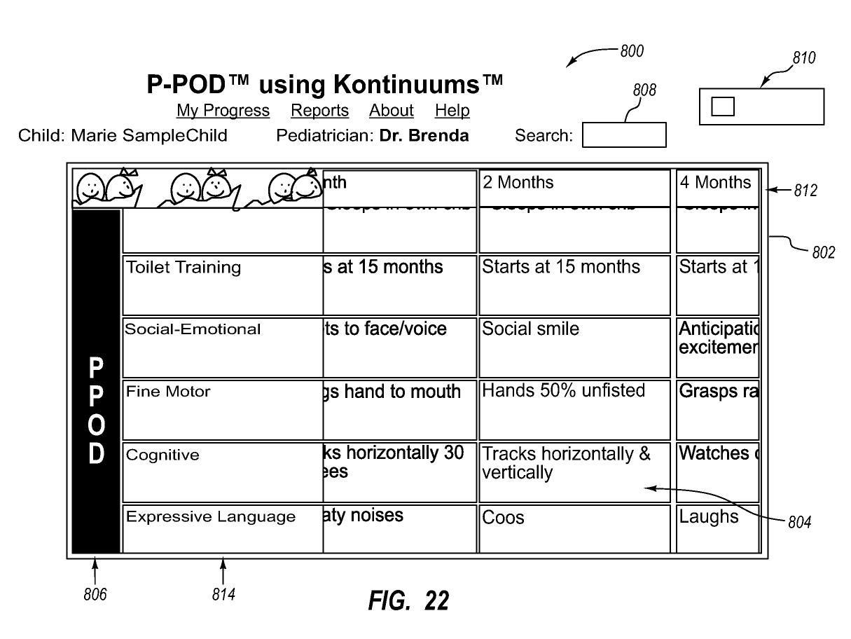

The multi-dimensional cells of the grid 804 are configured to scroll simultaneously within the viewport 802 both horizontally and vertically, also known as scrolling diagonally. During diagonal scrolling, the cells in the header row 812 and the cells in the header column 814 of the grid 804 are configured to scroll in a synchronous manner so as to remain visible in the viewport 802 and remain aligned with the rows and columns of multi-dimensional cells, as disclosed in the scrolling between FIGS. 21 and 22. Further, FIG. 22 discloses that the portion of the grid 804 displayed within the viewport 802 is configured to float within the viewport 802 during diagonal scrolling without automatically snapping to align one or more cell boundaries with one or more edges of the viewport 802 after the diagonal scrolling.

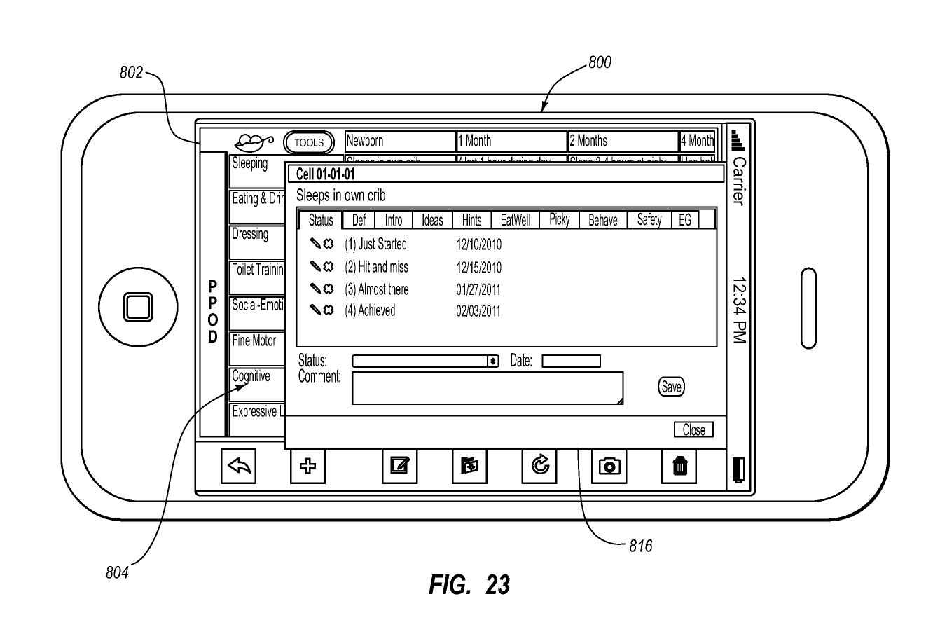

FIG. 23 discloses the user interface 800 employed in a handheld environment. It is understood, however, that the handheld environment of FIG. 23 is but one example environment in which the user interface 800 can be employed, and the user interface 800 may instead or also be employed in any of the other environments disclosed herein. FIG. 23 also discloses a pop-up modal window 816. The window 816 includes additional dimensions of structured content that are displayed in response to the selection of the cell 818 (see FIG. 21) by the user. The window 816 include a first “Status” tab which is configured to allow the user to select a status that corresponds to one of the dimensions of structured content of the cell 818. It is understood, however, that the status of the cell 818 could instead be automatically updated by the user interface 800.

As disclosed in FIG. 23, the status may be selected from a list of multiple statuses applicable to the dimension of structured content of the cell 818. For example, some of the statuses listed in FIG. 23 are “(1) Just Started,” “(2) Hit and miss,” “(3) Almost there,” and “(4) Achieved.” As disclosed in FIG. 23, the list of statuses may be ordered to indicate a progression from a less advanced assessment, such as level (1), to a more advanced assessment, such as level (4), of mastery of the dimension of structured content of the cell 818. Assessment in this context can be the end result of testing or observation. The window 816 also allows the user to enter a status date and add additional comments regarding the status. Using the Status tab of the window 816, a user can therefore track the status corresponding to the structured content of the cell 818 (see FIG. 21).

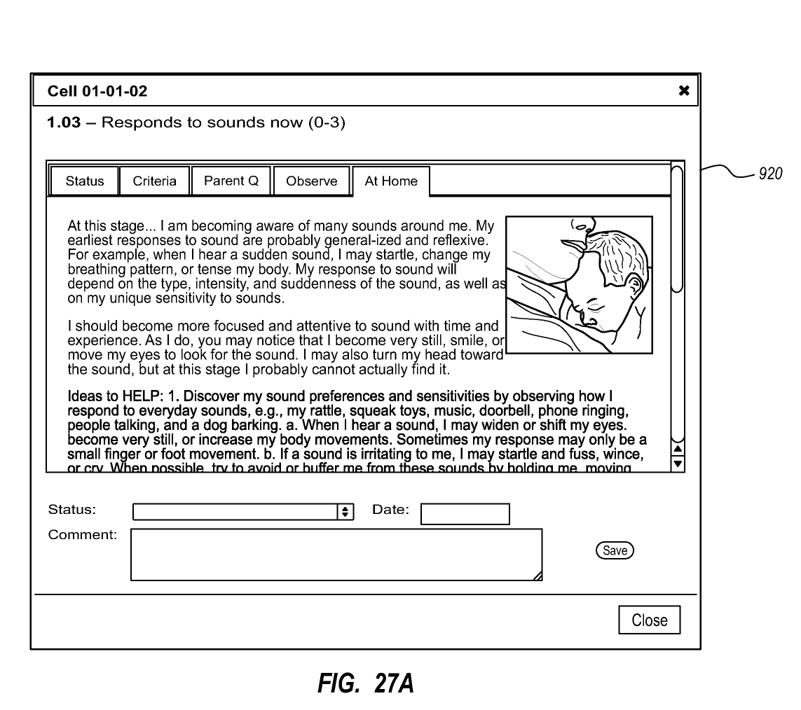

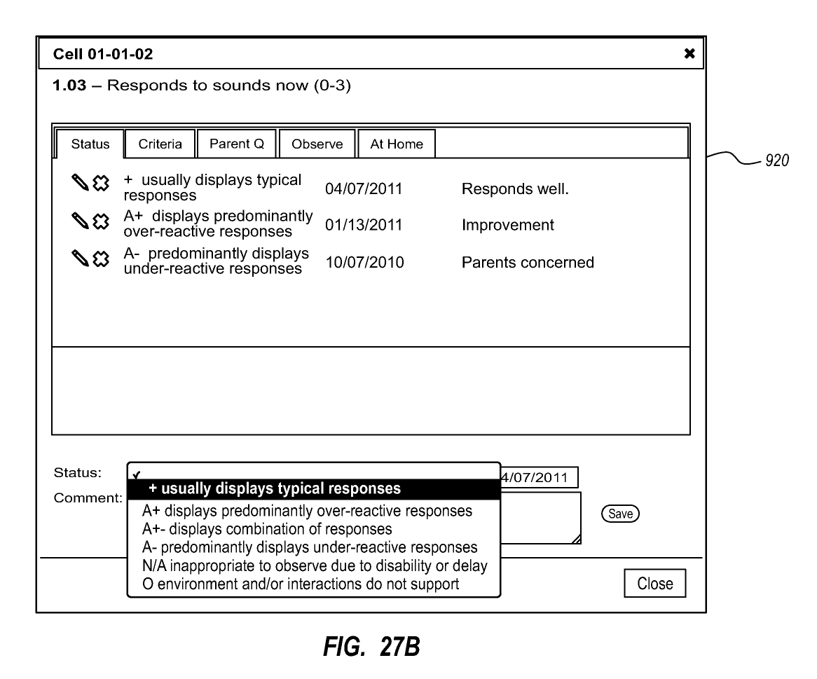

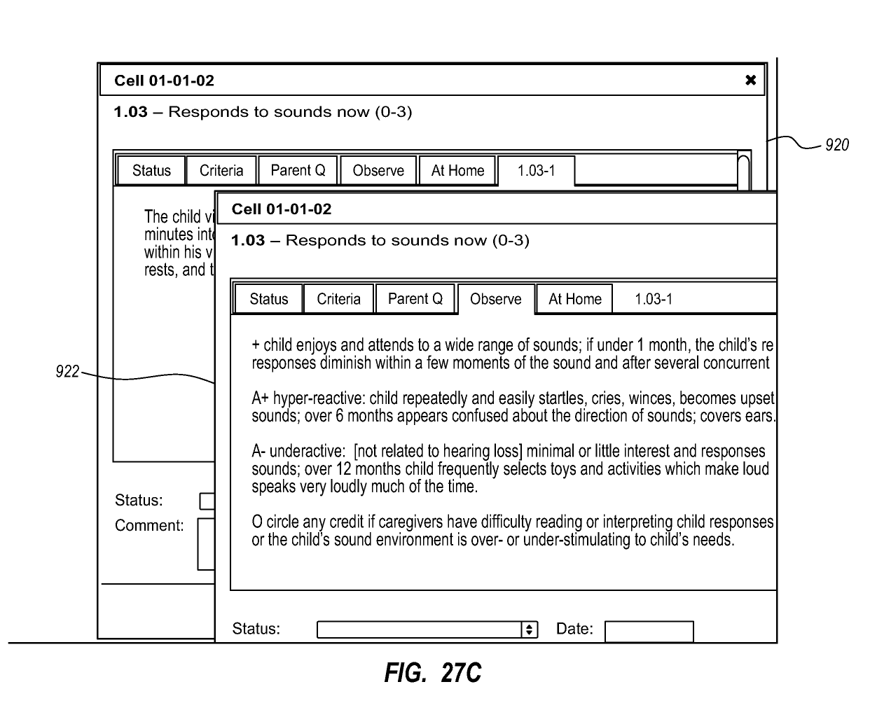

With reference now to FIG. 27B, a window 920 is disclosed in which additional statuses can be selected for a particular cell of a grid. For example, as disclosed in FIG. 27B, the status for a cell may be selected from a list of multiple statuses applicable to the dimension of structured content of the cell. For example, some of the statuses listed in FIG. 27B are “+ usually displays typical response,” “A+ displays predominantly over-reactive responses,” “A+ displays combination of response,” “A− predominantly display under-reactive responses,” “N/A inappropriate to observe due to disability or delay,” “O environment and/or interaction do not support.” As disclosed in FIG. 27B, the list of statuses may be ordered to indicate a progression from a less advanced assessment, such as level “A+,” to a more advanced assessment, such as level “+,” of mastery of the dimension of structured content of the cell. Assessment in this context can be the end result of testing or observation. The window 920 also allows the user to enter a status date and add additional comments regarding the status. In addition to the example button icons (pencil: edit, X: delete) shown on FIG. 27B next to each entry on the Status tab, there can be other types of interface options or buttons. For example, there can be buttons that allow a user to save/associate data such as photos, audio recordings, and/or video with a cell and/or with a particular status of that cell. Thus, for example, with content dealing with child development, if a parent desires to show his/her child's response or development as of a particular date, buttons can be provided to allow the parent to save/associate audio, video, images for each Status and/or for each cell on the particular date. Using the Status tab of the window 920, a user can therefore track the status corresponding to the structured content of a cell.

With reference now to FIG. 24, a summative representation 820 of the grid 804 of the user interface 800 is disclosed as employed in a handheld environment. It is understood, however, that the handheld environment of FIG. 24 is but one example environment in which the summative representation 820 can be employed, and the summative representation 820 may instead or also be employed in any of the other environments disclosed herein. Even with the limited display size in the handheld environment of FIG. 24, the summative representation 820 of the grid 804 enables a user to quickly and at a glance determine the statuses of the cells of at least a portion of the grid 804 (see FIG. 21). As disclosed in FIG. 24, using color, representative or symbolic nomenclature, or some other visual indicator, the status of each cell in the summative representation 820 is simultaneously displayed. Thus, the status of each cell, as entered in the window 816 of FIG. 23 for example, can be simultaneously displayed in the summative representation 820 to give the user an overall impression of the progress through the steps in the cells of the grid 804 (see FIG. 21).

The summative representation 820 can be used to provide a teacher or instructor or supervisor an overview of overall performance or progress across users or learners, or a buyer rating of the products they are considering. In another embodiment, such a summative representation can be used to show progress or learning across groups of learners, for example, all 3rd grade classes at a school, or all students in schools in a county, or performance of personnel in a corporate department. In another embodiment, such a summative representation can be used as a form of “historical standard” or goal, representing a target based on performance or progress history of other users or groups of users.

It is further noted that the user interface 800 may further include a “data dump” feature which enables a user to, for example, retrieve and/or capture from the system server/database all data for a child such as a their progress and photos and parents' comments. This “data dump” ability of the user interface 800, or other user interfaces disclosed herein, can be used in a variety of scenarios including, but not limited to, a Baby Book, a report card, test portfolios, or an analysis of job performance. This “data dump” feature is different from the summative representation 820 in that it is not a visual display of merely “status/progress” but rather a formatted retrieval of all account or user or learner data into a meaningful historical-type report.

FIGS. 25-1 and 25-2 disclose the user interface 800 employed in the context of a network-based social network 822. As disclosed in FIGS. 25-1 and 25-2, the user interface 800 can be part of a social-networking system, as discussed above in connection with FIGS. 18-1 and 18-2, where each user interface 800 is further integrated into an existing network-based social network 822, which in this example is the internet-based social network Facebook®. The network-based social network 822 can include a plurality of webpages or other screens 824 (only one of which is shown in FIGS. 25-1 and 25-2), or other networked interfaces, each associated with one of the users of the social-networking system. Further, the user interface 800 associated with each user is configured to be embedded in the webpage or other screen 824, or other networked interface, associated with the user to enable to user to navigate the structured content of the social-networking system in the context of the webpage or other screen 824 of the network-based social network 822, or other networked interface. The example user interface 800 can thus be employed to create and use structured content to spawn social interest and interaction, enabling users to edit or attach content, share comments and interests, and thus create a network (e.g. with social, business, or theme orientation) based on the structure of specific steps or topics or domains of knowledge in the user interface 800.

In other example embodiments, the status or progress that a learner/user is making within or across the cells of a grid can be shared with fellow workers (for example, educators or therapists). In another example embodiment, family members, work colleagues, trainers, and/or supervisors can also monitor the learner's progress or performance. The social networking provided by the social-networking system disclosed herein can be based on two or more users sharing both the aspects and relevance of the specific, structured content provided by the system, and by the sharing of other types of information such as dates, comments, images, videos, or any other information based on the user's status relative to a cell's content, be that status alone denoting learning progress, or purchase status or history, or voting or ranking services, or any other input by those within the social networking system regarding the content of a cell, sets of cells, or an entire grid.

### 7. Fifth Example User Interface for Navigating Structured Content

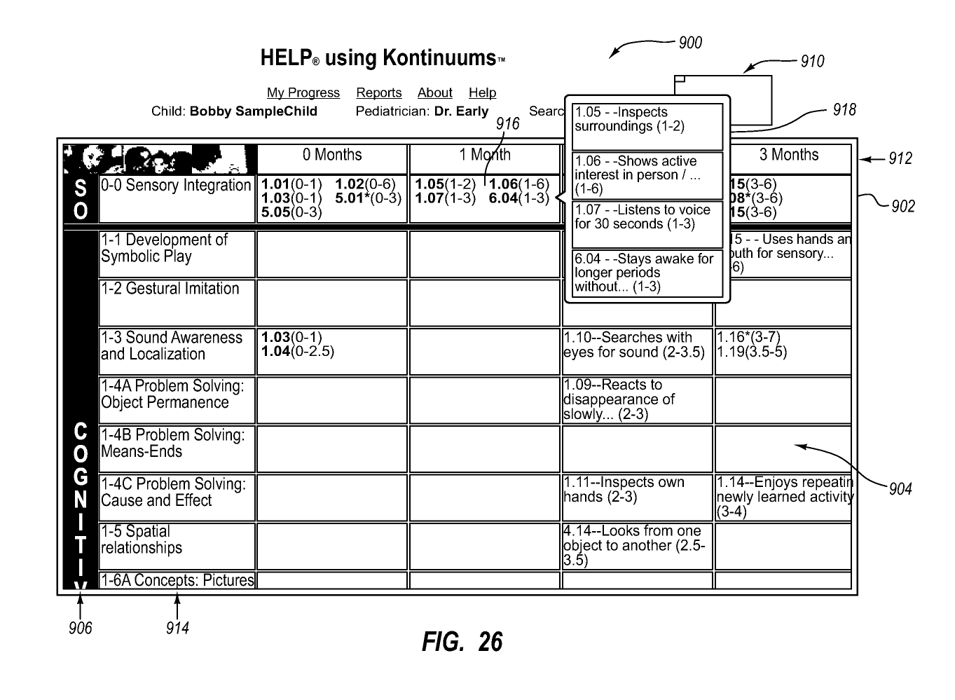

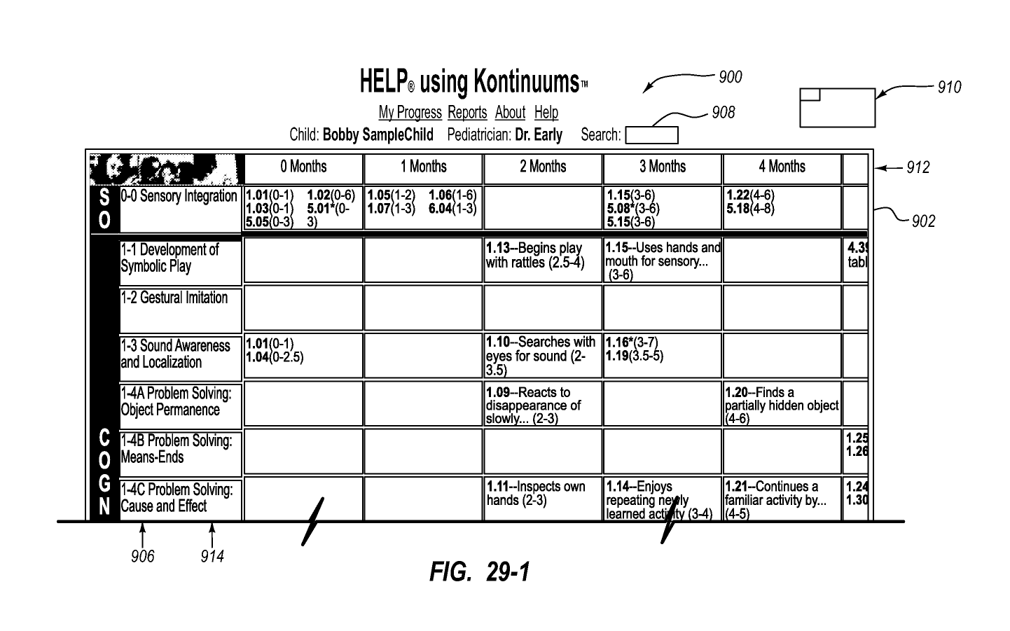

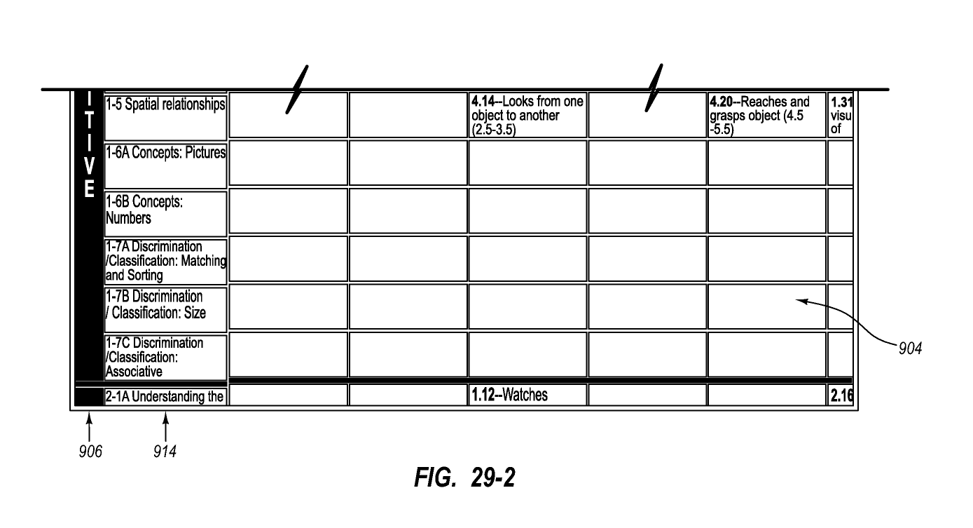

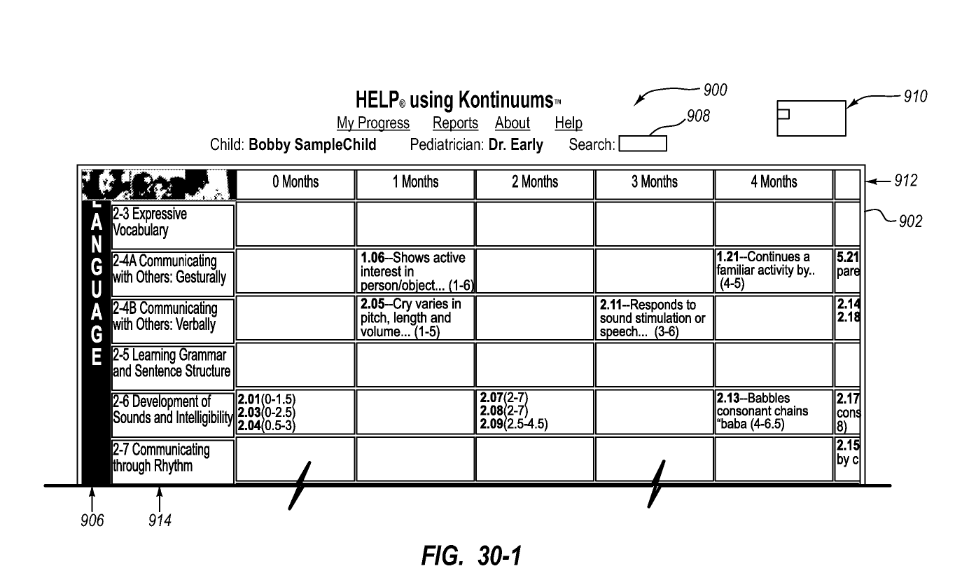

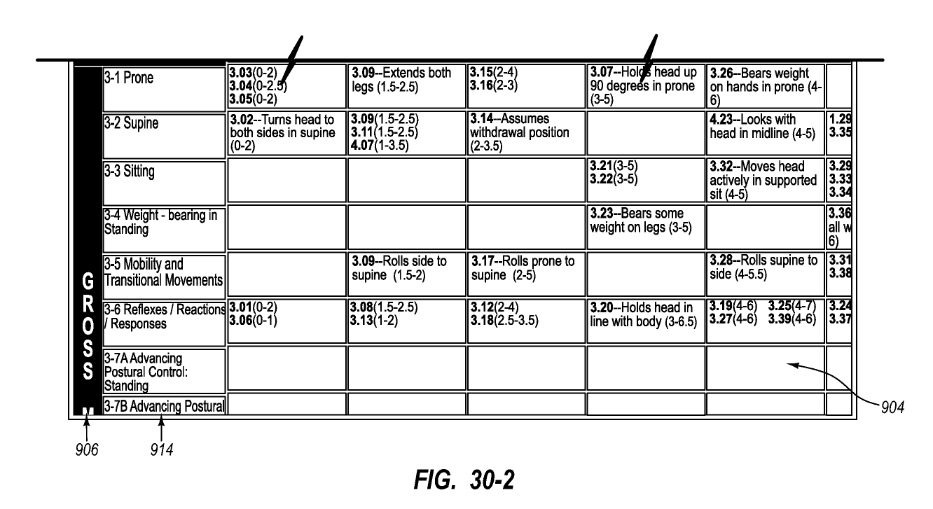

With reference now to FIGS. 26 to 30-2, a fifth example user interface 900 is disclosed. As with the user interfaces 500, 600, 700, and 800, the user interface 900 is configured to navigate structured content. As disclosed in FIG. 26, the structured content of the user interface 900 is the Hawaii Early Learning Profile®, with each cell containing one or more steps relating to child development. It is understood, however, that the user interface 900 could instead be used to navigate other structured content.

As disclosed in FIGS. 26 and 29-1 to 29-2, the user interface 900 generally includes a viewport 902, a grid 904 of multi-dimensional cells and a domain column 906 of cells that span multiple rows, a search box 908, and a viewtracker 910. The cells of the grid 904 are generally organized into horizontal rows and vertical columns. The grid 904 also includes a header row 912 and a header column 914.

Each of the multi-dimensional cells is configured to display only a first dimension of structured content before selection and display one or more additional dimensions of structured content upon selection. The grid 904 of FIGS. 26 and 29-1 to 29-2 also features abbreviations or representations of multiple cells within single cells. For example, when more than one value occupies or applies to a cell (at the intersection of a grid 904 row and column), selecting that one cell will open or cause to display a new screen object that presents the multiple cells in a fashion similar to the display of the cells in the viewport 902, thus allowing multiple instances of content within or referenced by one cell.

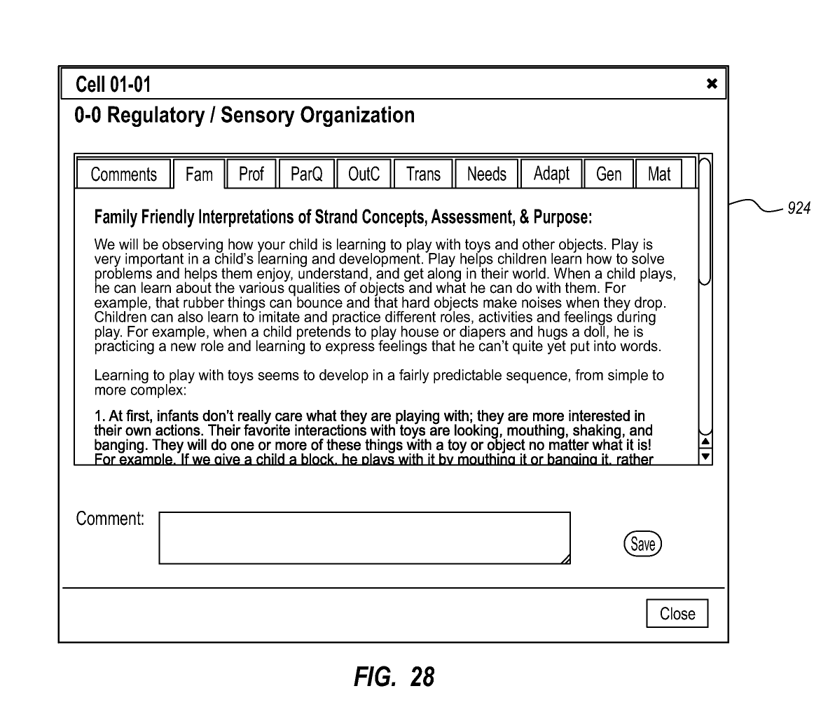

For example, as disclosed in FIG. 26, selecting the cell 916 causes additional cells of the grid 904 to be displayed in an interface object such as a pop-up window 918. Alternatively, selecting one of the cells of the grid 904 can cause additional dimensions of structured content to be displayed in an interface object 920, as disclosed in FIGS. 27A-27C. The interface object 920 disclosed in FIGS. 27A-27C includes several tabs that allow the user to view additional dimensions of structured content, as disclosed in FIG. 27A, select and update a current status corresponding to the structured content, as disclosed in FIG. 27B, or launch additional interface objects, such as the additional interface object 922 of FIG. 27C. As disclosed in FIG. 27C, the tabs of the interface object 920 enable the user to drill down to additional dimensions of structured content. The interface object 922 represents a deeper dimension, represented by the label 1.03-1, of the content in the cell 916, represented by the label 1.03. It is understood that the tabs of the interface object 920 are example interface objects only, and any number of other interface objects can be employed to allow the user to drill down to additional dimensions of structured content. FIG. 28 discloses yet another modal window 924 displayed in response to the selection of another cell in the grid 904. It is understood that expansion of a cell or multiple cells may also be configured to load an entirely new, but cell-related, grid into the viewport 902, such as the summative representation 820 disclosed in FIG. 24.

The user interface 900 is also configured to hide empty cells in certain situations. For example, FIGS. 29-1 and 29-2 disclose a first portion of the grid 904 of the example user interface 900, and FIGS. 30-1 and 30-2 disclose another portion of the grid 904 of the example user interface 900. Both portions of the grid 904 disclosed in FIGS. 29-1 and 29-2 and 30-1 and 30-2 include empty cells. Each cell in the header row 912 is configured, upon selection, to hide all rows in the grid 904 corresponding to empty cells positioned in the same column as the selected header row cell. Similarly, each cell in the header column 914 is configured, upon selection, to hide all columns in the grid 904 corresponding to empty cells positioned in the same row as the selected header column cell.

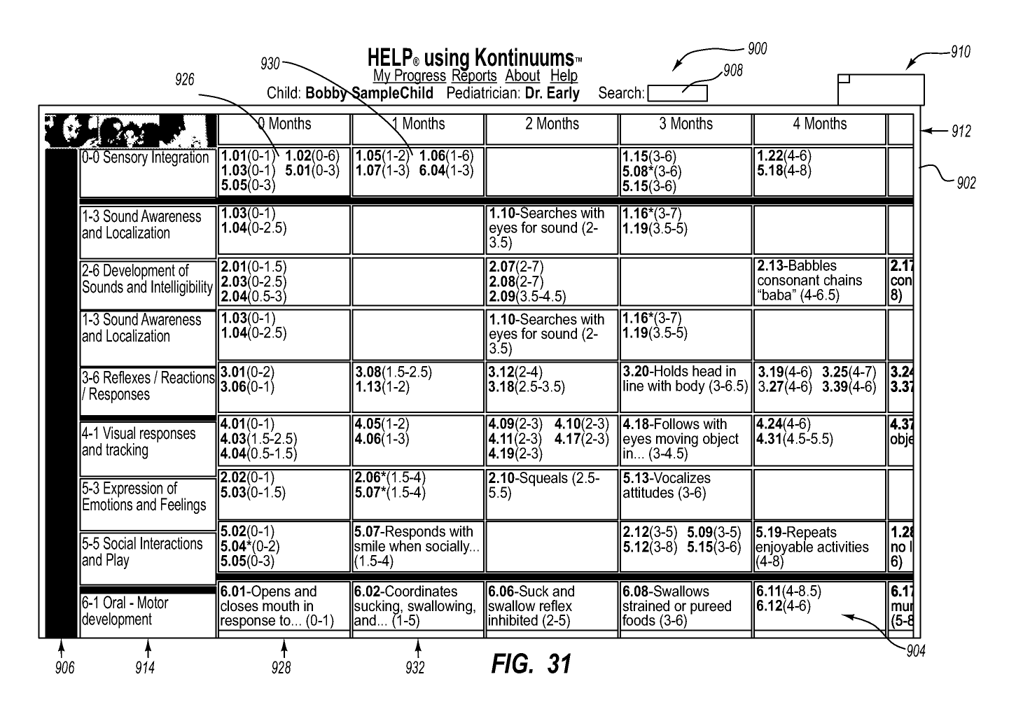

For example, as disclosed in FIG. 31, selection of the header row cell 926 causes all rows in the grid 904 corresponding to empty cells positioned in the column 928 to be hidden, thus enabling the user to only view rows in the column 928 that have structured content. The other header row cells and header column cells in the grid 904 are similarly configured. For example, if the user next selects the header row cell 930, the rows corresponding to empty cells positioned in the column 932 will be hidden (not shown), thus enabling the user to only view rows in the column 932 that have structured content.

### 8. Example Administrative Displays

FIGS. 32-35 are example administrative displays 1000-1006 of the example user interface 900. The example administrative displays 1000-1006 may be employed, for example, to enable a system administrator or a user to specify preferences for the user interface 900 such as cell font size, cell style, cell color, cell size, cell background color, border size, cell border size, blank cell display, viewport size, viewport border size, or some combination thereof or preferences for the system, such as for managing different “client” users. Other administrative preferences may include how cells move and stop and align within the grid 904 and viewport 902 (see FIG. 26) in response to the user's click-drag, touch-drag, or other navigation action.

For example, a preference may be set to specify whether the cells within a viewport 902 “snap” to stop their movement at the exact boundaries of the viewport 902 and/or the header column and header row such that complete cells are shown throughout the viewport 902 in a manner that matches the edges of the cells exactly to the edges and boundaries of the viewport 902 of header column and header row, with the viewport 902 being sized mathematically such that an exact multiple of cells fill the horizontal and vertical space within the viewport 902. Alternatively, the cells within the viewport 902 may be configured to “float” and stop their movement without regard to the exact boundaries of the viewport 902 and/or the header column or header row such that incomplete or partial cells are shown at the edges/boundaries of the viewport 902.

It should also be noted that, for example, the rate of the drag can accelerate or otherwise control both the speed and “distance” within the grid 904 that the cells move. For example, with a touch device, a fast finger drag can cause the cells within the viewport 902 to rapidly move in the direction of the drag, for example, the lower right corner.

Further, although not disclosed in FIGS. 32-35, any one of the administrative displays 1000-1006 may include a “what you see is what you get” (WYSIWYG) simulator that enables a system administrator or a user to see the effects of changes to preferences prior to actual implementation of the changes in the user interface 900. This viewport simulator can be employed as an alternative, or in conjunction with, a control or preferences method, enabling the user to upload or enters samples of structured content into the system. The viewport simulator is then displayed in a manner allowing the user to interact directly with the viewport simulator such as, for example, directly dragging cell borders or boundaries or clicking or touching a cell to bring up color palettes, font faces or size, all in the manner of a WYSIWYG direct editor of the viewport 902. In this way, the user is able to immediately see the impact on the viewport 902 when it is sized for different devices (e.g., computer screens, slate devices, smart phones) or when different font sizes do or do not allow cell text or content to fit or when coloration schemes do or do not look good, for example.

It is further noted that the administrative displays 1000-1006 may be used in connection with, augmented by, or replaced by a series of editable files such as CSS or variables embedded within HMTL or JavaScript for specifying settings such as viewport parameters, cell content, and cell properties including properties such as font size, style, color; cell size, background color, border size and color; viewport size, border size; and other parameters associated with the display, such as how to display blank cells.

### 9. Sixth Example User Interface for Navigating Structured Content

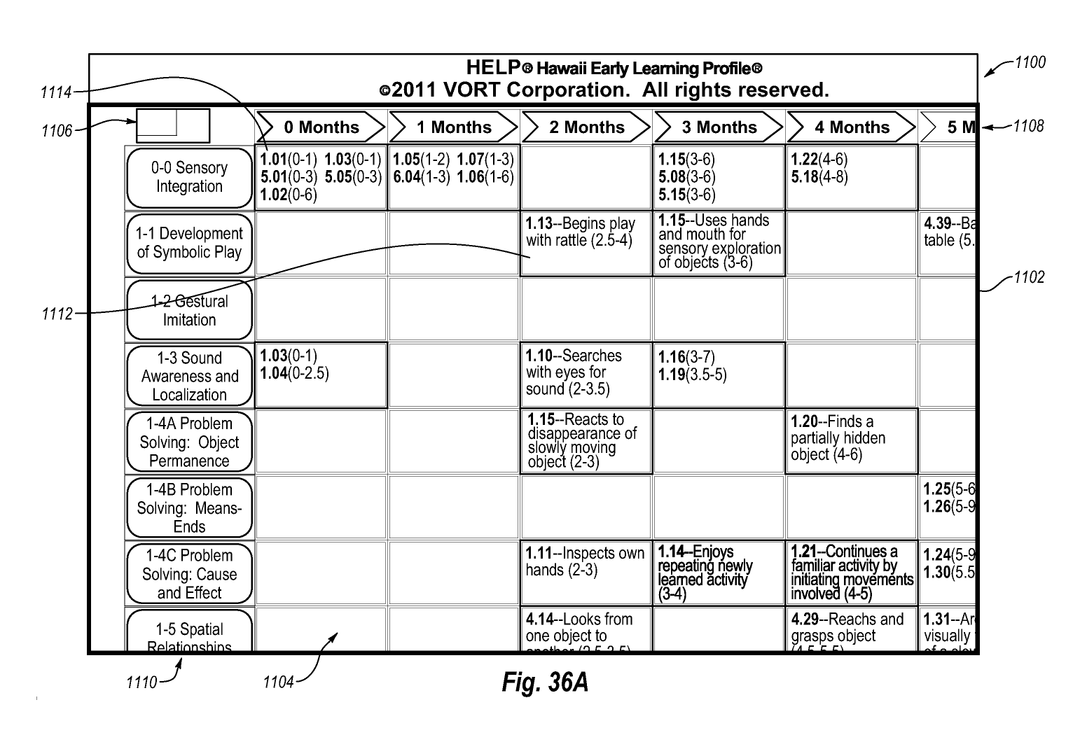

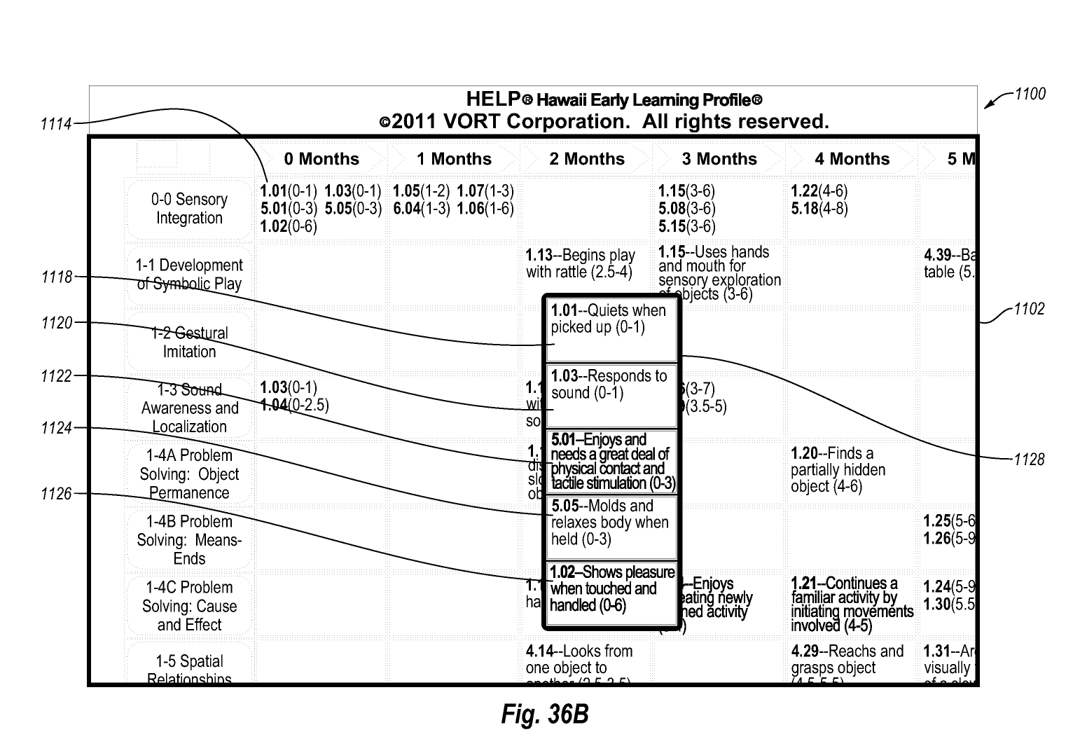

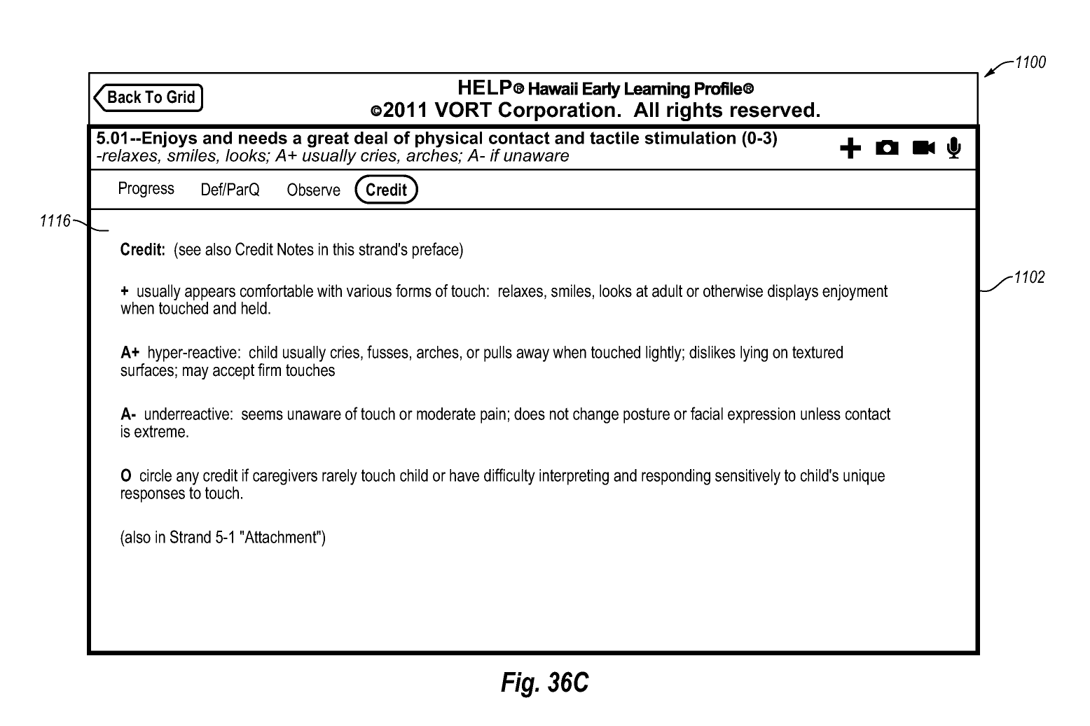

With reference now to FIGS. 36A-36C, a sixth example user interface 1100 is disclosed. As with the user interfaces 500, 600, 700, 800, and 900, the user interface 1100 is configured to navigate structured content. As disclosed in FIGS. 36A-36C, the structured content of the user interface 1100 is the Hawaii Early Learning Profile®, with each cell containing one or more steps relating to child development. It is understood, however, that the user interface 1100 could instead be used to navigate other structured content. It is also noted that the user interface 1100 is disclosed in FIGS. 36A-36C as it may be employed in a handheld environment. It is understood, however, that the handheld environment of FIGS. 36A-36C is but one example environment in which the user interface 1100 can be employed, and the user interface 1100 may instead or also be employed in any of the other environments disclosed herein, such as the environment disclosed in FIGS. 36A-36C, and/or with additional controls, such as a search box, as disclosed elsewhere herein. Even with the limited display size in the handheld environment of FIGS. 36A-36C, the user interface 1100 enables a user to navigate structured content with ease.

As disclosed in FIGS. 36A and 36B, the user interface 1100 generally includes a viewport 1102, a grid 1104 of multi-dimensional cells, and a viewtracker 1106. The cells of the grid 1104 are generally organized into horizontal rows and vertical columns. The grid 1104 also includes a header row 1108 and a header column 1110.

Each of the multi-dimensional cells of the grid 1104 is configured to display only a first dimension of structured content before selection and display one or more additional dimensions of structured content upon selection. Each of the cells in the grid 1104 of FIGS. 36A and 36B can also represent a single cell of structured content or multiple cells of structured content. For example, cell 1112 represents a single cell of structured content (step 1.13) while cell 1114 represents five different cells of structured content (steps 1.01, 1.03, 5.01, 5.05, and 1.02). Cells such as cell 1114 are known as cluster cells. While selection of a single cell of the grid 1104 can cause additional dimensions of structured content to be displayed in an interface object, such as the interface object 1116 disclosed in the viewport 1102 in FIG. 26C, selection of a cluster cell will open or cause to display a new screen object that presents each of the individual cells represented in the cluster cell.

For example, as disclosed in FIG. 36B, selecting the cluster cell 1114 causes individual cells 1118-1126 of the grid 1102 to be displayed in an interface object, such as a pop-up window 1128, while the focus on the pop-up window 1128 may be emphasized while the remainder of user interface 1100 or just the viewport 1102 is deemphasized by being greyed out for example. Then, selection of any of the single cells 1118-1126 displayed in the pop-up window 1128 can cause additional dimensions of structured content to be displayed in an interface object. For example, selection of the single cell 1122 in the pop-up window 1128 in FIG. 36B can replace the content of the viewport 1102 with the interface object 1116 as disclosed in FIG. 36C.

Thus, the user interface 1100 is configured such that a clusters cell can represent and give a user access to multiple cells of structured content in a single unique position in a grid. This can be useful, for example, where multiple cells of structured content pertain to a single unique position in a grid. In the above example, the unique position of the cluster cell 1114, which position represents the intersection of “0 Months” of age and the category of “0-0 Sensory Integration,” pertains to various steps relating to child development that each belong in this single unique position in the grid.

It is understood that the pop-up window 1128 of FIG. 36B and the interface object 1116 of FIG. 36C and but two example options for the display of the single cells 1118-1126 and the display of additional structured content for the step 5.01, respectively, and other screen or interface objects can alternatively be employed, including any of the other screen or interface objects disclosed herein. It is also understood that instead of displaying the pop-up window 1128 of FIG. 36B when the cluster cell 1114 is selected, the individual step labels can be selected individually. For example, the label 5.01 can be selected individually in the cluster cell 1114 of FIG. 36A resulting in either the display of only the cell 1122 of FIG. 36B or the display of the interface object of 1116.

The cluster cells disclosed herein may be applied to a wide variety of structured content. For example, cluster cells may be employed in a grid having a column representing price ranges and rows representing products or items for sale. In a real estate context, the column headers could be $100,000, $200,000, and so on, with the row headers being local towns, and the cell content, often clusters, could be the homes in Town A at $100,000, etc. In this manner multiple homes in the $100,000 price range in Town A could be represented in a single cluster cell.

### 10. Seventh Example User Interface for Navigating Structured Content

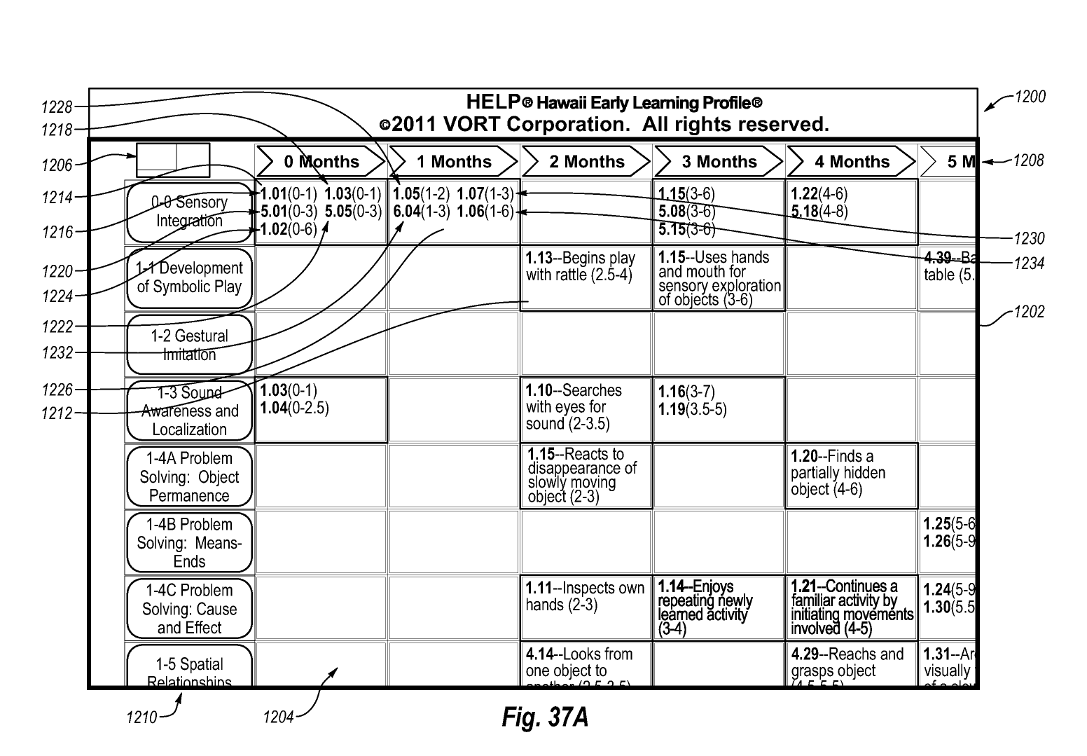

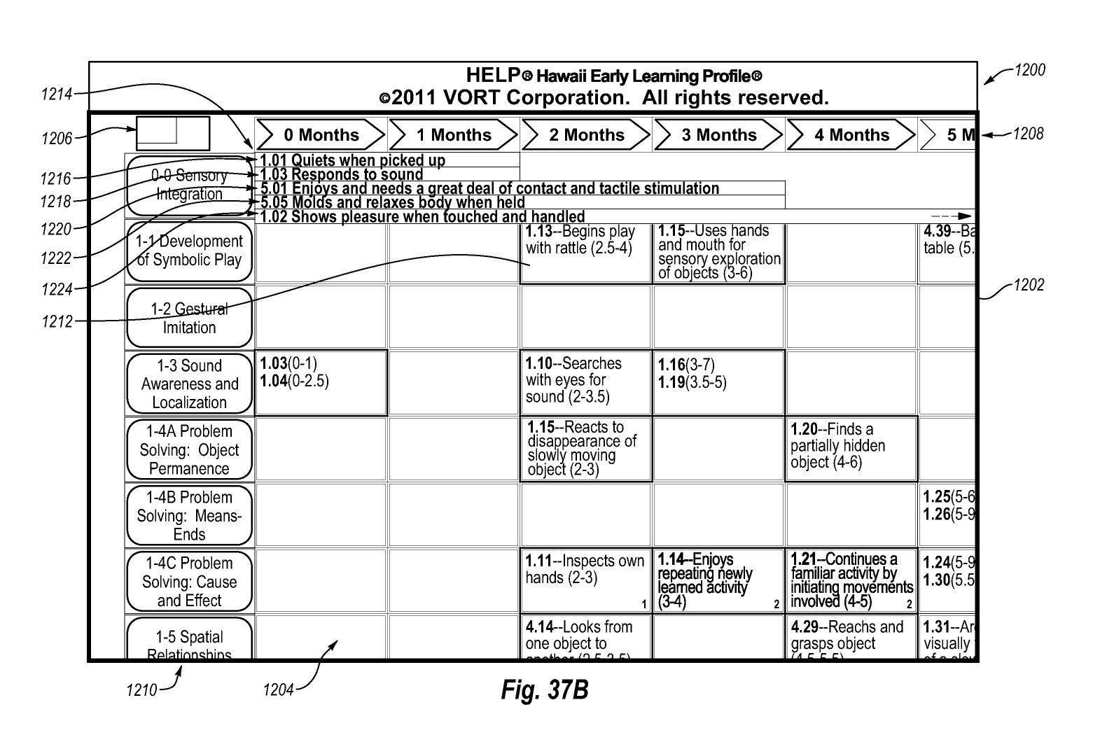

With reference now to FIGS. 37A and 37B, a seventh example user interface 1200 is disclosed. As with the user interfaces 500, 600, 700, 800, 900, and 1100, the user interface 1200 is configured to navigate structured content. Although the structured content of the user interface 1200 is the Hawaii Early Learning Profile®, the user interface 1200 could instead be used to navigate other structured content. Further, although the user interface 1200 is disclosed in FIGS. 37A and 37B in a handheld environment, the user interface 1200 may instead or also be employed in any of the other environments disclosed herein and/or with additional controls.

As disclosed in FIG. 37A, the user interface 1200 generally includes a viewport 1202, a grid 1204 of multi-dimensional cells, and a viewtracker 1206. The cells of the grid 1204 are generally organized into horizontal rows and vertical columns. The grid 1204 also includes a header row 1208 and a header column 1210.

Each of the multi-dimensional cells of the grid 1204 is configured to display only a first dimension of structured content before selection and display one or more additional dimensions of structured content upon selection. Each of the cells in the grid 1204 of FIG. 37A can also represent a single cell or a cluster cell. For example, cell 1212 represents a single cell of structured content corresponding to step 1.13, while cluster cell 1214 represents five different cells 1216-1224 of structured content corresponding to steps 1.01, 1.03, 5.01, 5.05, and 1.02, respectively. Each of the cells 1216-1224 are known as spanning cells. Spanning cell contain structured content that spans multiple header row columns, multiple header column rows, both multiple header row columns and multiple header column rows in a diagonal fashion, or some combination thereof. Similarly, cluster cell 1226 also represents four different cells 1228-1234 of structured content corresponding to steps 1.05, 1.07, 6.04, and 1.06, respectively. Each of the cells 1228-1234 are also spanning cells because they contain structured content that spans multiple header row columns.

Before selection of a unique row/column position in the grid 1204, a representation of each of the spanning cells that begin in the unique row/column position is displayed. Upon selection of a unique row/column position in the grid 1204, representations of the spanning cells that span the unique row/column position are displayed. For example, as disclosed in FIG. 37A, before selection of the unique row/column position of the cluster cell 1214, a representation of each of the spanning cells 1216-1224 is displayed in the unique row/column position of the cluster cell 1214 because each of the cells 1216-1224 begins in the unique row/column position of the cluster cell 1214. Upon selection of the unique row/column position of the cluster cell 1214, however, as disclosed in FIG. 37B a representation of the spanning cells 1216-1224 that span the unique row/column position of the cluster cell 1214 are displayed. In this example, the representation of the spanning cells 1216-1224 expands to visually overlay the header row columns corresponding to each spanning cell. For example, spanning cell 1220 spans four columns, from “0 Months” to “3 Months” to visually represent that that the child development step 5.01 of the cell 1220 pertains to multiple unique time periods (from “0 Months” to “3 Months”) in the grid 1204.

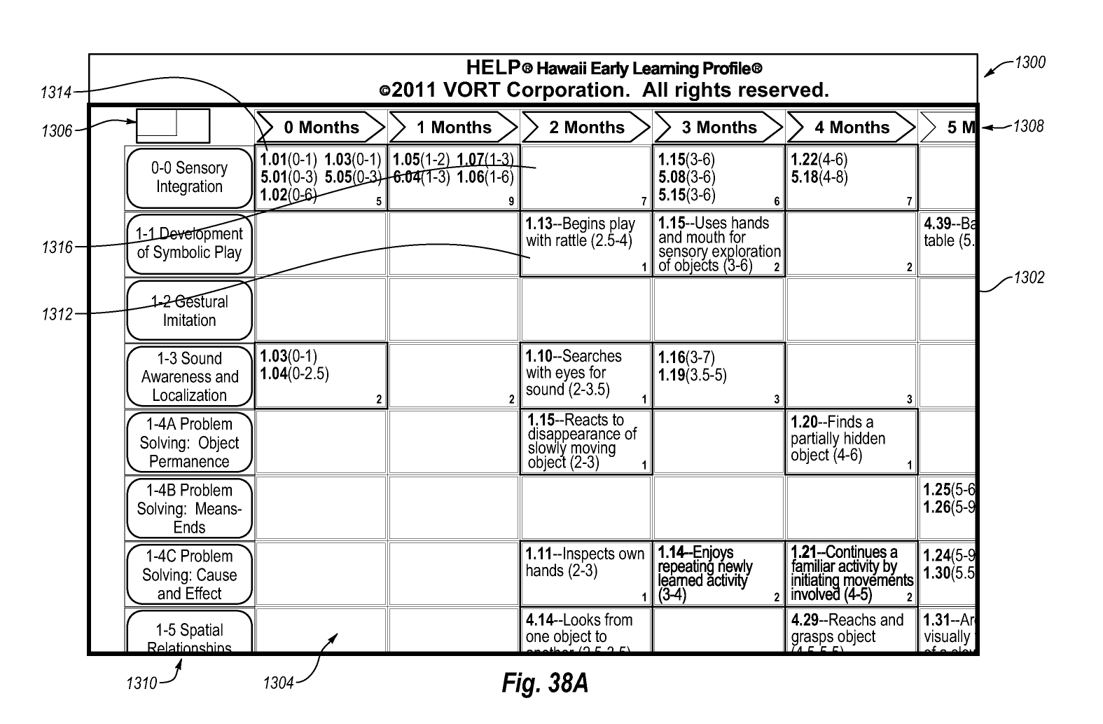

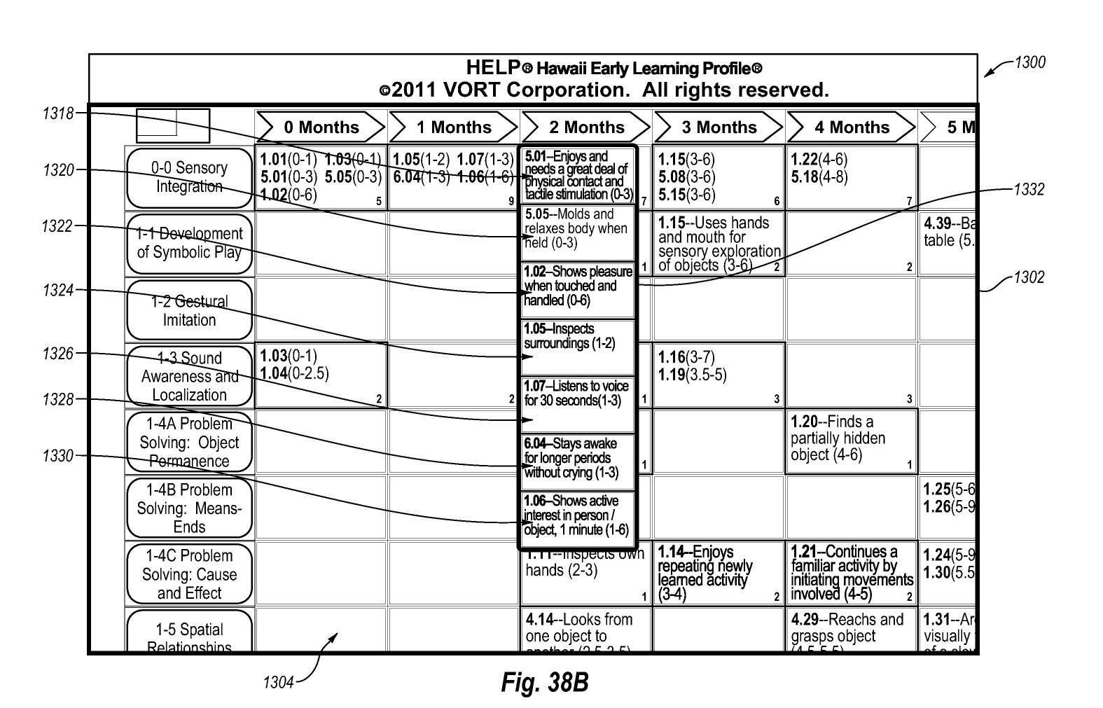

It is understood that although the spanning cells 1216-1224 each begins in the unique row/column position of the cluster cell 1214 and also spans the unique row/column position of the cluster cell 1214, a unique row/column position may be spanned by more cluster cells than begin in the unique row/column position. It is also understood that although FIG. 37B discloses the spanning cells 1216-1224 expanded to visually overlay the header row columns corresponding to each spanning cell, the spanning cells 1216-1224 could instead be expanded using accordion expansion to in order to accommodate the expansion of the spanning cells 1216-1224, as disclosed elsewhere herein. Further, the spanning cells 1216-1224 could instead be expanded in a separate interface object, such as the pop-up window 1332 of FIG. 38B, or any other interface object. Thus there are a variety of ways that spanning cells 1216-1224 could be displayed.

Selection of any of the spanning cells 1216-1224 disclosed in FIG. 37B can cause additional dimensions of structured content to be displayed in an interface object. For example, selection of the spanning cell 1220 in FIG. 37B can replace the content of the viewport 1202 with the interface object 1116 as disclosed in FIG. 36C. Other interface objects disclosed herein could alternatively be employed.

The spanning cells disclosed herein can enable start, or end, or span items within or cross a cell in a manner that condenses what may otherwise be a visually expansive and cluttered grid. Spanning cells may be applied to any structured content where the column headers or row headers reflect a range of data values.

### 11. Eight Example User Interface for Navigating Structured Content

With reference now to FIGS. 38A and 38B, an eighth example user interface 1300 is disclosed. As with the user interfaces 500, 600, 700, 800, 900, 1100, and 1200, the user interface 1300 is configured to navigate structured content. Although the structured content of the user interface 1300 is the Hawaii Early Learning Profile®, the user interface 1300 could instead be used to navigate other structured content. Further, although the user interface 1300 is disclosed in FIGS. 38A and 38B in a handheld environment, the user interface 1300 may instead or also be employed in any of the other environments disclosed herein and/or with additional controls.

As disclosed in FIG. 38A, the user interface 1300 generally includes a viewport 1302, a grid 1304 of multi-dimensional cells, and a viewtracker 1306. The cells of the grid 1304 are generally organized into horizontal rows and vertical columns. The grid 1304 also includes a header row 1308 and a header column 1310.

Each of the multi-dimensional cells of the grid 1304 is configured to display only a first dimension of structured content before selection and display one or more additional dimensions of structured content upon selection. Each of the cells in the grid 1304 of FIG. 38A can also represent a single cell, a cluster cell, or a blank cell. For example, cell 1312 represents a single spanning cell of structured content corresponding to step 1.13, cluster cell 1314 represents five different spanning cells 1216-1224 of structured content corresponding to steps 1.01, 1.03, 5.01, 5.05, and 1.02, respectively, and cell 1316 represents a blank cell.

Before selection of a unique row/column positions in the grid 1304, the number, or other symbolic representation, of spanning cells that span the unique row/column position is displayed. Upon selection of a unique row/column position in the grid 1304, representations of the spanning cells that span the unique row/column position are displayed. For example, as disclosed in FIG. 38A each cell spanned by spanning cells has a number displayed in the lower right-hand corner with single cell 1312 displaying the number “1,” cluster cell 1314 displaying the number “5,” and blank cell 1316 displaying the number “7” to represent the numbers of spanning cells that span the unique row/column positions of these cells. Upon selection of the unique row/column position of the blank cell 1316, however, as disclosed in FIG. 38B a representation of the spanning cells 1318-1330 that span the unique row/column position of the blank cell 1316 are displayed. In this example, the representation of the spanning cells 1318-1330 is displayed in a pop-up window 1332. It is understood that selection of a unique row/column position and/or the selection of the number may launch the pop-up window 1332. It is also understood that the representation of the spanning cells 1318-1330 in FIG. 38B may instead be displayed in any other interface object of in the overlay expansion or accordion expansion disclosed in connection with Figure and 37B.

Selection of any of the spanning cells 1318-1330 disclosed in the pop-up window 1332 of FIG. 38B can cause additional dimensions of structured content to be displayed in an interface object. For example, selection of the spanning cell 1318 in FIG. 38B can replace the content of the viewport 1302 with the interface object 1116 as disclosed in FIG. 36C. Other interface objects disclosed herein could alternatively be employed.

### 12. Ninth Example User Interface for Navigating Structured Content

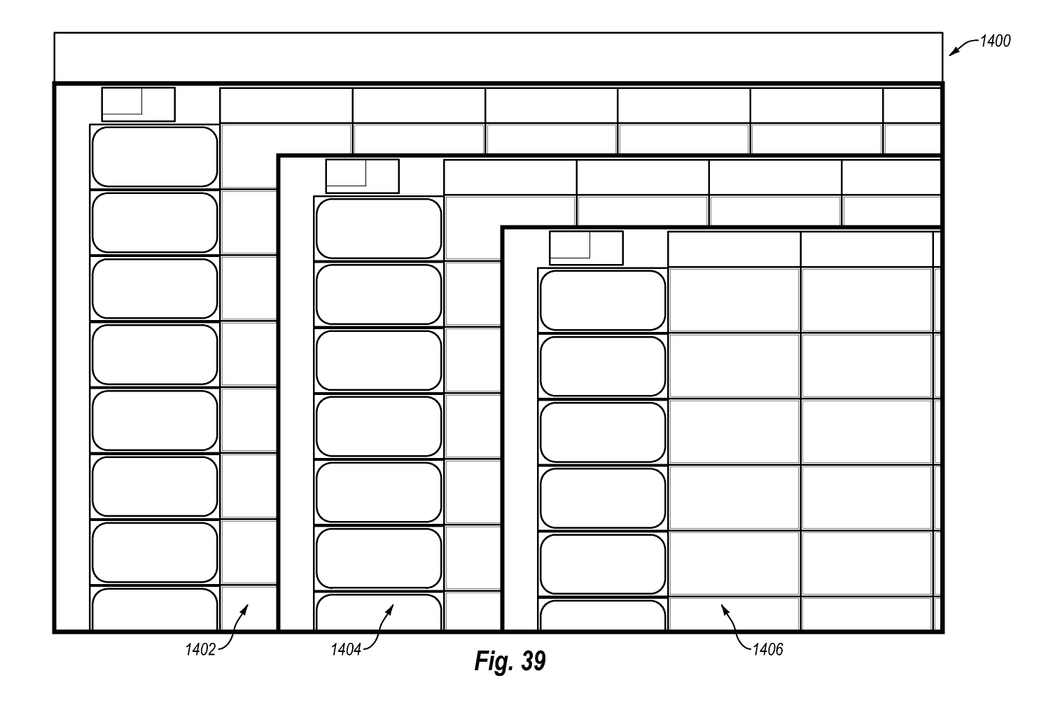

With reference now to FIG. 39, a ninth example user interface 1400 is disclosed. In particular, the interface object 1400 includes a parent grid 1402 and child grids 1404 and 1406 each with its own cells. The child grid 1404 may be launched by selecting a cell in the parent grid 1402. Similarly, the child grid 1406 may be launched by selecting a cell in the grid 1404, with the grid 1404 acting both as a child grid to the grid 1402 but as a parent grid to the grid 1406. The grids 1404 and 1406 are thus additional examples of interface objects that can be employed to display additional dimensions of structured content. The user interface 1400 may further display breadcrumbs or some other method for displaying the hierarchy of levels of parent and child grids and jumping/moving back up that hierarchy. It is understood that a hierarchy of “N” levels of other interface objects can be launched in a similar manner and with similar relationships to the grids 1402, 1404, and 1406.

### 13. Conclusion

The example user interfaces disclosed herein thus open up and make manageable and accessible areas of structured content currently not viewed as uniformly teachable from a learning or instructional basis, or easily self-directed or self-assessed. Such areas are typically outside of traditional textbook domains, such as learning how and if one is growing in his/her religious faith, how one is doing as a new parent, or how well one is mastering the art of selling real estate. There are many content areas that have defied being arranged into a progression of learnable steps coupled with personal assessment and with social interaction/sharing, primarily due to the sheer size and complexity of the steps and the lack of any tool or process to easily navigate and use such content. The example user interfaces disclosed herein provide these missing tools and greatly increase and improve the potential for accessing, studying, and applying granular and detailed structured content by facilitating navigation to such content and by making the content more easily hidden and then visible, and thus usable. The example user interfaces disclosed herein enable a user to access structured content that progresses from less to more advanced or complex steps, and some within a fixed screen display size or viewport.

Embodiments of the invention can include user interfaces implemented on computing devices having various computer hardware and software. Embodiments within the scope of the present invention can also include computer-readable media for carrying or having computer-executable instructions or data structures stored thereon. Computer-executable instructions comprise, for example, instructions and data which cause a computer to perform a certain function or group of functions.

Computer-readable media, on the other hand, can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means or modules in the form of computer-executable instructions or data structures and which can be accessed by a computer.

Further, the software disclosed herein can be employed as Document Object Model (DOM) methods to dynamically determine display screen positions within a grid in order to make easy and enhance the user's ability to scroll or navigate to other cells within the displayed portion of the grid. Further, the software disclosed herein can be employed as part of an operating system. In addition, the software described herein may be implemented in any number of software languages such as C++, Java, or JQuery scripts.

In one embodiment, using a DOM, for example, and based on a directional vector received from the user's selection/pointing device (for example using a mouse click on the navigation palette or a finger touch/scroll to denote up, down, right, left) and based on the current object (for example the domain, header cell, or cell), the software determines the current object and then calculates the next object in the grid hierarchy to display in the 0,0 position of the array/grid, does a JQuery call, and then positions that object at 0,0.

While a variety of features have been disclosed in connection with the user interfaces disclosed herein, it is contemplated that the various features of all of the user interfaces disclosed herein could be combined into a single user interface and/or that the features can be combined or separated in a variety of ways not specifically illustrated by the example user interfaces disclosed herein. It is further understood that one or more user interfaces disclosed herein, and their various features, can function together as an integrated system for navigating and interacting with structured content.

The example embodiments disclosed herein may be embodied in other specific forms. The example embodiments disclosed herein are to be considered in all respects only as illustrative and not restrictive.

What is claimed is:

1. A user interface comprising:
a grid comprising rows and columns;
a header row of cells each positioned in a separate column of the grid;
a header column of cells each positioned in a separate row of the grid;
a plurality of multi-dimensional cells each having a unique position in the grid; and
a viewport that displays only a portion of the grid,
wherein, upon of reception an indication that the portion of the grid displayed within the viewport should simultaneously scroll both horizontally and vertically:
the multi-dimensional cells of the grid are configured to scroll simultaneously within the viewport both horizontally and vertically; and
the header row cells and header column cells of the grid are configured to scroll in a synchronous manner so as to remain visible in the viewport and remain aligned with the rows and columns of multi-dimensional cells.

2. The user interface as recited in claim 1, wherein the indication that the portion of grid displayed within the viewport should simultaneously scroll both horizontally and vertically is received upon a user dragging the grid both horizontally and vertically.

3. The user interface as recited in claim 1, wherein the indication that the portion of grid displayed within the viewport should simultaneously scroll both horizontally and vertically is received upon a user uttering a voice command.

4. The user interface as recited in claim 1, wherein the portion of the grid displayed within the viewport is configured to float within the viewport during simultaneous horizontal and vertical scrolling without automatically snapping to align one or more cell boundaries with one or more edges of the viewport after the simultaneous horizontal and vertical scrolling.

5. The user interface as recited in claim 1, further comprising a viewtracker comprising:
a grid representation of the grid; and
a viewport representation of the viewport that is positioned within the grid representation and overlays the grid representation and visually conveys both the proportion of the grid currently displayed in the viewport as well as the position within the grid of the portion of the grid displayed in the viewport.

6. The user interface as recited in claim 5, wherein the viewport representation, the grid representation, or some combination thereof visually conveys a content density of the cells of the grid, the content density of each cell comprising the amount of content in each cell, the number of dimensions of content in each cell, or some combination thereof.

7. The user interface as recited in claim 5, wherein:
the viewport representation is configured to automatically reposition within the grid representation when the user repositions the portion of the grid displayed in the viewport; and
the portion of the grid displayed in the viewport is configured to automatically reposition when the user repositions the viewport representation within the grid representation.

8. The user interface as recited in claim 1, wherein the viewport initially automatically scrolls to a starting portion of the grid based on one or more metrics entered by a user of the user interface.

9. A user interface comprising:
a grid; and
a plurality of cluster cells each having a unique position in the grid, each cluster cell being configured to:
display only a single cell representing multiple cells before selection; and
display the multiple cells represented by the single cell upon selection.

10. The user interface as recited in claim 9, wherein the selected cluster cell is configured to display the multiple cells represented by the single cell in a separate interface object.

11. The user interface as recited in claim 10, wherein the grid is visually deemphasized simultaneously to the display of the separate interface object.

12. The user interface as recited in claim 10, wherein the separate interface object overlaps at least a portion of the grid.

13. The user interface as recited in claim 9, wherein each of the multiple cells is configured to:
display only a first dimension of structured content before selection; and
display one or more additional dimensions of structured content upon selection.

14. A user interface comprising:
a grid comprising rows and columns and defining multiple unique row/column positions in the grid;
a header row of header row cells each positioned in a separate column of the grid;
a header column of header column cells each positioned in a separate row of the grid; and
a plurality of multi-dimensional spanning cells each configured to span multiple header row columns, multiple header column rows, both multiple header row columns and multiple header column rows in a diagonal fashion, or some combination thereof.

15. The user interface as recited in claim 14, wherein each unique row/column position in the grid is configured to:
display a representation of the spanning cells that begin in the unique row/column position before selection; and
display a representation of the spanning cells that span the unique row/column position upon selection.

16. The user interface as recited in claim 15, wherein the selected unique row/column position is configured to display the representation of the spanning cells that span the unique row/column position by displaying the spanning cells spanning the corresponding multiple header row columns, the corresponding multiple header column rows, both the corresponding multiple header row columns and multiple header column rows in a diagonal fashion, or the combination thereof.

17. The user interface as recited in claim 14, wherein each unique row/column position in the grid is configured to:
display the number of spanning cells that span the unique row/column position before selection; and
display the actual spanning cells that span the unique row/column position upon selection.

18. A user interface comprising:
a grid; and
a plurality of multi-dimensional cells each having a unique position in the grid, each multi-dimensional cell being configured to:
display only a first dimension of structured content before selection; and
display one or more additional dimensions of structured content in a child grid upon selection.

19. The user interface as recited in claim 18, wherein each cell in the child grid is configured to:
display only a first dimension of structured content before selection; and
display one or more additional dimensions of structured content in a second child grid upon selection.

20. The user interface as recited in claim 18, wherein each cell in the child grid is configured to:
display only a first dimension of structured content before selection; and
display one or more additional dimensions of structured content in a separate interface object upon selection.
